(19) United States
(12) Patent Application Publication
(10) Pub. No.: US 2023/0321618 A1
(43) Pub. Date: Oct. 12, 2023

(54) Laboratory Instrument with Mixing Mechanism for Mixing a Medium of a Slide

(71) Applicant: Qinstruments GmbH, Jena (DE)

(72) Inventors: Olaf Simmat, Dornburg-Camburg (DE); Andreas Vester, Jena (DE); Michael Bachseitz, Jena (DE); Sven Maeusezahl, Jena (DE)

(73) Assignee: Qinstruments GmbH, Jena (DE)

(21) Appl. No.: 18/334,052

(22) Filed: Jun. 13, 2023

Related U.S. Application Data
(63) Continuation of application No. PCT/EP2021/085272, filed on Dec. 10, 2021.

(30) Foreign Application Priority Data
Dec. 14, 2020 (DE) 102020133424.0

(51) Int. Cl. B01F 31/22; B01F 31/00; B01F 35/90

(52) U.S. Cl. CPC B01F 31/22; B01F 31/70; B01F 35/90; B01F 2035/98; B01F 2101/23

(57) ABSTRACT

A laboratory instrument for mixing a medium in an object carrier, wherein the laboratory instrument includes a support body, a main component for receiving the object carrier which is disposed on the support body and is movable with respect to the support body for mixing, and a mixing drive mechanism disposed on the support body, with a drive device, a first eccentric and a second eccentric, which can be driven by means of the drive device and which are configured in order to transmit a driving force produced by the drive device to the main component in order to mix the medium in the object carrier, wherein the first eccentric and the second eccentric are disposed on a peripheral edge of the support body and outside a central region of the support body.

### CROSS-REFERENCE TO RELATED APPLICATIONS

The instant patent application claims priority to International Patent Application No. PCT/EP2021/085272, filed on Dec. 10, 2021, and to German Patent Application No. 102020133424.9, filed on Dec. 13, 2020, each of which is incorporated herein in its entirety by reference.

### FIELD OF THE DISCLOSURE

The present disclosure generally relates to a laboratory instrument and a method for mixing a medium.

### BACKGROUND OF THE INVENTION

EP 2 144 716 discloses a sample handling device for handling a sample, wherein the sample handling device comprises a drive shaft which can be driven by a drive unit, wherein a base plate is attached in order to follow a movement of the drive shaft when it is driven by the drive unit, wherein the base plate is configured to receive a sample carrier block which can be mounted to follow a movement of the base plate, and a balance weight mounted asymmetrically on the drive shaft to at least partially compensate for an unbalanced mass of the sample handling device during the movement.

EP 2 809 436 discloses a mechanism for generating an orbital motion for mixing, in particular for shaking, a fluid sample received in a sample holder, wherein the mechanism comprises a stationary mounted or lockable first toothed wheel with a first through hole and a plurality of first teeth disposed along an outer periphery of the first toothed wheel. Furthermore, a movably mounted second toothed wheel with a second through hole and a plurality of second teeth is provided, which is disposed along an outer periphery of the second toothed wheel. A drive shaft is provided with a concentric first section and an eccentric second section, wherein the first section is guided through the first through hole and the second section is guided through the second through hole. A coupling body has a plurality of third teeth which are disposed along an inner periphery of the coupling body. The coupling body is coupled to the first toothed wheel and the second toothed wheel in order to engage a portion of the first teeth and a portion of the second teeth by a portion of the third teeth in order to generate the orbital motion of the second toothed wheel and a sample holder thereby, wherein the sample holder is to be mounted so as to follow a movement of the second toothed wheel when the first section of the drive shaft turns.

### BRIEF SUMMARY OF THE INVENTION

The present disclosure generally describes a laboratory instrument and a method for mixing a medium in an object carrier in a simple manner and with great accuracy. In accordance with an exemplary embodiment of the present invention, a laboratory instrument for mixing a medium in an object carrier is provided, wherein the laboratory instrument has a support body, a main component for receiving the object carrier which is movable with respect to the support body and is disposed on the support body for mixing, and a mixing drive mechanism disposed on the support body with a drive device, a first eccentric and a second eccentric which can be driven by means of the drive device and are configured in order to transmit a driving force produced by the drive device (in particular in order to transmit a drive torque produced by the drive device and resulting from the driving force) to the main component in order to mix the medium in the object carrier, wherein the first eccentric and the second eccentric are disposed at a peripheral edge of the support body and outside a central region of the support body.

In accordance with another exemplary embodiment of the present invention, a method for mixing a medium in an object carrier is provided, wherein the method comprises receiving the object carrier on a main component which is disposed on a support body and can be moved with respect to the support body for the purposes of mixing, disposing a mixing drive mechanism which has a drive device, a first eccentric and a second eccentric on the support body, disposing the first eccentric and the second eccentric on a peripheral edge of the support body and outside a central region of the support body, and driving the first eccentric and the second eccentric by means of the drive device in order to transmit a driving force produced by the drive device to the main component in order to mix the medium in the object carrier.

In the context of the present application, the term “laboratory instrument” should in particular be understood to mean equipment, tools and ancillaries used in a chemistry laboratory, biochemistry laboratory, biophysics laboratory, pharmaceutical laboratory and/or medical laboratory which can be used to carry out chemical, biochemical, biophysical, pharmaceutical and/or medical procedures such as sample treatments, sample preparations, sample separations, sample tests, sample investigations, syntheses and/or analyses.

In the context of the present application, the term “object carrier” can in particular be understood to mean a device which is configured to receive a medium which is to be handled in a laboratory (for example a medium which can be liquid and/or solid and/or gaseous). In particular, an object carrier for receiving a substance can be present in a container, or preferably configured as a plurality of substances in different containers. As an example, an object carrier can be a sample carrier plate, for example a microtiter plate with a plurality of cavities.

In the context of the present application, the term “mixing drive mechanism” can in particular be understood to mean an assembly of elements or components which are configured to cooperate in order to exert a mixing force on a medium in an object carrier which is mounted on the laboratory instrument.

In the context of the present application, the term “eccentric” should in particular be understood to mean a control body (in particular a control cam or a control cylinder) which is asymmetrically attached to a shaft which is driven in rotation, the central point of the control body lying outside the shaft axis. In other words, an eccentric can be an asymmetrically rotating body attached to a shaft. As an example, an eccentric can also be configured as a double eccentric (see FIG. 75). In accordance with an exemplary embodiment of the invention, in particular, a rotary (turning) movement can be transformed into an orbital motion with an eccentric. The term “orbital motion” as used here should be understood to mean the continuous movement of the object carrier and of the medium contained therein about centers which are formed by two eccentric shafts. Preferably, an orbital motion can be carried out in a horizontal plane.

In the context of the present application, the term “drive device” should in particular be understood to mean a source of force or torque or energy which makes the eccentric turn. In particular, a drive device of this type can be an electric motor which can be supplied with electrical energy from a power supply or an accumulator. As an alternative, the drive device can also comprise a fuel cell or a combustion engine. The drive device can produce a rotational force which can be transformed into an orbital motion by the eccentrics, for example.

In the context of the present application, the term “eccentrics on a peripheral edge of a support body outside a central region of the support body” should in particular be understood to mean that the two eccentrics protrude from the edge rather than from the center of a housing of the support body, so that in this way they can be operatively coupled to the main component in a force-fitting manner. Expressed another way, the two eccentrics should both be disposed on an edge of the support body and therefore leave a cavity exposed between the two eccentrics in a center of the support body. Below the cavity, for example, the drive device can be countersunk into the housing of the support body, whereupon a depression is formed in the central region of the support body. It is also possible, however, to mount the drive device on the edge of the support body, whereupon the central region can also, for example, be formed by a through hole in the support body. The cavity left free because of the edge arrangement of the two eccentrics is freely available, for example, for the passage of cooling gas and/or to be configured to be able to accommodate all or part of an interactive device for functional interaction with an object carrier fixed on the main component. As an example, a cavity of this type can be completely or partially filled by a cooling body (as the interactive device) on the underside of the main component in order to cool medium in the object carrier. By arranging the eccentrics in the region of a peripheral edge of the support body, a distance of a respective eccentric from an external side wall of a housing of the support body can be less than 25%, in particular less than 20% of the width of a housing, for example. A separation of the two eccentrics, which can be laterally offset with respect to each other, can, for example, be at least 60%, in particular at least 70% of said housing width. The exposed central region of the support body which corresponds to a surface area of the cavity in top view, can, for example, be at least 50%, in particular at least 60% of the surface area of the support body in top view.

### BRIEF DESCRIPTION OF THE SEVERAL VIEWS OF THE DRAWING(S)

FIG. 1 shows a three-dimensional view of a laboratory instrument in accordance with an exemplary embodiment of the disclosure.

FIG. 2 shows a three-dimensional view of a laboratory instrument with a flat bottom adapter in accordance with another exemplary embodiment of the disclosure.

FIG. 3 shows the laboratory instrument in accordance with FIG. 1 with a temperature control adapter in the form of a thermally conductive framework with receiving openings for receiving laboratory vessels or an object carrier mounted thereon.

FIG. 4 shows an exploded view of the laboratory instrument in accordance with FIG. 2.

FIG. 5 shows another exploded view of the laboratory instrument in accordance with FIG. 2.

FIG. 6 shows a laboratory instrument without temperature control in accordance with another exemplary embodiment of the disclosure.

FIG. 7 shows a laboratory instrument with positioning pins in all four corner regions in accordance with another exemplary embodiment of the disclosure.

FIG. 8 shows a laboratory instrument with positioning pins in all four corner regions and with a flat bottom adapter in accordance with another exemplary embodiment of the disclosure.

FIG. 9 shows the laboratory instrument in accordance with FIG. 7 with an alternative temperature control adapter to that of FIG. 8 mounted on it.

FIG. 10 shows another three-dimensional view of the laboratory instrument in accordance with FIG. 7.

FIG. 11 shows a laboratory instrument in accordance with another exemplary embodiment of the disclosure.

FIG. 12 shows another view of the laboratory instrument in accordance with FIG. 11.

FIG. 13 shows a bottom view of a main component of a laboratory instrument with positioning pins in two corner regions in accordance with an exemplary embodiment of the disclosure.

FIG. 14 shows a cross-sectional view of the main component in accordance with FIG. 13.

FIG. 15 shows a bottom view of a main component of a laboratory instrument with positioning pins in four corner regions in accordance with another exemplary embodiment of the disclosure.

FIG. 16 shows a cross-sectional view of the main component in accordance with FIG. 15.

FIG. 17 shows a bottom view of a laboratory instrument in accordance with another exemplary embodiment of the disclosure.

FIG. 18 shows a docking station for a laboratory instrument in accordance with FIG. 17.

FIG. 19 shows a top view and FIG. 20 shows a bottom view of a docking station in accordance with another exemplary embodiment of the disclosure.

FIG. 21 shows a base station configured here as a base plate for mounting a plurality of laboratory instruments in accordance with an exemplary embodiment of the invention using a plurality of docking stations in accordance with FIG. 19, which are inserted into the base plate.

FIG. 22A shows a top view of a guide disk of a fixing mechanism for a laboratory instrument in accordance with an exemplary embodiment of the disclosure.

FIG. 22B shows a guide disk in accordance with FIG. 22A when installed and in an operational state, in which the guide disk has been turned by actuating an actuating device.

FIG. 22C shows the guide disk in the installed situation in accordance with FIG. 22B and in another operational state in which no actuation of the actuating device and therefore no turning of the guide disk has taken place.

FIG. 23 shows a three-dimensional view of the guide disk in accordance with FIG. 22A.

FIG. 24 shows a three-dimensional view of a positioning fixture in accordance with an exemplary embodiment of the disclosure.

FIG. 25 shows another three-dimensional view of the positioning fixture in accordance with FIG. 24.

FIG. 26 shows a three-dimensional view of the positioning fixture in accordance with FIG. 24 plus guide disk in accordance with FIG. 23.

FIG. 27 shows the assembly of FIG. 26 in a housing of a main component in sectional view.

FIG. 28 shows another view of the assembly in accordance with FIG. 27 in sectional view.

FIG. 29 shows a three-dimensional view of a portion of a laboratory instrument in accordance with an exemplary embodiment of the disclosure.

FIG. 30 shows a three-dimensional view of a portion of a laboratory instrument in accordance with another exemplary embodiment of the disclosure.

FIG. 31 shows an internal construction of a support body for a laboratory instrument in accordance with an exemplary embodiment of the disclosure.

FIG. 32 shows a top view of the internal construction of the support body in accordance with FIG. 31.

FIG. 33 shows an exposed interior of the support body in accordance with FIG. 31 and FIG. 32.

FIG. 34 shows a bottom view of the exposed interior of the support body in accordance with FIG. 33.

FIG. 35 shows a swivel support for a laboratory instrument in accordance with an exemplary embodiment of the disclosure.

FIG. 36 shows a tipped swivel support between a support body and a main component of a laboratory instrument in accordance with an exemplary embodiment of the invention, in sectional view.

FIG. 37 shows an actuator for automatically actuating an actuating device of a laboratory instrument in accordance with an exemplary embodiment of the disclosure.

FIG. 38 shows an internal construction of a support body for a laboratory instrument in accordance with an exemplary embodiment of the disclosure.

FIG. 39 shows another view of the assembly in accordance with FIG. 38.

FIG. 40 shows a top view of a laboratory instrument in accordance with an exemplary embodiment of the invention with an object carrier mounted on it which is engaged by positioning fixtures for the laboratory instrument.

FIG. 41 shows the assembly in accordance with FIG. 40, wherein the object carrier has been released from the positioning fixtures.

FIG. 42 shows a top view of a support body for a laboratory instrument in accordance with an exemplary embodiment of the invention in an actuation position with a locked object carrier.

FIG. 43 shows the assembly in accordance with FIG. 42 in an actuation position with an unlocked object carrier.

FIG. 44 shows a three-dimensional view of a laboratory instrument in accordance with an exemplary embodiment of the invention, wherein a cooling airflow has been shown diagrammatically.

FIG. 45 shows a cross-sectional view of a laboratory instrument in accordance with an exemplary embodiment of the invention, wherein a cooling airflow has been shown diagrammatically.

FIG. 46 shows a top view of a laboratory instrument in accordance with an exemplary embodiment of the disclosure.

FIG. 47 shows a cross-sectional view of the laboratory instrument in accordance with FIG. 46 along a sectional line A-A.

FIG. 48 shows a top view of a laboratory instrument in accordance with an exemplary embodiment of the disclosure.

FIG. 49 shows a cross-sectional view of the laboratory instrument in accordance with FIG. 48 along a sectional line B-B.

FIG. 50 shows a three-dimensional view of a main component of a laboratory instrument in accordance with an exemplary embodiment of the disclosure.

FIG. 51 shows another three-dimensional view of the main component in accordance with FIG. 50.

FIG. 52 shows a three-dimensional view of a main component of a laboratory instrument in accordance with another exemplary embodiment of the disclosure.

FIG. 53 shows a bottom view of the main component in accordance with FIG. 52.

FIG. 54 shows a top view of the main component in accordance with FIG. 52 with positioning fixtures in a locked state.

FIG. 55 shows a top view of the main component in accordance with FIG. 52 with positioning fixtures in an unlocked state.

FIG. 56 shows a see-through top view of the main component in accordance with FIG. 52.

FIG. 57 shows a three-dimensional view of a laboratory instrument in accordance with an exemplary embodiment of the disclosure.

FIG. 58 shows a bottom view of a main component of the laboratory instrument in accordance with FIG. 57.

FIG. 59 shows a three-dimensional view of a main component of a laboratory instrument in accordance with an exemplary embodiment of the invention, with positioning fixtures in all four corners.

FIG. 60 shows a top view of the main component in accordance with FIG. 59.

FIG. 61 shows a three-dimensional view of an underside of the main component in accordance with FIG. 59.

FIG. 62 shows a bottom view, i.e. an underside, of the main component in accordance with FIG. 59.

FIG. 63 shows a bottom view of the main component in accordance with FIG. 59 and elements that are hidden in FIG. 62.

FIG. 64 shows a three-dimensional view of a laboratory instrument with an object carrier in accordance with an exemplary embodiment of the invention mounted thereon.

FIG. 65 shows a three-dimensional view of a laboratory instrument in accordance with another exemplary embodiment of the disclosure.

FIG. 66 shows a three-dimensional view of an exposed support body of the laboratory instrument in accordance with FIG. 65.

FIG. 67 shows an eccentric with counterbalancing mass of a mixing drive mechanism of a laboratory instrument in accordance with an exemplary embodiment of the disclosure.

FIG. 68 shows the laboratory instrument in accordance with FIG. 65 with an object carrier mounted thereon.

FIG. 69 shows an underside of the laboratory instrument in accordance with FIG. 65.

FIG. 70 shows an underside of the laboratory instrument in accordance with FIG. 65 without the bottom cover.

FIG. 71 shows a top view of the laboratory instrument in accordance with FIG. 65.

FIG. 72 shows a cross-sectional view of the laboratory instrument in accordance with FIG. 65.

FIG. 73 shows different views of components of the laboratory instrument in accordance with FIG. 65.

FIG. 74 shows different views of components of the laboratory instrument in accordance with FIG. 65.

FIG. 75 shows a three-dimensional view of a laboratory instrument in accordance with another exemplary embodiment of the invention with a frame-shaped counterbalancing mass, wherein furthermore, two representations of a double eccentric can be seen.

FIG. 76 shows different views of components of the laboratory instrument in accordance with FIG. 75.

FIG. 77 shows a three-dimensional top view of a main component with positioning fixtures and fixing mechanism for a laboratory instrument in accordance with another exemplary embodiment of the disclosure.

FIG. 78 shows a three-dimensional bottom view of the main component with positioning fixtures and fixing mechanism in accordance with FIG. 77.

FIG. 79 shows a three-dimensional bottom view of a functional assembly of the laboratory instrument in accordance with FIG. 77 and FIG. 78.

FIG. 80 shows a cross-sectional view of the functional assembly in accordance with FIG. 79.

FIG. 81 shows a three-dimensional view of a one-piece main component of the laboratory instrument in accordance with FIG. 77 to FIG. 80.

FIG. 82 shows a cross-sectional view of a positioning assembly with positioning fixture of a laboratory instrument in accordance with an exemplary embodiment of the disclosure.

FIG. 83 shows a three-dimensional bottom view of a main component with positioning fixtures and fixing mechanism as well as a cooling body of a laboratory instrument with normal force-producing device in accordance with a further exemplary embodiment of the disclosure.

FIG. 84 shows a three-dimensional top view of a support body of the laboratory instrument with normal force-producing device in accordance with FIG. 83.

FIG. 85 shows a cross-sectional view of a laboratory instrument with normal force-producing device in accordance with an exemplary embodiment of the invention and shows a coupling region between the main component in accordance with FIG. 83 and the support body in accordance with FIG. 84.

FIG. 86 shows a three-dimensional view of a support body for a laboratory instrument with normal force-producing device in accordance with an exemplary embodiment of the disclosure.

FIG. 87 shows a three-dimensional bottom view of a main component with positioning fixtures and fixing mechanism as well as a cooling body of a laboratory instrument with normal force-producing device for cooperation with the support body in accordance with FIG. 86.

FIG. 88 shows a three-dimensional view of a support body for a laboratory instrument with normal force-producing device in accordance with another exemplary embodiment of the disclosure.

FIG. 89 shows a cross-sectional view of a laboratory instrument with normal force-producing device in accordance with an exemplary embodiment of the invention, with which the support body in accordance with FIG. 88 can be employed.

FIG. 90 shows a three-dimensional view of a support body for a laboratory instrument in accordance with an exemplary embodiment of the disclosure.

FIG. 91 shows a cross-sectional view of the laboratory instrument in accordance with FIG. 90.

FIG. 92 shows a cross-sectional view of a laboratory instrument with normal force-producing device in accordance with an exemplary embodiment of the disclosure.

FIG. 93 shows a cross-sectional view of a laboratory instrument with normal force-producing device in accordance with another exemplary embodiment of the disclosure.

FIG. 94 shows a cross-sectional view of a laboratory instrument with normal force-producing device and magnetic field shielding device in accordance with another exemplary embodiment of the disclosure.

### DETAILED DESCRIPTION OF THE INVENTION

Identical or similar components in the various figures are provided with identical reference numerals. Before describing exemplary embodiments of the invention in more detail, some general aspects of the exemplary embodiments of the invention will be explained.

A disadvantage of conventional laboratory instruments is that a major proportion of the build space in the center of an object mounting device for receiving an object carrier is occupied by components of the drive and bearings and cannot be used for the integration of other functions. The drive of a mixing device of a laboratory instrument can conventionally be obtained by means of an electromagnetic solenoid drive, for example. However, solenoid drives suffer from the disadvantage that the amplitude of the mixing motion varies unintentionally with the mixing frequency (usually reduces), because there is no constrained guidance. Furthermore, in embodiments of that type, unwanted resonance phenomena are observed for the mixing motion of the shaker tray or the sample carrier plate. Both impede reproducible and identical mixing of samples in individual vessels, because a different movement or acceleration can be present depending on the geometrical position.

The drives of known mixing devices for mixing sample carrier plates (in particular microtiter plates) usually set the shaker tray in movement from the geometric center outwards. This suffers from the disadvantage that components for the transmission of mixing force have to be installed centrally under the shaker tray and therefore the build space for integrating a cooling body, for example, or for measuring or for other manipulations of the samples in the individual vessels from below is severely restricted.

In addition, in this case, other constructive measures have to be taken in order to minimize unintentional distortion of the shaker tray during the movement, which can affect that mixing motion (in particular when used to mix a plurality of samples in parallel in sample carrier plates). This means that currently, not all samples are moved in an identical manner or mixed in an identical manner independently of their position on the sample carrier plate under otherwise only near-identical conditions.

Mounting the shaker tray with respect to the stationary framework of a laboratory instrument should substantially permit a movement in one plane (horizontal plane). When the shaker tray is mounted on balls or the like, conventionally, in the case of a central eccentric drive, there is a risk of unintentional distortion during execution of the mixing motion, i.e. the amplitude (in particular the orbital diameter) is not constant over the shaker tray and object carrier. This leads to different mixing of the samples distributed over the object carrier.

Conventional mixing devices usually have exchangeable receiving devices in order to be able to receive different laboratory vessels. Furthermore, in order to receive sample carrier plates in automated liquid handling systems, mixing devices with fixed positioning corners or spring-loaded mechanisms are known. However, these suffer from the disadvantage that normal grippers can only place the sample carrier plate and remove it if small forces are necessary for that. Thus, with compartments of this type without automated fastening, only low mixing frequencies can be obtained without running the risk that the sample carrier plate will come loose from the shaker tray of the mixing device.

In accordance with an exemplary embodiment of the invention, a laboratory instrument is provided which includes a mixing device or a mixing drive mechanism for objects or object carriers, in particular sample holders. An exemplary embodiment of this type with a mixing drive mechanism enables a mixing device to be driven and mounted and can in particular be used for mixing medium in sample carrier plates (more particularly microtiter plates), but also in any other types of laboratory vessels.

Advantageously, a laboratory instrument in accordance with an exemplary embodiment of the invention can include a mixing drive mechanism with (preferably exactly) two eccentrics disposed on the edge, between which a central cavity for receiving an interactive device or the like can be left free. In this manner, a main component of the laboratory instrument can execute a mixing motion in a horizontal plane by means of the eccentric disposed in the support body and by means of a drive device countersunk below the free central region in the support body. This means that medium in receiving containers of an object carrier on the main component can be efficiently mixed.

A laboratory instrument in accordance with the described exemplary embodiment advantageously lends itself to laboratory automation and also supports an increase in the number of samples which can be processed in parallel in fully automated sample handling systems while at the same time reducing the sample volume. The reduction in sample volume and geometry goes hand in hand with an increase in the prevailing surface force, which inhibits a mixing motion. In order to be able to overcome these forces and to obtain mixing, very high angular velocities, mixing frequencies and/or rotational speeds can be obtained with the mixing drive mechanism in accordance with an exemplary embodiment of the invention.

When processing sample carrier plates or other object carriers, in accordance with exemplary embodiments of the invention, in addition, all of the samples can be processed in a near-identical manner. Advantageous in this connection is the accurate orbital mixing motion which can be obtained without an unintentional distortion about a central drive axis.

When using only one eccentric shaft for the drive, conventionally, unintentional movements of this type can occur. Observed from the sample carrier plate, then, in conventional laboratory instruments, uncontrolled motions can occur and variable treatment of the samples can occur.

Since, in accordance with an exemplary embodiment of the invention, two coupled eccentric shafts or eccentrics are integrated into a support body of the laboratory instrument which are driven by means of a common drive device to execute a synchronous movement, an exact mixing motion in the plane of assembly of the object carrier is obtained. By mounting the main component which is moved for mixing axially with respect to the stationary support body on swivel supports (preferably at least three, in particular four) and by mounting the eccentric shaft or eccentric in an axially displaceable manner in ball bearings, axial loading of the radial bearing (i.e. ball bearing) can be reliably avoided in accordance with exemplary embodiments of the invention.

Advantageously, in accordance with exemplary embodiments of the invention, the swivel supports have spherical ends which sit on flat surfaces and thus can roll during operation. By using the swivel supports, for a uniformly low loading (clearly, a Hertzian stress with plane-sphere contact occurs), build space is saved and therefore a particularly compact laboratory instrument is obtained.

In addition, in accordance with exemplary embodiments of the invention, it is advantageous for the orbital mixing motion to take place almost entirely in a horizontal plane. In conventional laboratory instruments, the large movements in the vertical direction can, in the case of open vessels, lead to the contents of the vessels spilling out and in the case of closed vessels, can lead to an unwanted wetting of the covers. In particular, when using open sample carrier plates, conventionally, there is a risk of cross-contamination between the individual vessels.

Highly advantageously, exemplary embodiments of the invention enable build space to be created in the middle of the mixing device or the mixing drive mechanism by displacing the bearings of the eccentric shafts or eccentrics from the center of the support body. This allows an interactive device to be accommodated as a consequence of the fact that the central region of the support body is freed from the mixing drive mechanism. As an example, an interactive device of this type can be used to control the temperature of a sample carrier plate or of another object carrier, to carry out optical measurements on the object carrier or on the medium received therein and/or for carrying out a manipulation of the object carrier or the medium received therein from below. By using two eccentric shafts or eccentrics in order to provide the mixing motion energy, very precise positioning of the object carrier or containers of the object carrier can be ensured. Such a high positioning accuracy is advantageous, for example when pipetting small vessels. In addition, by using two eccentric shafts or eccentrics, all of the samples of the sample carrier plate or of the object carrier are exposed to the same conditions when executing the mixing motion. In contrast, when using the conventional only one eccentric, unwanted rotations, rotational oscillations about the drive axis or other artefacts, can arise. With a laboratory instrument in accordance with an exemplary embodiment, then, all of the samples are exposed to an identical movement or acceleration. Furthermore, by strictly separating the axial and radial bearings in accordance with exemplary embodiments of the invention, this results in an increase in the service life and reliability. Furthermore, as regards the strict separation of axial and radial mounting, it should be mentioned that in particular, the eccentric shafts can be displaceable in ball bearings or radial bearings, whereupon all of the axial forces can be taken up by the swivel supports.

Advantageously, the use of swivel supports with spherical ends (instead of using complete spheres) in accordance with an exemplary embodiment of the invention produces a small build space for almost the same capacity. For as small a Hertzian stress as possible at the plane-sphere contact point, advantageously, the radii of the spherical surfaces at the mutually opposite ends of the swivel supports are as large as possible.

The mixing drive mechanism of a laboratory instrument in accordance with an exemplary embodiment of the invention in particular serves for mixing contents of sample vessels and is provided with a drive device and a bearing. This means that a shaker tray of the main component can be moved relative to a stationary frame in the form of the support body on a defined path, preferably within a plane.

By combining a mixing device or a mixing drive mechanism with an automatic fixing device or with a fixing mechanism for the sample carrier plate and shaker tray, in accordance with an exemplary embodiment of the invention, it can be ensured that the samples can be processed safely even under high accelerations. In accordance with an exemplary embodiment of the invention, the drive for the object carrier for mixing can be obtained via an electric drive device and at least two eccentrics or eccentric shafts. The axial mounting can advantageously be produced via four swivel supports with spherical ends which preferably can be mounted on flat counter-surfaces. In accordance with alternative exemplary embodiments, mounting on balls or other rolling bodies is possible.

In order to compensate for imbalances which arise because of the orbital mixing motion, in accordance with exemplary embodiments of the invention, one or more counterbalancing masses can be provided. Such counterbalancing masses can be configured so as to rotate. As an alternative, a (for example frame-shaped) component can be used as the counterbalancing mass which, like the shaker tray or the main component, can be moved orbitally. Advantageously, a counterbalancing mass of this type can be driven eccentrically in the opposite direction in order, in this manner, to completely or partially compensate for the imbalances.

Advantageously, in accordance with an exemplary embodiment of the invention, a temperature control device can be integrated into the laboratory instrument, in particular to control the temperature of sample containers of an object carrier. In this manner, an exemplary embodiment provides a device for controlling the temperature of the object carrier, in particular of open and closed containers for receiving samples. In accordance with exemplary embodiments of the invention, such object carriers can be microtiter plates, tubes, vials, etc. for example. In accordance with an exemplary embodiment, the temperature of object carriers or medium received therein can be selectively brought to temperatures above and/or below the ambient temperature.

A temperature control device of a laboratory instrument in accordance with an exemplary embodiment of the invention can, for example, include a Peltier element and/or a resistive heating element. In one exemplary embodiment, the mixing device can include a heating device and in addition a cooling device (for example a Peltier element which can be used for heating and cooling the sample vessels or vessel contents). In accordance with an exemplary embodiment, simultaneous mixing and temperature control is possible.

A laboratory instrument in accordance with an exemplary embodiment of the invention can, for example, be configured as a free-standing mixing and temperature control device, i.e. used in the laboratory as a single independent laboratory instrument. Another use for a laboratory instrument in accordance with an exemplary embodiment of the invention is its use in a laboratory robot which, for example, carries out sample preparation to mixing right up to the final analysis of various working steps. A further possible application is the use of a laboratory instrument in accordance with an exemplary embodiment of the invention in an incubator in which samples (in particular living cells) can be exposed to a controlled atmosphere (for example as regards temperature, humidity and/or ambient gaseous medium). The mixing device or the mixing drive mechanism here can produce a uniform motion in a sample to be incubated.

In accordance with a preferred exemplary embodiment, the shaker tray or the main component in the laboratory instrument can simultaneously form or contain the cooling body. This provides the advantage of a particularly high heating capacity while simultaneously reducing the moved mass, whereupon high mixing speeds can be obtained for a small loading of the drive and bearings. In addition, this ensures that only the top of the Peltier element or another temperature control element is loaded with forces due to the mixing motion. This means that the underside of the Peltier element can be mounted directly on the shaker tray or main component or on the cooling body and therefore no forces from a separate cooling body act on it. In contrast, a contact component can be secured to the upper side in a recess, so that this cannot move in the horizontal plane and therefore exerts hardly any forces on the temperature control element (in particular the Peltier element).

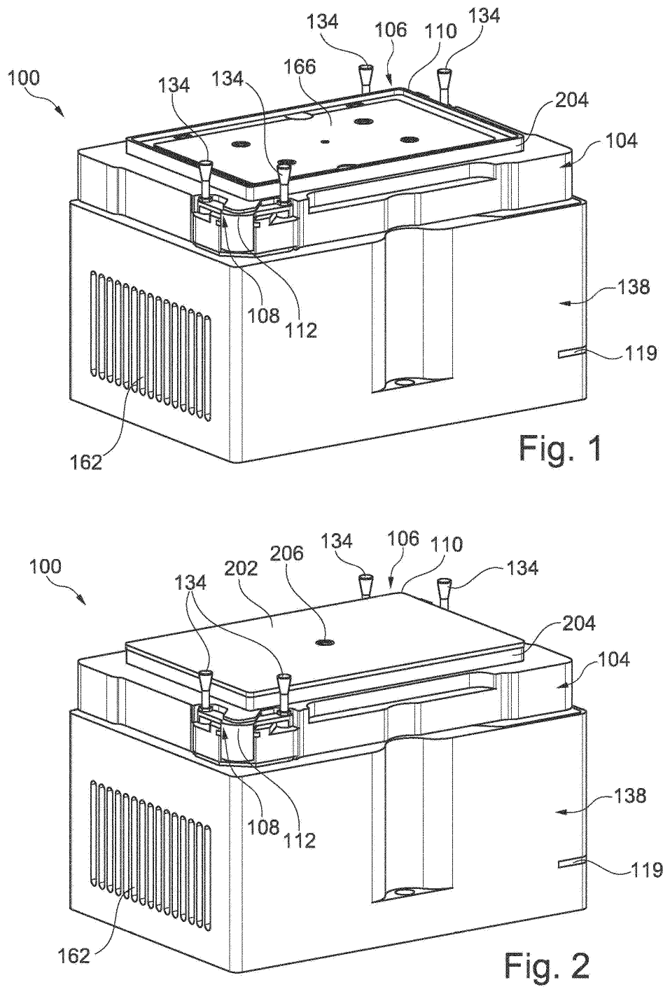

FIG. 1 shows a three-dimensional view of a laboratory instrument 100 in accordance with an exemplary embodiment of the invention. The laboratory instrument 100 shown serves for the releasable attachment of an object carrier 102 to its upper side. Although the object carrier 102 is not shown in FIG. 1, FIG. 44 shows an object carrier 102 configured as a plastic microtiter plate by way of example.

The laboratory instrument 100 shown has a stationary support body 138 as a lower part and a main component 104 movably mounted thereon as an upper part, wherein the latter functions for the releasable receipt of the object carrier 102.

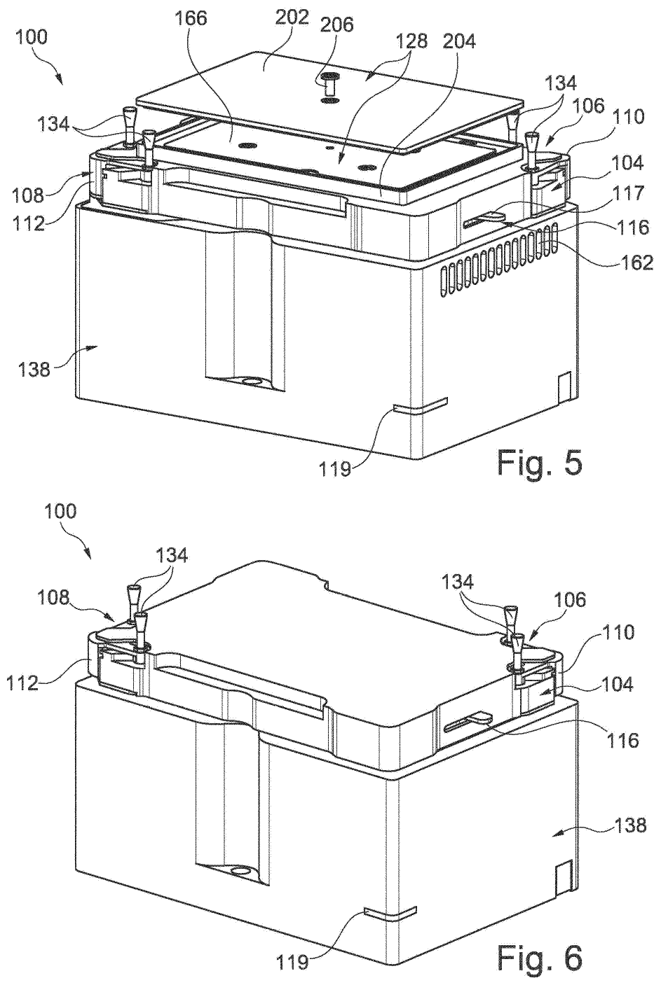

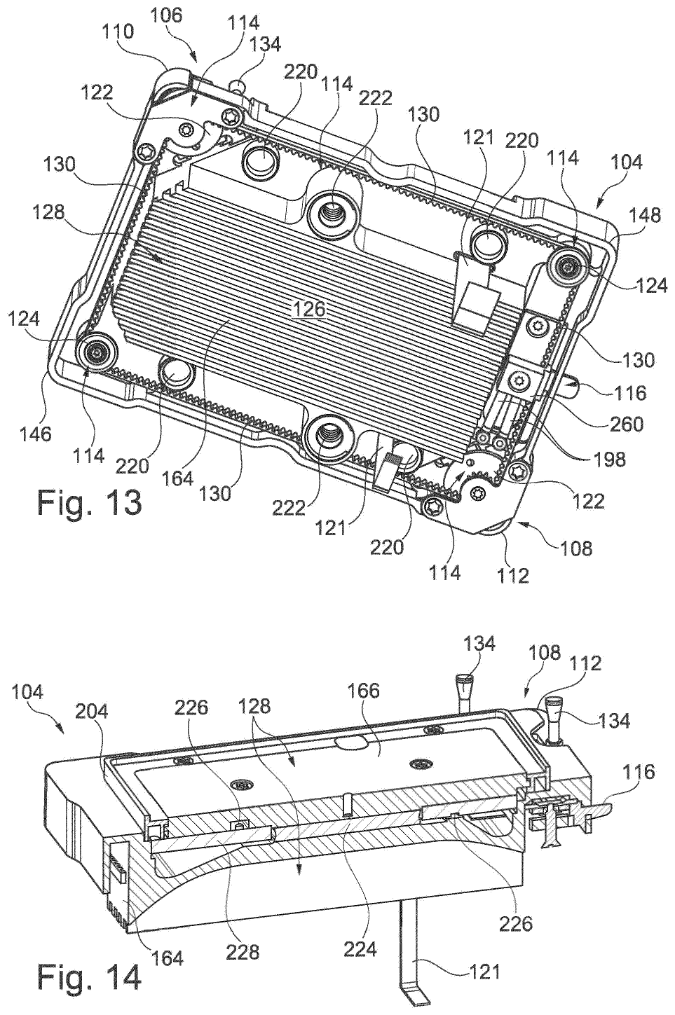

A first positioning fixture 106 for fastening to a first edge region of the object carrier 102 and which can be moved linearly outwards or inwards is provided on an upper side of the main component 104. The first positioning fixture 106 is disposed at a first corner 110 of the main component 104. Furthermore, a further positioning fixture 108 for application to a second edge region of the object carrier 102 and which can be moved linearly outwards or inwards is provided on the upper side of the main component 104. The second positioning fixture 108 is disposed at a second corner 112 of the main component 104. As an alternative, the second positioning fixture 108 can also be rigidly attached to the main component 104. Both the first positioning fixture 106 and also the second positioning fixture 108 each have two positioning pins 134, between which a respective corner region of a rectangular object carrier 102 can be engaged in order to securely clamp the object carrier 102 between the positioning fixtures 106, 108. A fixing mechanism 114, which is shown in more detail in FIG. 13 by way of example inside the main component 104, serves to clamp the object carrier 102 between the first positioning fixture 106 and the second positioning fixture 108. By means of an actuating device 116 which is shown in FIG. 5 and in detail in FIG. 13, the object carrier 102 can be transposed between an engaging or secure configuration and a released configuration for placing or removing the object carrier 102.

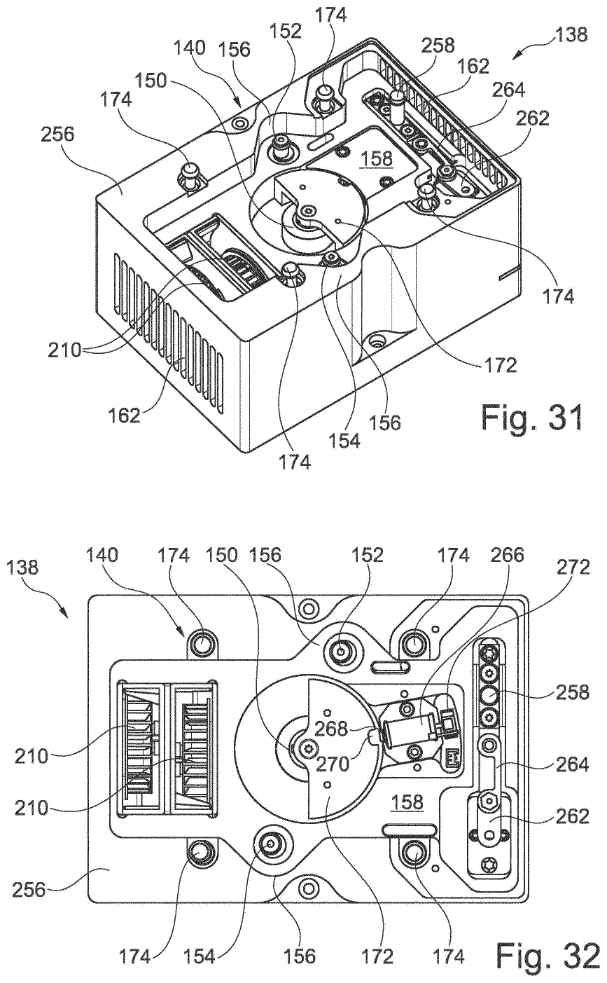

FIG. 1 also shows a thermal coupling plate 166 on an exposed upper side or mounting surface of the main component 104. The thermal coupling plate 166 can be fabricated from a highly thermally conductive material (for example from a metal) in order to control the temperature of the object carrier 102 and the liquid medium contained in it, in particular to heat it or cool it. The thermal coupling plate 166 forms a part of a loading surface of the object carrier 102. The thermal coupling plate 166 is surrounded by a thermally insulating frame 204 (for example produced from plastic). As can be seen in FIG. 13, the underside of the thermal coupling plate 166 can be thermally coupled to a cooling body 164, for example in order to dissipate heat from the object carrier 102 and fluid medium received therein. To this end, ambient air can flow through a cooling opening 162 as the air inlet in a housing of the support body 138 into the interior of the laboratory instrument 101, can pick up heat given out by the cooling body 164 and can then flow out of the laboratory instrument 100 again in its heated state. Although the cooling opening 162 in FIG. 1 serves as an inlet for ambient air into the interior of the laboratory instrument 100, another cooling opening 162 is shown in FIG. 5 as an outlet for air from the interior of the laboratory instrument 100. Optionally, air could also be taken in through the air inlet, for example by means of a cooling fan 210 (see FIG. 31). The air outlet acts as the ventilation opening.

FIG. 1 shows the laboratory instrument 100 without the optionally attached temperature control adapter, which in FIG. 2 is shown with the reference numeral 202.

FIG. 2 shows a three-dimensional view of a laboratory instrument 100 with a flat bottom adapter as a temperature control adapter 202 in accordance with another exemplary embodiment of the invention. The temperature control adapter 202 shown in FIG. 2 on the upper side of the laboratory instrument 100 serves to control the temperature of a flat-bottomed microtiter plate as the object carrier 102 (not shown). The laboratory instrument 100 of FIG. 2 therefore has a thermally highly conductive temperature control adapter 202 produced from a metallic material which can be attached to the main component 104, namely by means of a fastening screw 206 on the main component 104, which can be thermally coupled to the main component 104 for thermally conductive coupling of an object carrier 102 (which is not shown in FIG. 2) to the main component 104. In accordance with FIG. 2, the temperature control adapter 202 which is configured as a plate here lies directly and substantially over the entire surface of the thermal coupling plate 166 and is inserted into the thermally insulating frame 204 in an interlocking manner. In this manner, the temperature control adapter 202 can be releasably secured to the thermal coupling plate 166 of the main component 104 by screwing.

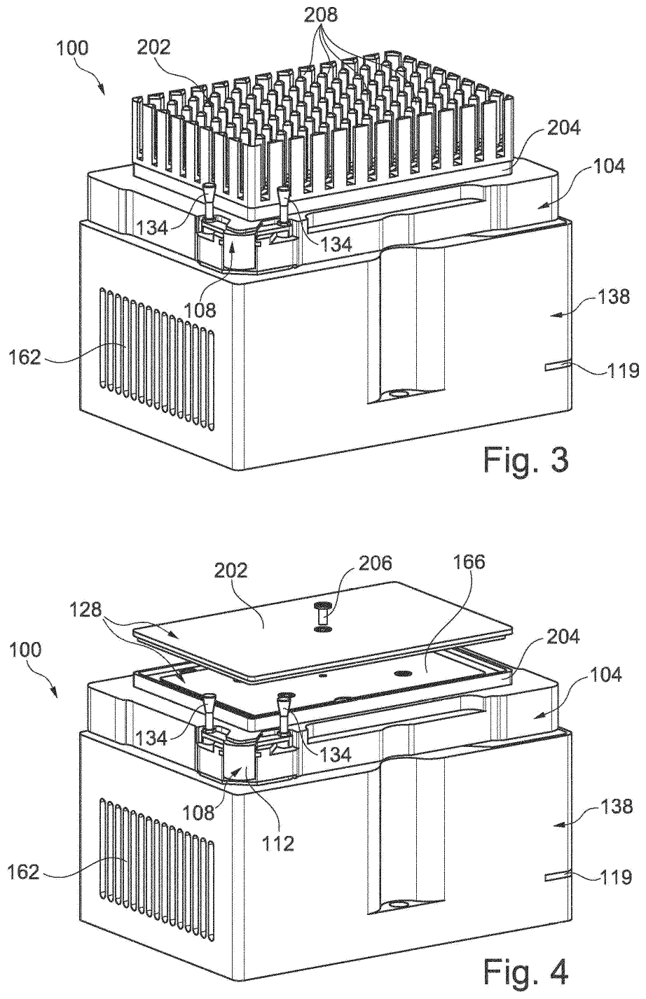

FIG. 3 shows the laboratory instrument 100 in accordance with FIG. 1 with a temperature control adapter 202, which is an alternative to that of FIG. 2, mounted on it, which here is configured as a metal framework with a plurality of receiving openings 208 disposed therein in a matrix for receiving laboratory vessels (not shown) in an interlocking manner or for interlocking insertion of an object carrier 102 with a bottom which is complementary to the receiving openings 208. Thus, in accordance with FIG. 3, the temperature control adapter 202 which is configured as a metal framework is placed on the thermal coupling plate 166 and fastened to the main component 104 by means of the fastening screw 206. The object carrier 102 can then be inserted into the temperature control adapter 202 of FIG. 3.

FIG. 4 shows an exploded view of the laboratory instrument 100 in accordance with FIG. 2 and illustrates mounting of the flat temperature control adapter 202 for controlling the temperature of an object carrier 102 which is configured as a flat-bottomed microtiter plate. FIG. 5 shows another exploded view of the same laboratory instrument 100. As can be seen, the temperature control adapter 202 can be screwed onto the thermal coupling plate 166 by means of a fastening screw 206. The temperature control adapter 202, which is produced from a highly thermally conductive material such as metal, for example, can be used to control the temperature of a microtiter plate with 96 wells, for example.

A mixing device can be employed in the respective laboratory instrument 100 of FIG. 1 to FIG. 5 which functions to mix the laboratory vessel contents of the object carrier 102. Furthermore, an object mounting device for receiving the material to be mixed, i.e. of the object carrier 102, is provided in the form of the main component 104. Inside the support body 138 is a mixing drive mechanism 140, shown by way of example in more detail in FIG. 31, through which the main component 104 plus the object carrier 102 received on it and fixed thereto can be displaced in a mixing motion relative to the stationary framework in the form of the support body 102. The movement preferably occurs over a closed path, in particular as an orbital mixing motion. Clearly, the movement of the main component 104 plus object carrier 102 can, for example, follow a circular path in a horizontal plane. Meanwhile, there is little or no movement in the vertical direction, whereupon splatter or spillage of the samples out of open vessels of an object carrier 102 (for example a microtiter plate) or wetting of the cover of such vessels can be reliably prevented.

As an example, an amplitude or an orbital radius of a mixing motion which can be produced by means of the mixing drive mechanism 140 can be in a range of 0.5 mm to 5 mm. The mixing frequency can preferably lie between 25 rpm and 5000 rpm, wherein other values are also possible. Laboratory vessel contents can be mixed with such a mixing device or with such a mixing drive mechanism 140. In order to increase the flexibility, receiving devices can be provided for different types of laboratory vessels. As an example, reaction vessels with a contents volume of 0.2 mL to 2.0 mL, cryogenic vessels, sample carrier plates (in particular microtiter plates), for example with 96, 384 or 1536 individual vessels, Falcon vessels (with a receptacle volume in the range from 1.5 mL to 50 mL, for example), slides, glass vessels, beakers, etc., can be used.

Advantageously, the object mounting device in the form of the main component 104 has a positioning and locking mechanism which, for example, is shown in FIG. 13 as a fixing mechanism 114. A fixing mechanism 114 of a laboratory instrument 100 in accordance with an exemplary embodiment of the invention can in particular be operated automatically or manually. A manual operation by the user can, for example, be carried out from outside the laboratory instrument 100 by actuating a slide member 117 of the actuating device 116 which is shown in FIG. 5. An associated actuating device 116 is shown in detail in FIG. 13. It is also possible for a robot or the like to actuate the slide member 117 from an external region of the laboratory instrument 100. In accordance with a further embodiment, an actuator 262 (see FIG. 31, for example) can act in an interior of the laboratory instrument 100, or more precisely in an interior of the support body 138, on the actuating device 116 in an interior of the laboratory instrument 100, more precisely in an interior of the main component 104.

Different laboratory vessels (but in particular a sample carrier plate) can be fixed, positioned and securely connected as the object carrier 102 on the main component 104 which functions as a shaker tray using the fixing mechanism 114 and the actuating device 116.

In addition, a laboratory instrument 100 in accordance with an exemplary embodiment of the invention can include a temperature control device in order to set the object carrier 102 and/or the temperature control adapter 202 and therefore the laboratory vessel contents which are in contact therewith to a defined temperature which, for example, can be above or below the ambient temperature. As an example, the range of temperatures supported by such a temperature control device can be from 20° C. to 120° C.

The laboratory instrument 100 shown can in particular be used in automated laboratory systems. Control electronics including a microprocessor can be integrated into the laboratory instrument 100 for this purpose. Furthermore, the laboratory instrument 100 can be equipped with cables for the external power supply and for communication with a higher level system. Suitable communication interfaces are RS232, CAN, Bluetooth, WLAN and USB, but other standards are possible.

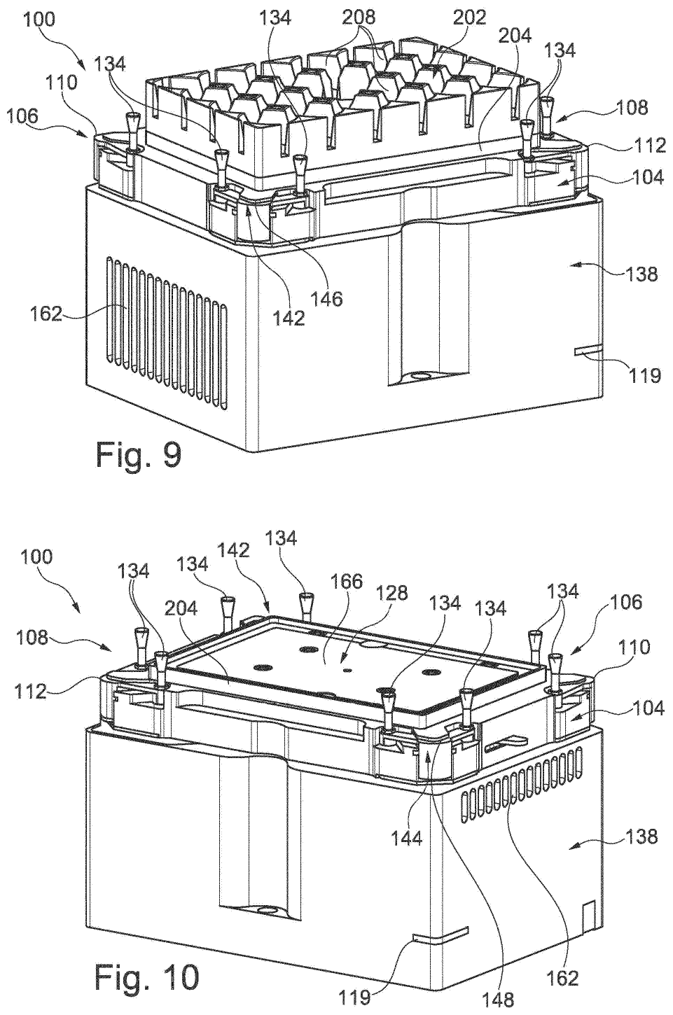

Laboratory instruments 100 in accordance with exemplary embodiments can include an exchangeable temperature control adapter 202 for thermal coupling of laboratory vessels of an object carrier 102 to the temperature control adapter 202. A temperature control adapter 202 of this type can have widely different forms (see FIG. 2, FIG. 3 and FIG. 9). The temperature control adapter 202 can be connected to the contact surface of the temperature control device on an upper side of the main component 104 using a central fastening screw 206.

The main component 104 can also be designated an object mounting device and also acts as a shaker tray. In particular, the main component 104 can receive all of the components which are necessary for fixing an object carrier 102 (in particular a sample carrier plate). In addition, the entire shaker tray or a part thereof can simultaneously be configured as a cooling body (which can consist of aluminum, for example), which can come into contact with an integrated Peltier element. The contact surface of the temperature control device in the form of the thermal coupling plate 166 can function for contacting the exchangeable temperature control adapter 202. This contact surface or the thermal coupling plate 166 can be selectively heated or cooled by a Peltier element or another temperature control element which is integrated into the shaker tray or the main component 104.

The support body 138 is configured as a stationary framework which includes, for example, control electronics, a drive device 150 as well as eccentrics 152, 154 of the mixing drive mechanism 140, at least one cooling fan (for a compact build space, advantageously a radial cooling fan) in order to move the air and for cooling a cooling body 164 and therefore the main component 104 or shaker tray (see FIG. 31, for example).

The exemplary embodiments in accordance with FIG. 1 to FIG. 5 employ linearly displaceably mounted positioning fixtures 106, 108 with lower cylindrical and upper tapered positioning pins 134, which alternatively can also have a different shape. Clearly, the positioning pins 134 move outwards to unlock the object carrier 102 and move inwards to lock the object carrier 102.

As can be seen in FIG. 5, the actuating device 116 is provided with a lever which here can be displaced longitudinally for manual actuation of the positioning fixtures 106, 108 (for example, which can be actuated for emergency unlocking or for rapid loading or unloading by a user).

The laboratory instrument 100 can also include a light guide for optically displaying a status of the laboratory instrument 100 which can be illuminated by an internal light emitting diode. As an example, a light 119 which illuminates red could indicate a defect, a green light could indicate an operational state which was ready for action and a yellow light could indicate a loss of communication.

FIG. 6 shows a laboratory instrument 100 without a temperature control device in accordance with another exemplary embodiment of the invention. The functions provided by the laboratory instrument 100 in accordance with FIG. 6 therefore include clamping of a platen-shaped object carrier 102 and a mixing function.

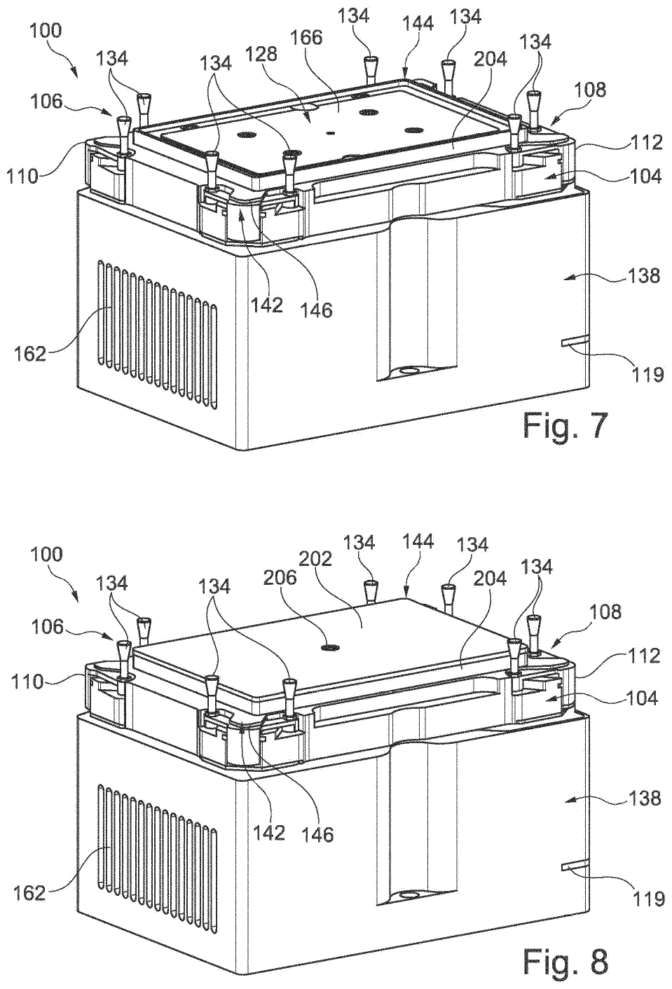

FIG. 7 shows a laboratory instrument 100 with positioning fixtures 134 in all four corner regions in accordance with another exemplary embodiment of the invention. While FIG. 1 to FIG. 6 show embodiments of a laboratory instrument 100 with two positioning fixtures 106, 108, in the exemplary embodiments in accordance with FIG. 7 to FIG. 10, four positioning fixtures 106, 108, 142, 144 are provided which, for example, can all be movable. Thus, the laboratory instrument 100 in accordance with FIG. 7 additionally includes a third positioning fixture 142 with two positioning pins 134 for application to a third edge region of an object carrier 102 (not shown) and a fourth positioning fixture 144 with two positioning pins 134 for fastening to a fourth edge region of an object carrier 102 of this type. The third positioning fixture 142 is disposed at a third corner 146 of the main component 104. The fourth positioning fixture 144 is disposed at a fourth corner 148 of the main component 104.

FIG. 8 shows a laboratory instrument 100 with positioning fixtures 134 in all four corner regions and with a temperature control adapter 202 configured as a flat-bottomed adapter in order to control the temperature of flat-bottomed microtiter plates in accordance with another exemplary embodiment of the invention. Apart from the additional positioning fixtures 142, 144, the exemplary embodiment in accordance with FIG. 8 corresponds to that in accordance with FIG. 2.

FIG. 9 shows the laboratory instrument 100 in accordance with FIG. 7 with an alternative temperature control adapter 202 to that of FIG. 8 mounted on it, which here is configured as a metal framework with a plurality of receiving openings 208 formed as a matrix for receiving laboratory vessels or an object carrier 102 (not shown). Apart from the additional positioning fixtures 142, 144 and the different configuration of the temperature control adapter 202, the exemplary embodiment in accordance with FIG. 9 corresponds to that in accordance with FIG. 3.

FIG. 10 shows another three-dimensional view of the laboratory instrument 100 in accordance with FIG. 7, in which the cooling opening 162 which functions as an air outlet can be seen in the housing of the support body 138.

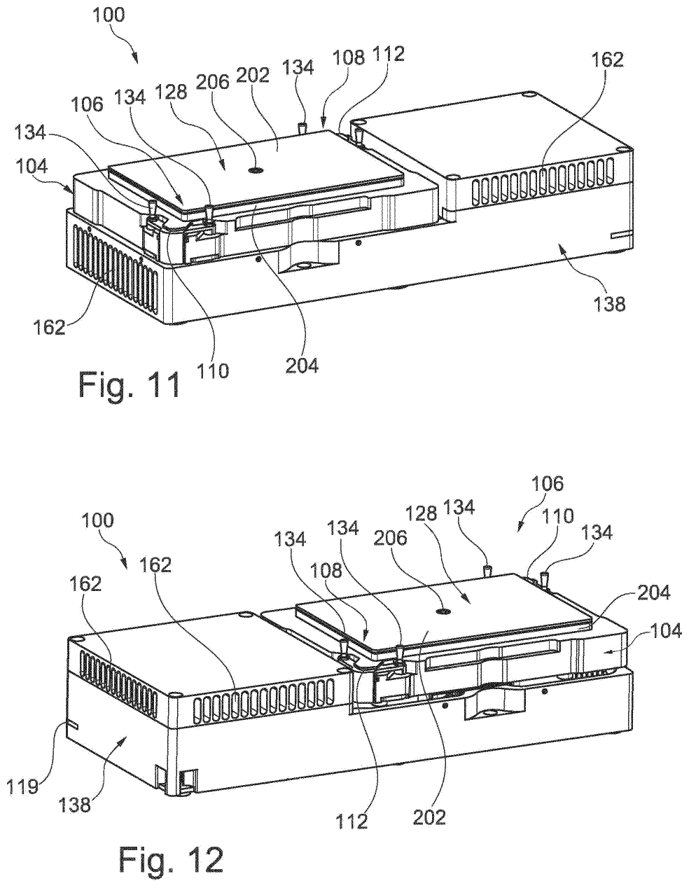

FIG. 11 shows a laboratory instrument 100 in accordance with another exemplary embodiment of the invention. FIG. 12 shows another view of the laboratory instrument 100 in accordance with FIG. 11. This exemplary embodiment shows an alternative construction of the air inlet and air outlet (which can also be exchanged, i.e. the other way around) in the form of cooling openings 162 in a housing of the support body 138. In the laboratory instrument 100 in accordance with FIG. 11 and FIG. 12, the surface (and in particular the length) is enlarged, in order to reduce the build height. Advantageously, the laboratory instrument 100 in accordance with FIG. 11 and FIG. 12 can be used for systems with a limited build height. As an alternative, the width or another dimension of the laboratory instrument 100 can be varied.

FIG. 13 shows a bottom view of a main component 104 of a laboratory instrument 100 with positioning fixtures 134 in two corner regions in accordance with an exemplary embodiment of the invention. Clearly, FIG. 13 constitutes a bottom view of a shaker tray with two positioning fixtures 106, 108.

In particular, FIG. 13 illustrates a fixing mechanism 114 for fixing an object carrier 102 to the main component 104 between the first positioning fixture 106 and the second positioning fixture 108 by moving the two positioning fixtures 106, 108. Furthermore, FIG. 13 shows details of an actuating device 116 for actuating the fixing mechanism 114 in order for transposing the two positioning fixtures 106, 108 between an operational state which fixes the object carrier 102 and an operational state which releases the object carrier 102.

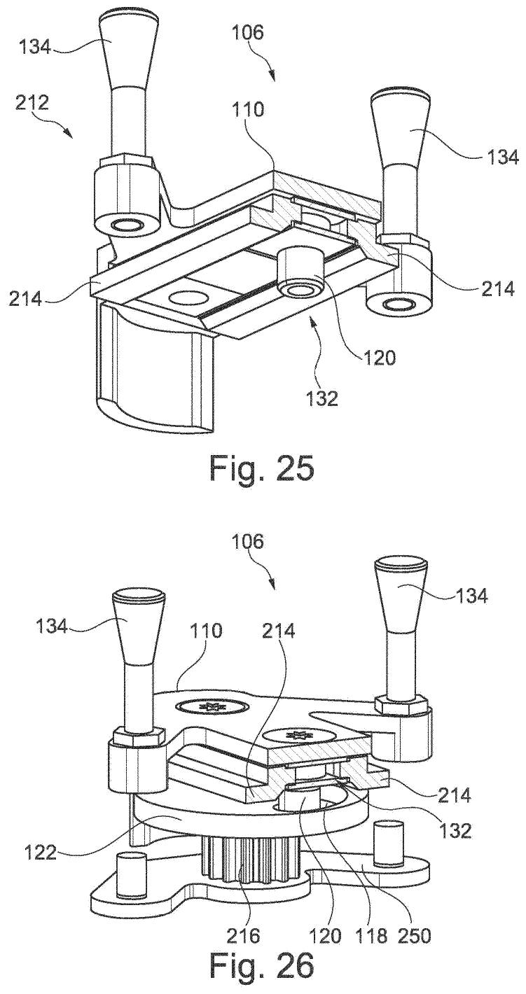

With reference to FIG. 22A to FIG. 28, the fixing mechanism 114 includes two guide bodies 120 in the form of guide pins which can be guided in a respective guide recess 118 of a respective guide disk 122. The guide recess 118 is present in the circular guide disk 122 as a curved groove. The two said guide disks 122 are rotatably mounted in mutually opposite corners 110, 112 of the substantially rectangular main component 104, in which the positioning fixtures 106 or 108 are also disposed. The guide bodies 120 simultaneously form components of a rigid component 213 shown in FIG. 24 and FIG. 25 which also includes a pair of positioning pins 134 of an associated positioning fixture 106, 108 as well as guide rails 214 to move the component 212 in a straight line along a linear guide 132. Clearly, a respective component 212 forms a respective positioning fixture 106 or 108.

In accordance with FIG. 13, the configuration of the fixing mechanism 114 is such that an actuating force to actuate the actuating device 116 for transposing the fixing mechanism 114 into the operational state in which the object carrier 102 is released is smaller than a releasing force to release the fixed object carrier 102 which is to be exerted by the fixed object carrier 102 which has been set in a mixing motion, for example. The releasing force can therefore be a force which results from a mixing motion of the object carrier 102 and which should not lead to release of the object carrier 102 from the laboratory instrument 100. The force-transmitting mechanism of the fixing device 114 which has been described combines a low-force actuation capability of the actuating device 116 with a strong self-locking effect against an unwanted shaking free of a fixed object carrier 102 during the mixing operation. Clearly, the actuating device 116 can therefore be actuated with a moderate actuating force in order to displace the positioning fixtures 106, 108, whereas an object carrier 102 clamped between the positioning fixtures 106, 108 can only shake free under extraordinarily high forces because of the self-locking effect described. Referring now to FIG. 22A to FIG. 22C, actuation of the actuating device 116 leads to a displacement of the guide body 120 along the guide recess 118, which is possible with a low force (see FIG. 22B). In contrast, a force acting on a clamped object carrier 102 which is subjected to a mixing motion leads to a force on the guide body 120 in the guide recess 118 but no actuation of the actuating device 116, resulting in no turning of the guide disk 122 and therefore no movement of the positioning fixtures 106, 108 (see FIG. 22C). The force arrow 218 in FIG. 22C is in fact almost transverse to the positioning recess 118. This asymmetric force transmission rationale results in comfortable actuation of the actuating device 116 and simultaneously to the described self-locking effect or to an intrinsic protection of the laboratory instrument 100 from unwanted release of an object carrier 102 from the positioning fixtures 106, 108.

Referring again to FIG. 13, both guide disks 122 configured in accordance with FIG. 22A are disposed in the opposing first and second corners 110, 112 of the main component 104. Thus, each of the two guide recesses 118 is disposed in a respective guide disk 122, which guide disks 122 are disposed in the mutually opposite first and second corners 110, 112 of the main component 104. A respective rotatably mounted guide pulley 124 is disposed in a third corner 146 and in a fourth corner 148 of the main component 104.

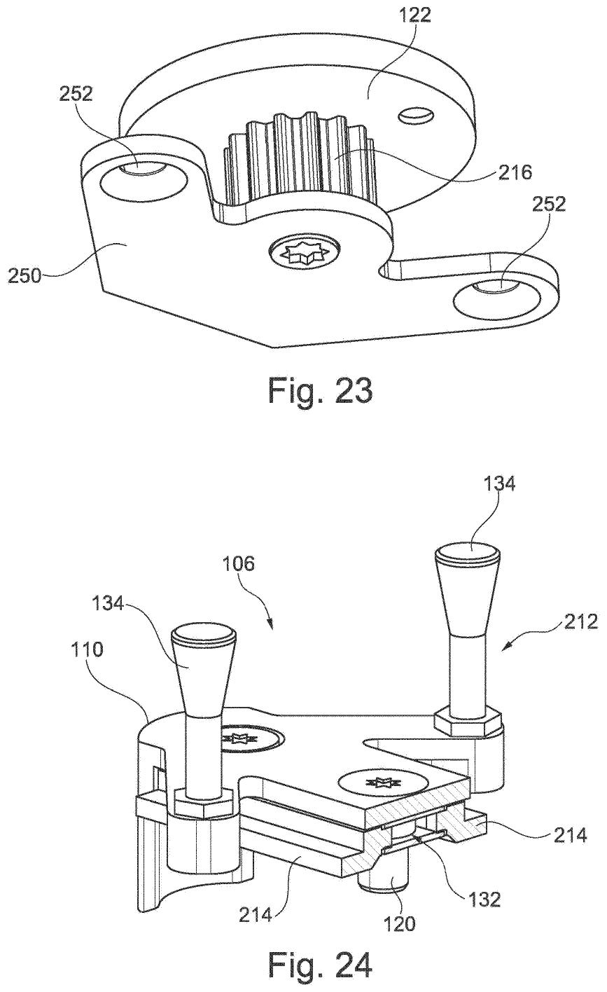

Advantageously, the fixing mechanism 114 includes an annular closed force-transmitting mechanism 130, which is configured here as an annular closed toothed belt. Said toothed belt extends substantially rectangularly with rounded corners along the entire periphery of the main component 104 and runs continuously along an outer edge of the main component 104. Here, in the mounted state in accordance with FIG. 13, teeth of the toothed belt engage in a respective toothed wheel 216 (which can also be described as a toothed belt pulley or synchronous belt pulley), which is rigidly connected to a respective guide disk 122 (see FIG. 23). In this manner, an actuating force exerted on the actuating device 116 can be transferred by clamping the actuating device 116 to the toothed belt or by engaging teeth (not shown) present on the actuating device 116 on said toothed belt which, because of its annular closed configuration, is then turned a little in the clockwise direction or in the counter-clockwise direction. Twisting of the toothed belt acts on the toothed wheels 216 of the guide disks 122 as well as on toothed wheels (not shown) of the guide pulleys 124. Turning of the toothed wheels 216 of the guide disks 122 makes a force act on the guide body 120 which can be displaced along the guide recesses 118. Because of the linear guide 132 or the guide rails 214 of the components 212, it is only possible for the components 212 to move radially outwards or radially inwards in a straight line. Because the guide bodies 120 form part of the rigid components 212, an actuation of the actuating device 116 therefore results in a movement of the components 212 inwards or outwards in a straight line. In this manner, an actuation of the actuating device 116 results in a movement of the positioning fixtures 106 or 108 inwards or outwards in a straight line.

As can be seen clearly in FIG. 13, the fixing mechanism 114 is disposed along an entire edge and periphery of the main component 104, leaving free a central region 126 of the main component 104 which is surrounded by the periphery. Furthermore, the annular closed fixing mechanism 114 which extends along the entire peripheral edge of the main component 104 is disposed along an underside of the main component 104 which faces away from the object carrier 102.

In respect of the actuating device 116, it should also be noted that this is coupled to a pre-tensioning element 198 in the form of a pair of helical springs (or even just one helical spring) which is configured to pre-tension the actuating device 116 corresponding to an operational state of the fixing mechanism 114 which fixes the object carrier 102. As an alternative, a torsion spring, a magnet or another component can be used as the pre-tensioning element 198 to generate an appropriately directed pre-tensioning force. Expressed another way, the actuating device 116 together with the pre-tensioning element 198 pre-loads an object carrier 102 into a fixed state between the positioning fixtures 106, 108, so that release of the object carrier 102 from the laboratory instrument 100 requires a force to be actively exerted on the actuating device 116. This increases the operational safety of the laboratory instrument 100 and prevents unwanted release of the object carrier 102. After placing an object carrier 102 on the main component 104, it is sufficient for a user to let go of the previously actuated actuating device 116, whereupon the pre-tensioning element 198 pulls the linearly movable positioning fixtures 106, 108 inwards. This in turn securely clamps the object carrier 102.

Highly advantageously, the fixing mechanism 114 extends exclusively along the outer periphery of the main component 104 and leaves a central region 126 of the main component 104 free. Expressed another way, neither the fixing mechanism 114 nor the actuating device 116 contains components which are outside the outer periphery of the main component 114, nor any which extend into the central region 126 of the main component 104. Thus, the central region 126 of the main component 104 is free to use for other tasks or functional components.

FIG. 13 shows, by way of example, an interactive device 128 which is disposed in the free central region 126 of the main component 104. The interactive device 128 can therefore extend through the free central region 126 of the main component 104. In the exemplary embodiment which is shown, the interactive device 128 is a cooling body 164 for cooling an object carrier 102 or a temperature control adapter 202 as described above. As can be seen, the cooling body 164 includes a massive plate section which is thermally coupled to the thermal coupling plate 166. Furthermore, the cooling body 164 can include a plurality of cooling fins which extend outwards from the plate section and between which channels are formed to pass a flow of air or cooling gas through. Naturally, other alternative interactive devices 128 are possible, for example an optical apparatus for optical interaction with a medium in the object carrier 102, or a magnetic mechanism for magnetic interaction with a medium in the object carrier 102 (not shown).

FIG. 13 therefore shows the main component 104 which acts as the object mounting device and shaker tray from below in an embodiment with two positioning fixtures 106, 108. The main component 104 receives the described components and can simultaneously contain a cooling body 164 for a temperature control device.

The guide disks 122 function as rotatably mounted cam disks for guiding or for the linear movement of the positioning fixtures 106, 108. Each of the guide disks 122 contains a track-shaped groove as the guide recess 118, into which a guide body 120 which is formed as a round guide pin engages. The latter is rigidly fixed to the linearly mounted positioning fixtures 106, 108. The rotatably mounted guide pulleys 124 looped operation of the synchronous belt as the force-transmitting mechanism 130. Said synchronous belt can be configured as a toothed belt and permits synchronous movement of the positioning fixtures 106, 108 together.

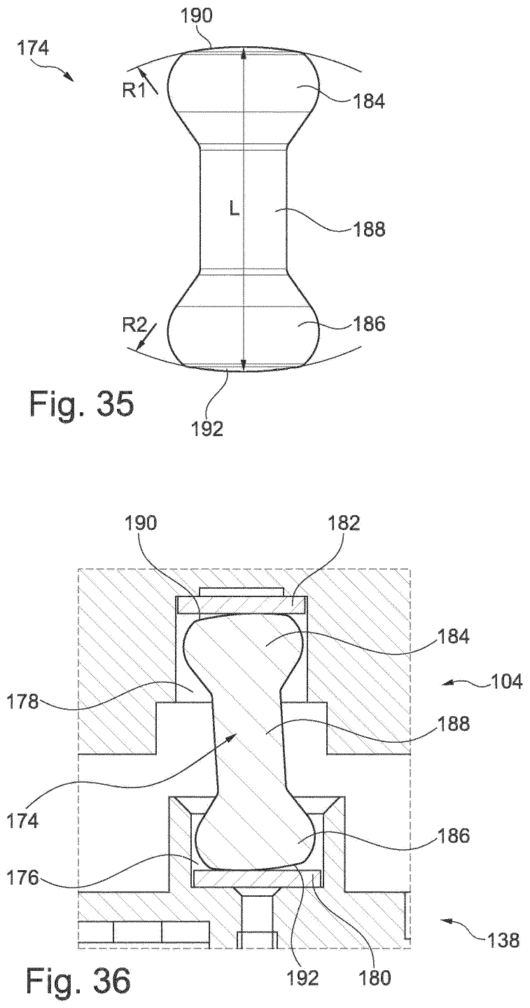

Furthermore, the underside of the main component 104 contains bearings 220 (four in the exemplary embodiment shown) for swivel supports 174 (see FIG. 35 and FIG. 36), which advantageously can be used for an axial mounting in a plane.

Furthermore, FIG. 13 shows two ball bearings 222 into which, in the assembled state of the laboratory instrument 100, a first eccentric 152 (or a first eccentric shaft) or a second eccentric 154 (or a second eccentric shaft) engage (see FIG. 31). Clearly, the ball bearings 222 can serve to deflect the main component 104 or the shaker tray with respect to the stationary frame in the form of the support body 138 on a circular path in a plane.

In accordance with FIG. 13, the actuating device 116 is configured as a linearly mounted slide for manual or automatic actuation to unlock the sample carrier plate or another object carrier 102. When no force (manual or via an actuator) acts on this slide, it is moved back into its initial position by the pre-tensioning element 198 which is configured as springs. The actuating device 116 is connected to the force-transmitting mechanism 130 which is configured as a synchronous belt, which produces a turning movement of the guide disks 122, whereupon in turn, the positioning fixtures 106, 108 are linearly displaced. More precisely, the pre-tensioning element 198 in accordance with FIG. 13 is configured as a tension spring for the movement of the linearly mounted slide and therefore of the positioning fixtures 106, 108 in the direction of the object carrier 102 (i.e. for pre-tensioning in a locking state).

Furthermore, cables (in particular flat cables, see reference numeral 121) for the electrical connection of the main component 104 to the support body 138 are employed. In this regard, Peltier elements (or another heating element) can in particular be supplied with power and an optional sensor system (in particular temperature sensors) can be connected.

FIG. 14 shows a cross-sectional view of the main component 104 in accordance with FIG. 13. More precisely, FIG. 14 shows a sectional view through the cooling body 164 or the cooling fins (center).

Reference numeral 224 shows a temperature control element configured here as a Peltier element for controlling the temperature (in particular heating or cooling) of the thermal coupling plate 166 (which can also be described as a thermal contact component). An exchangeable temperature control adapter 202 can be thermally connected to the temperature control element 224, which in turn can control the temperature of laboratory vessels.

Furthermore, a temperature sensor 226 can be integrated into the thermal coupling plate 166 which is also termed a contact component. As an alternative or in addition, a temperature sensor 226 can be provided in the exchangeable temperature control adapter 202 and/or in sample vessels or samples to be handled. Furthermore, a temperature sensor 226 can be provided in the cooling body 164 or in the shaker tray, which is advantageous for the purposes of efficient control.

Reference numeral 228 describe a thermal insulation between the thermal coupling plate 166 and the cooling body 164.

The thermally insulating frame 204 serves for the thermal insulation of the thermal coupling plate 166 and of the cooling body 164. In addition, the thermally insulating frame 204 can take up lateral forces in order to reduce the transmission of vibrations in a horizontal plane onto the temperature control element 224 which is configured here as a Peltier element.

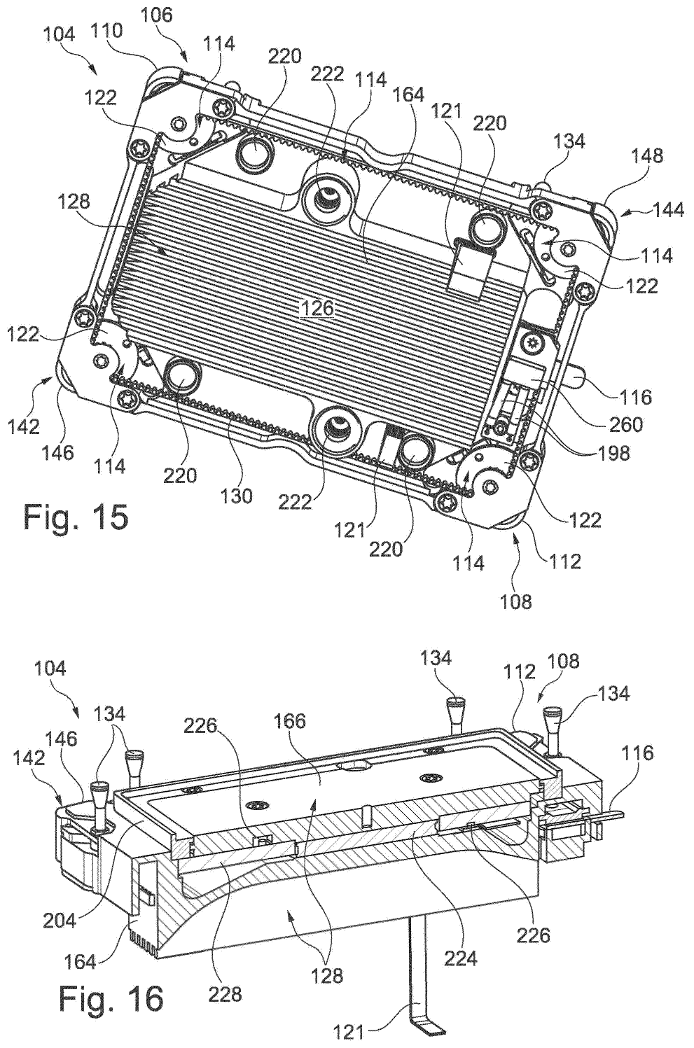

FIG. 15 shows a bottom view of a main component 104 of a laboratory instrument 100 with positioning fixtures 134 in four corner regions in accordance with another exemplary embodiment of the invention. In this regard, the exemplary embodiment in accordance with FIG. 15 differs from that of FIG. 13 in particular in that instead of the guide pulleys 124 in two corners 146, 148 of the main component 104 of FIG. 15, a movable positioning fixture 106, 108, 142, 144 is disposed in each corner 110, 112, 146, 148. The force-transmitting mechanism 130 which is configured as a toothed belt is also disposed along an outer periphery of the main component 104 in FIG. 15 and is deflected by 90° each time at each of the four corners 110, 112, 146, 148 of the main component 104 by a respective toothed wheel 216 of a respective guide disk 122.

FIG. 16 shows a cross-sectional view of the main component 104 in accordance with FIG. 15. The sectional view in accordance with FIG. 16 corresponds to that in accordance with FIG. 14, with the difference that in FIG. 16, a positioning fixture 106, 108, 142, 144 is disposed in all four corners 110, 112, 146, 148.

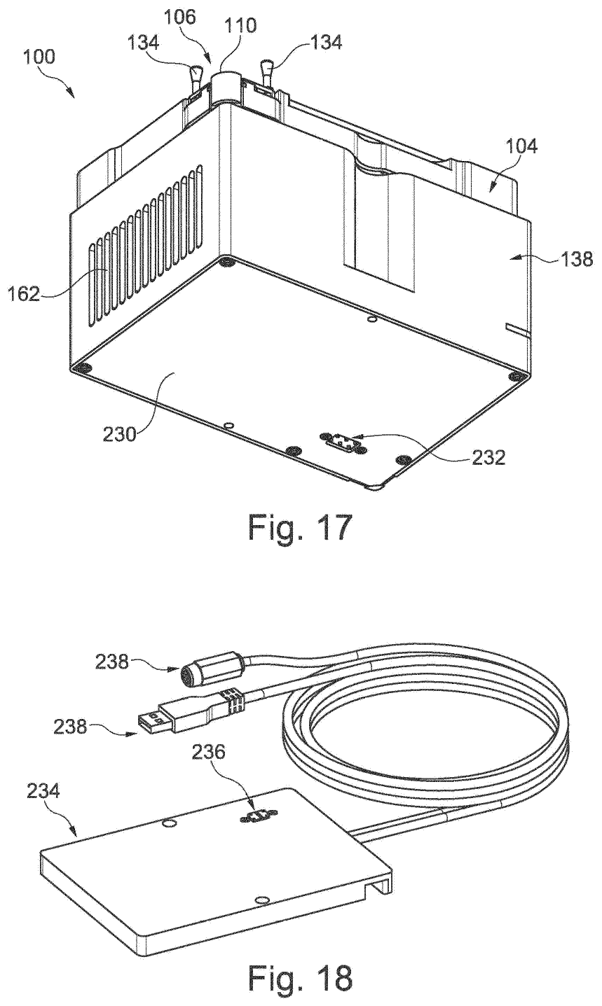

FIG. 17 shows a bottom view of a laboratory instrument 100 in accordance with another exemplary embodiment of the invention, wherein a bottom connecting plate 230 of the support body 138 is equipped with an electrical connector 232. The connector 232 includes pogo pins, i.e. spring-loaded electrical contacts. The laboratory instrument 100 can be supplied with power by means of the connector 232 and can be coupled up for communication (for example in accordance with RS232, USB or another communication interface).

FIG. 18 shows a docking station 234 for the laboratory instrument 100 in accordance with FIG. 17. The docking station 234 has an electrical interface 236, which can be coupled to the connector 232 on the underside of the laboratory instrument 100. Furthermore, the docking station 234 is provided with cables 238. The assembly shown in FIG. 18 can, for example, be installed in a higher-level system so that laboratory instruments 100 can then be changed quickly and without wiring. This has the advantage of rapid exchange in the case of failure or during maintenance, without dropout of the instrument.

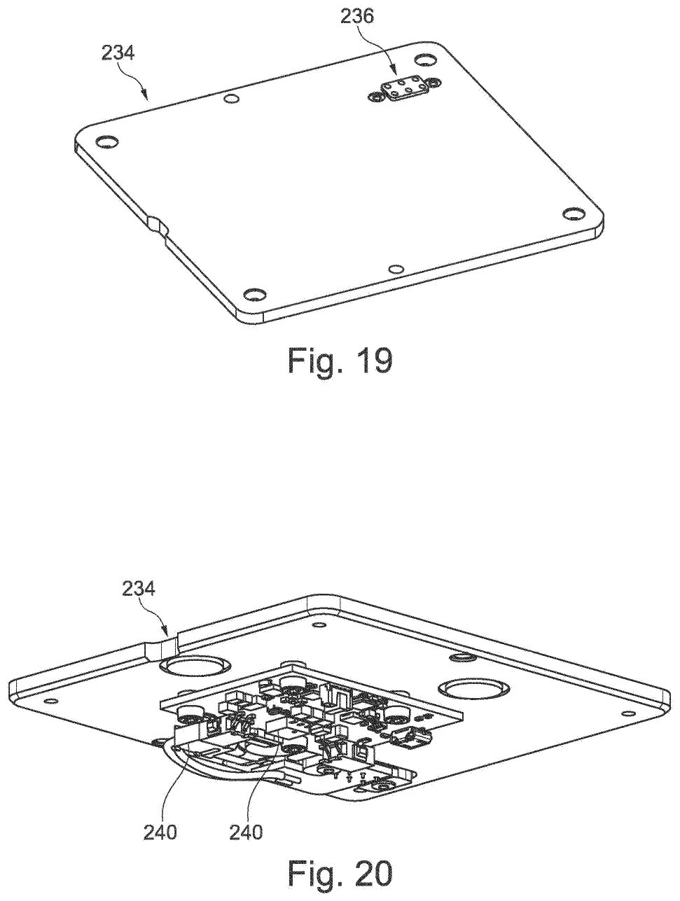

FIG. 19 shows a top view and FIG. 20 shows a bottom view of a docking station 234 in accordance with another exemplary embodiment of the invention. As can be seen in FIG. 20, the electrical interface 236 can be coupled to the upper side of the docking station 234 through a plate and to one or more electronic components 240 which can be mounted on the inside of the docking station 234.

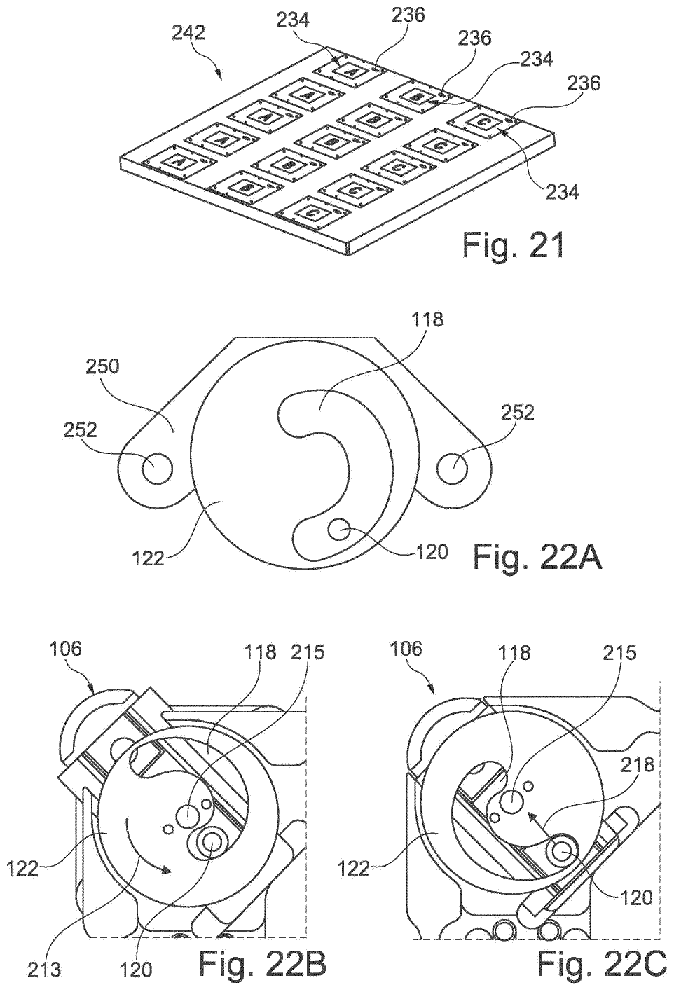

FIG. 21 shows a base plate 242 for mounting a plurality of laboratory instruments 100 in accordance with an exemplary embodiment of the invention. In the example shown, fifteen mounting bases in the form of docking stations 234 in accordance with FIG. 19 and FIG. 20 can be provided, which are equipped with electrical interfaces 236 in order to form a plug-in connection with connectors 232 for a respective laboratory instrument 100. The laboratory instruments 100 with their connectors 232 (preferably equipped with pogo pins) and a respective corresponding connector in the form of an electrical interface 236 on the base plate 242 therefore form a higher-level instrument for the provision of power and communications. This allows for rapid exchange of the laboratory instrument 100 (for example in the case of a defect or for maintenance).

As can be seen in FIG. 17 to FIG. 21, a laboratory instrument 100 in accordance with an exemplary embodiment can even be produced without external wiring, but instead with a connector 232 for connection to a power supply and a communication device. A connector 232 of this type can, for example, be integrated into a base plate 242 (see FIG. 21) of a higher-level system, in particular be plugged into it. As an example, a connector 232 of this type can be provided with pogo pin contacts.

In another exemplary embodiment of the laboratory instrument 100, it is equipped with cables for supplying power and for communications.

FIG. 22A shows a top view of a guide disk 122 of a fixing mechanism 114 of a laboratory instrument 100 in accordance with an exemplary embodiment of the invention. FIG. 23 shows a three-dimensional view of the guide disk 122 in accordance with FIG. 22A.

Furthermore, FIG. 22B shows a guide disk 122 in accordance with FIG. 22A in an installed situation and in an operational state in which, by actuating an actuating device 116, the guide disk 122 is turned or has been turned about a pivot point 215 (see curved arrow 213). FIG. 22C shows the guide disk 122 in the installed situation in accordance with FIG. 22B, but in a different operational state in which no actuating of the actuating device 116 and therefore no rotation of the guide disk 122 occurs or has occurred.

By applying a force to guide slides (in particular produced by an object carrier 102 mounted on the main component 104 during the mixing operation), a radially outwardly directed force can also be generated (see reference numeral 218 in FIG. 22C). Without actuating the actuating device 116, however, no rotation of the guide disk 122 occurs, so that despite the force in the direction of the arrow 218, no movement of the guide body 120 occurs because the force on the guide body 120, which is configured as a pin, for example, acts in the direction of the pivot point 215 in the center of the guide disk 122 and therefore transverse to or almost perpendicular to the guide recess 118. Thus, in accordance with FIG. 22B, an actuation of the actuating device 116 occurs, and therefore a rotation of the guide disk 122, which causes a ready and low-power displacement of the guide body 120 in the guide recess 118. In contrast to this, in accordance with FIG. 22C, a force on the guide body 120 alone does not cause any turning of the guide disk 122 and therefore no outward movement of the positioning fixture 106. The force acts on the guide body 120 almost perpendicular to the guide recess 118. For this reason, this force on the guide body 120 does not result in turning of the guide disk 122. An at most extremely slight turning of the guide disk 122 can at best generate a very slight displacement of the system of reference numerals 120, 106, 108. In this manner, a low-power actuation capability of the actuating device 116 in accordance with FIG. 22B can be combined with a high self-locking effect without such an actuation (see FIG. 22C).

Referring again to FIG. 22A, such a guide disk 122, which can be configured as a cam disk with a guide groove, can, for example, be installed in the main component 104 shown in FIG. 13. FIG. 22A shows the view of an assembly with such a guide disk 122 with a rotatable mount from above. It can be seen from FIG. 22A that a guide body 120, which is configured as a guide pin, can be moved in a curved track-shaped guide recess 118. The guide recess 118 is formed as a groove in a main face of the guide disk 122. When installed, the guide disk 122 is rotatably mounted on the main component 104. The fixing mechanism 114 shown in FIG. 13, of which the component of FIG. 22A forms a part, is preferably configured in a manner such that when a shaking releasing force is exerted through a clamped object carrier 102 during a mixing operation, a displacement force acts on the guide body 120 transversely to the guide recess 118 (see reference numeral 218 in FIG. 22C). Furthermore, the fixing mechanism 114 is configured in a manner such that when the actuating device 116 is actuated for transposing the fixing mechanism 114 between the operational state in which the object carrier 102 is free and the operational state in which the object carrier 102 is engaged, a displacement force acts on the guide body 120 along the guide recess 118 (see FIG. 22B).

Thus, FIG. 22A shows the guide recess 118 configured as a guide groove of the guide disk 123 configured as a cam disk, which is rotatably mounted with respect to the object mounting device or the shaker tray of the main component 104. The guide body 120 which is configured as a guide pin protrudes into the guide recess 118, which guide body forms a rigid part of a respective positioning fixture 106 or 108. The guide body 120 and/or the guide disk 122 can be round in shape or disk-shaped, but can also have any other shape. Thus, FIG. 23 shows the guide disk 122 configured as a cam disk with a toothed wheel 216 rigidly attached thereto. The guide disk 122 together with the toothed wheel 216 can be rotatably mounted on a plate-shaped main body 250. The main body 250 can be provided with one or more through holes 252 for screwing the assembly shown in FIG. 23 to a housing of the main component 104.

FIG. 24 shows a three-dimensional view of a positioning fixture 106 in accordance with an exemplary embodiment of the invention. FIG. 25 shows another three-dimensional view of the positioning fixtures 106 in accordance with FIG. 24.

The rigid assembly shown in FIG. 24 and FIG. 25 of the positioning fixture 106 with a linear slide mount or linear guide 132 also comprises the guide body 120 which is configured here as a pin which, when a laboratory instrument 100 is operating, engages in the guide recess 118 of the guide disk 122 in accordance with FIG. 22A.

When the laboratory instrument 100 is transposed between an operational state which fixes an object carrier 102 and an operational state which releases the object carrier 102, the first positioning fixture 106 shown can be displaced along the linear guide 132 which can be received in a corresponding guide seat of a housing of the main component 104 for longitudinal displacement (see FIG. 56, for example). Thus, the guide body 120 forms a positioning pin which, for example, is connected by a screw to the assembly of FIG. 25 and FIG. 26 corresponding to the linearly displaceable positioning fixture 106. As an alternative, such a connection can also be produced in another manner. Clearly, the guide body 120 acts as a guide pin which engages in the groove-like guide recess 118 of the guide disk 122 and ensures a linear displacement of the positioning fixture 106 (because of the constrained guidance of the component of FIG. 24 and FIG. 25 in an appropriately shaped recess in the housing of the main component 104).

FIG. 26 shows a three-dimensional view of the positioning fixtures 106 in accordance with FIG. 24 plus the guide disk 122 in accordance with FIG. 23. Clearly, FIG. 26 therefore shows a view of the operatively interconnected assembly of the positioning fixture 106 in accordance with FIG. 24 and FIG. 25 and the cam disk assembly of FIG. 22A and FIG. 23 without the object mounting device or shaker tray. FIG. 26 therefore shows the cooperation of guide disk 122 and positioning fixture 106 which is obtained by engagement of the guide body 120 of the positioning fixture 106 in the guide recess 118 in the guide disk 122. In operation, the guide disk 122 is rotatably mounted. To this end, the main body 250 is screwed onto a housing of the main component 104 as a mounting bracket for the guide disk 122 or is connected in another manner. It is also possible to rotatably mount the guide disk 122 directly in the main component 104 of the object mounting device or the shaker tray.

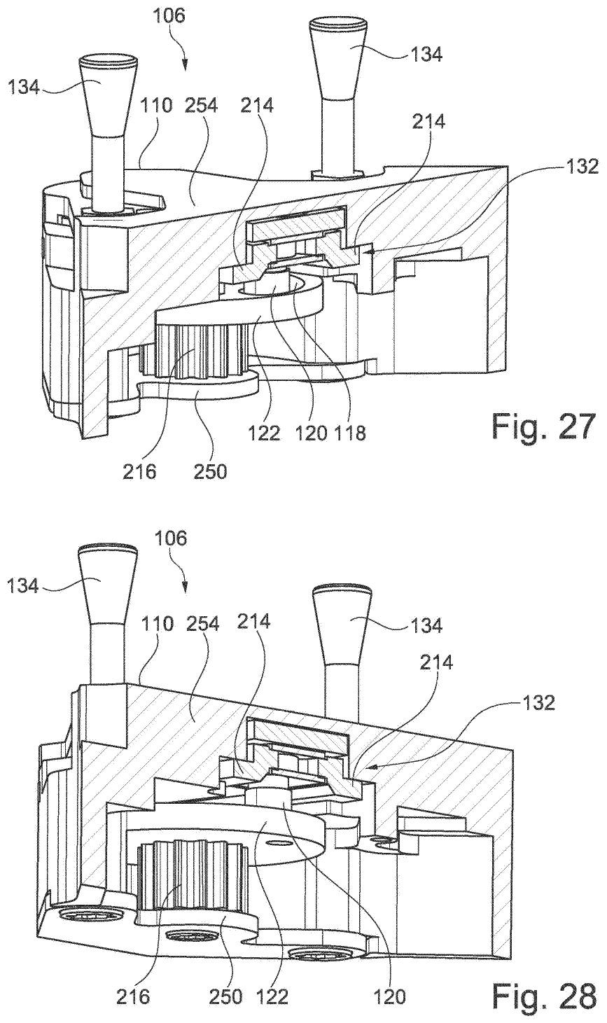

FIG. 27 shows the assembly in accordance with FIG. 26 in a housing 254 of a main component 104. FIG. 28 shows another view of the assembly in accordance with FIG. 27.

The housing 254 of the main component 104 (also termed a shaker tray) receives all of the components in accordance with FIG. 22A to FIG. 26 and at the same time can carry out a cooling body function for a temperature control device. The guide disk 122 with the guide recess 118 configured as a guide groove is rotatably mounted with respect to the main component 104. The positioning fixture 106 is mounted for linear displacement in the housing 254 of the main component 104.

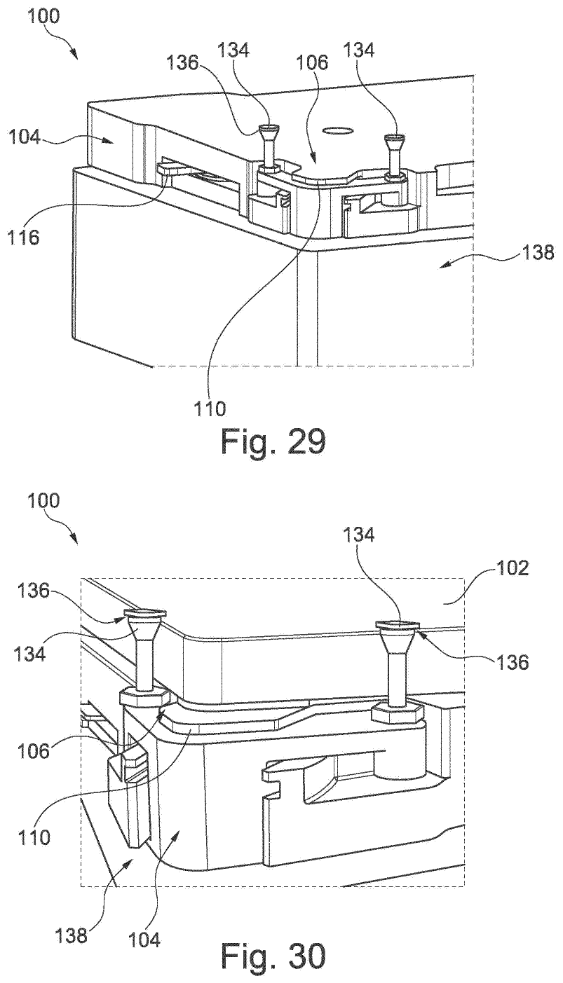

FIG. 29 shows a three-dimensional view of a portion of a laboratory instrument 100 in accordance with an exemplary embodiment of the invention. More precisely, FIG. 29 shows an alternative exemplary embodiment of the positioning pin 134. In accordance with FIG. 29, the positioning pins 134 have a laterally broadened head with an exaggerated profile on the underside of the head. This advantageously results in preventing a movement of an object carrier 102 fixed by means of the positioning pins 134 in the vertical direction against appropriate forces. Thus, the alternative construction of the positioning pins 134 shown in FIG. 29 provides the respective positioning fixture 106, 108 etc. with an increased security in the vertical direction.

FIG. 30 shows a three-dimensional view of a portion of a laboratory instrument 100 in accordance with another exemplary embodiment of the invention. FIG. 30 shows yet another exemplary embodiment of the positioning pins 134, with which an effective inhibition of a movement in the vertical direction against appropriate forces can be obtained. In similar manner to FIG. 29, the positioning pins 134 in accordance with FIG. 30 have a respective retaining profile 136 which is configured to make it impossible for the object carrier 102 to come away from the main component 104 in the vertical direction. Clearly, these positioning pins 134 clamp the object carrier 102 not only laterally, but also limit its movement in the vertical direction, because with the retaining profile 136, they provide a vertical stop for an upper side of an object carrier 102.

With the aid of FIG. 29 and FIG. 30, a person skilled in the art will recognize that other alternative constructions and shapes for the positioning pins 134 are possible for increasing the security in the vertical direction. In particular, the positioning pins 134 can also be non-cylindrical and/or not rotationally symmetrical in configuration, in order to modify the laboratory instrument 100 for alternative requirements, object carriers 102 and support bodies 138.

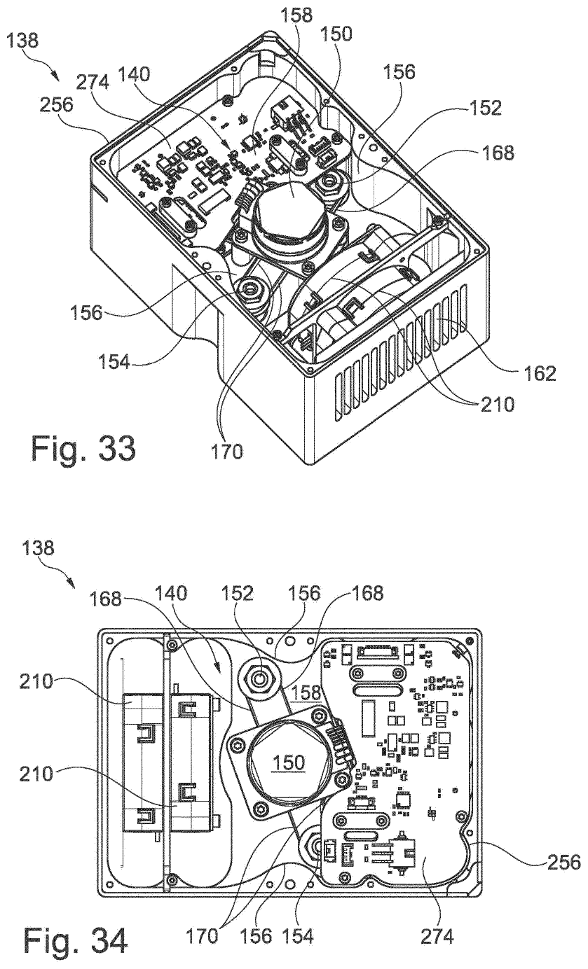

FIG. 31 shows an internal construction of a support body 138 or framework of a laboratory instrument 100 in accordance with an exemplary embodiment of the invention from above. FIG. 32 shows a top view of the internal construction of the support body 138 in accordance with FIG. 31. FIG. 33 shows an exposed interior of the support body 138 in accordance with FIG. 31 and FIG. 32 from below. FIG. 33 shows the support body 138 as a stationary framework assembly from below after removing a cover plate or connecting plate 230. FIG. 34 shows a top view of the exposed interior of the support body 138 in accordance with FIG. 33, from below.

The support body 138 in accordance with FIG. 31 to FIG. 34 forms a lower part of a laboratory instrument 100 for mixing a medium in an object carrier 102 in accordance with an exemplary embodiment of the invention. What is not shown in FIG. 31 to FIG. 34 is the movable main component 104 for receiving the object carrier 102 to be disposed on the support body 138 for mixing (see FIG. 13, for example). Referring again to FIG. 31 to FIG. 34, a mixing drive mechanism 140 for providing a driving force for mixing a medium in the object carrier 102 on the main component 104 is provided on the support body 138.

The mixing drive mechanism 140 comprises a drive device 150 which here is configured as an electric motor. A drive motor can be used as the drive device 150, for example a brushless DC motor. Furthermore, the mixing drive mechanism 140 contains a first eccentric 152 (also termed the first eccentric shaft) and a second eccentric 154 (also termed the second eccentric shaft), which can both be driven by means of the drive device 150. The eccentrics 152, 154 serve to transfer a driving force produced by the drive device 150 (more precisely a drive torque) to the main component 104, in order to stimulate the main component 104 plus an object carrier 102 mounted thereon and fixed thereto to carry out an orbital mixing motion in order to mix the medium in the object carrier 102.

Advantageously, both the first eccentric 152 as well as the second eccentric 154 are disposed on a peripheral edge 156 of the support body 138 and therefore outside a central region 158 of the support body 138. In this manner, a cavity is formed in the central region 158, which is bordered on the underside by the drive device 150 and laterally by the eccentrics 152, 154 as well as by a housing 256 of the support body 138. This cavity is available for the insertion of an interactive device (see reference numeral 128 and the above description, for example FIG. 13). In particular, this cavity can be used, if at the same time a central region 126 is generated in the main component 104 which is free from any fixing mechanism 114 (see FIG. 13, for example), to allow a free through connection through an upper region of the support body 138 and through the main component 104 to an object carrier 102 mounted on the main component 104. A through connection of this type can, for example, be used for an optical sensor or for an optical stimulation device in order to optically influence medium in the object carrier 102 from the laboratory instrument 100.

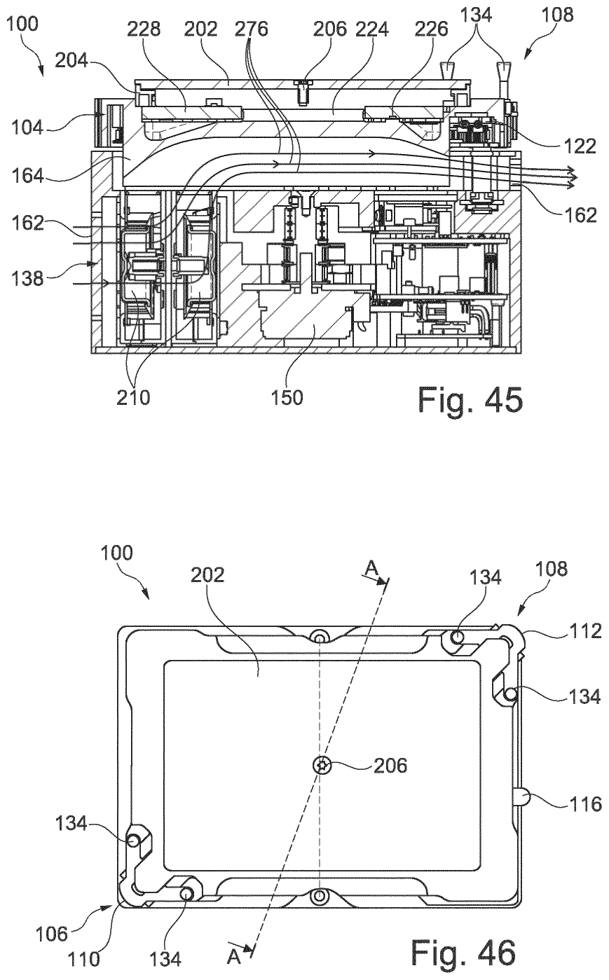

In the exemplary embodiment shown in FIG. 31 to FIG. 34, the support body 138 which leaves the cavity free is configured to allow a cooling fluid (in particular ambient air) to flow from outside the laboratory instrument 100 through the cavity (see FIG. 44 and FIG. 45). As can be seen best in FIG. 31, the housing 256 of the support body 138 is provided on mutually opposite sides with a respective cooling opening 162 through which the cooling fluid (in particular ambient air) flows from outside the laboratory instrument 100 through the cavity and then out of the laboratory instrument 100 again. This results in efficient air cooling. Furthermore, a cooling body 164 mounted on an underside of the main component 104 can be accommodated in the cavity in the central region 158. The ambient air sucked into the support body 138 by means of a cooling fan 210 can flow between the cooling fins of the cooling body and therefore take up heat from the cooling body 164 before the heated ambient air leaves the laboratory instrument 100 again. The air flow which is produced by the two cooling fans 210 leaves through an air outlet, i.e. leaves the laboratory instrument 100 after it has passed through the cooling body 164 or the main component 104 and has correspondingly picked up heat.

As can be seen to best effect in FIG. 31, a counterbalancing mass 172 for at least partial compensation of an imbalance produced by the first eccentric 152 and the second eccentric 154 is attached to a shaft of the drive device 150. As can be seen, this counterbalancing mass 172 is attached to the drive device 150 asymmetrically with respect to a direction of rotation of this shaft and moves with the drive device 150. Clearly, the counterbalancing mass 172 is orientated to counterbalance the two eccentrics 152, 154 during operation of the laboratory instrument 100. When, for example, two eccentrics 152, 154 are completely orientated to the left, then the counterbalancing mass is completely to the right.

Advantageously, the laboratory instrument 100 has four swivel supports 174 which are mounted in pairs on mutually opposite sides of the support body 138 and the main component 174. The construction and operation of these swivel supports 174 will be described in more detail below with reference to FIG. 35 and FIG. 36.

FIG. 31 and FIG. 32 show that the first eccentric 152 and the second eccentric 154 are disposed on mutually opposite side edges of the support body 138 and laterally offset with respect to each other. The drive device 150 is disposed between the first eccentric 152 and the second eccentric 154. Furthermore, the drive device 150 is coupled to the first eccentric 152 and the second eccentric 154 for synchronous movement of the first eccentric 152 and of the second eccentric 154. The mixing drive mechanism 140 is configured for an orbital mixing motion when the eccentrics 152, 154 transfer their eccentric drive movement to the main component 104. Thus, the main component 104 is in a state of being capable of moving along an orbital path on the support body 138 by means of the mixing drive mechanism 140 in order to mixture a medium contained in the object carrier 102.

Advantageously in this regard, the mixing drive mechanism 140 and the fixing mechanism 114 are decoupled from each other both functionally and spatially, i.e. they can be operated independently of each other. While the mixing drive mechanism 138 forms a part of the support body 138, the fixing mechanism 114 is part of the main component 104.

FIG. 31 to FIG. 34 show the support body 138 as an assembly with a stationary framework. FIG. 31 to FIG. 34 show the components which are relevant to the mixing device without the attached main component 104 or shaker tray.

The two eccentrics 152, 154 each form an eccentric shaft to deflect the main component 104 and produce an orbital mixing motion in a horizontal plane. Advantageously, two mutually opposite eccentrics 152, 154 are employed. Both eccentrics 152, 154 are driven synchronously by the drive device 150. The counterbalancing mass 172 which is attached to a shaft of the drive device 150 in the exemplary embodiment shown is rotatably mounted in the housing 256 of the support body 138 for the purpose of compensating for the imbalance. When mixing, the counterbalancing mass 172 is driven by the drive device 150 synchronously with the eccentric shafts or eccentrics 152, 154. In addition, the counterbalancing mass 172 contains a notch 270 which engages in a plunger 268 of a solenoid 266 in order to provide a defined zero position in the horizontal plane. This is advantageous so that even small vessels of an object carrier 102 which are fastened to the main component 104 can be safely worked on by a pipette device or another handling unit.

Furthermore, FIG. 31 and FIG. 32 show a linearly displaceably mounted slide 258 which actuates a linearly displaceably mounted slide 260 of the actuating device 116 (see FIG. 13) and therefore opens the fixing mechanism 114 or the locking device and therefore unlocks an object carrier 102.

Furthermore, an electromechanical actuator 262 is provided which pivots a lever by means of a turning movement and produces a displacement of the slide 258 via a connecting rod 264. The connecting rod 264 thus couples the pivotal movement of the lever of the actuator 262 with the linearly movable slide 258. As can be seen, the actuator 262 is disposed on the support body 138. The actuator 262 serves for the automated electromechanical control of the actuating device 116 disposed on the main component 104, which under this control selectively actuates the fixing mechanism 114 in order to engage or release the object carrier 102.

Referring now to FIG. 32, a bi-stable solenoid 266 is used in the support body 138 and can lock the counterbalancing mass 172. To this end, a plunger 268 can be locked onto the solenoid 266 in a notch 270 of the counterbalancing mass 172. The back of the plunger 268 can protrude into a light guide 272 in the unlocked state. The light guide 272 monitors the plunger 268 of the solenoid 266.

Advantageously, the counterbalancing mass 172 and the two eccentrics 152, 154 move synchronously when the laboratory instrument 100 is mixing. The eccentrics 152, 154 or eccentric shafts deflect the main component 104 which functions as a shaker tray during the mixing operation. The eccentrics 152, 154 both move synchronously with the counterbalancing mass 172 because they are driven via synchronous belts or toothed belts 168, 170 from the drive device 150. A first toothed belt 168 provides a torque coupling between a shaft of the drive device 150 and a shaft of the first eccentric 152. A second toothed belt 170 provides a torque coupling between the shaft of the drive device 150 and a shaft of the second eccentric 154. This is shown in FIG. 33 and FIG. 34.

The counterbalancing mass 172 serves to compensate for imbalances caused by the moving masses and is configured with notch 270 for stopping by the solenoid 266, whereupon a zero position of the shaker tray can be defined.

In accordance with FIG. 33, the drive device 150 is securely connected to the counterbalancing mass 172 or drives it directly. The two eccentric shafts are moved synchronously and in the same position via the two synchronous belts or toothed belts 168, 170 and synchronous wheels on the eccentrics 152, 154. The two synchronous belts or toothed belts 168, 170 serve to connect the drive device 150 plus counterbalancing mass 172 and the two eccentrics 152, 154. Said synchronous wheels (for example toothed wheels) are connected in a non-rotational manner to the eccentrics 152, 154 or eccentric shafts, which in turn deflect the main component 104.

Two cooling fans 210 can, for example, be formed as radial cooling fans in order to provide a convective transport of heat along a cooling body 164 or the main component 104. Just one cooling fan can also be provided, or at least three cooling fans. The cooling fan or cooling fans can also be constructed in a different manner to radial cooling fans.

Electronics boards 274 shown in FIG. 33 and FIG. 34 can be used in the housing 256 of the support body 138. An electronics board 274 of this type can be equipped with a microprocessor for independently controlling all of the functions of the laboratory instrument 100. As an example, only commands are sent and responses received. The entire control and regulation of the laboratory instrument 100 can be carried out by these internal electronics.

As an alternative to the depicted exemplary embodiment, the drive and mounting of the mixing device can also be used entirely without the temperature control device (with components such as the temperature control element 224 and integrated cooling body 164). This results in an even simpler construction for the laboratory instrument 100.

FIG. 35 shows an isolated swivel support 174 of a laboratory instrument 100 in accordance with an exemplary embodiment of the invention. FIG. 36 shows a tipped swivel support 174 between a support body 138 and a main component 104 of a laboratory instrument 100 in accordance with an exemplary embodiment of the invention. Expressed another way, FIG. 36 shows the swivel support 174 in a state in which it is installed in the laboratory instrument 100.

The swivel support 174 shown can be movably mounted between the support body 138 and the main component 104. More precisely, the bottom of the swivel support 174 can be mounted in a first depression 176 in the support body 138 and with the top in a second depression 178 in the main component 104. A first counter plate 180 on the support body 138 can be in physical contact with a bottom surface of the swivel support 174. Furthermore, a second counter plate 82 on the main component 104 can be disposed in physical contact with a top surface of the swivel support 174. The swivel support 174 and the counter plates 180, 182 are configured to interact substantially entirely by rolling friction and preferably substantially free from sliding friction. The swivel support 174 has a laterally broadened top section 184 and a laterally broadened bottom section 186. Between the top section 184 and the bottom section 186 is a pin section 188. An outer surface of the top section 184 can be configured as a first spherical surface 190. In corresponding manner, and outer surface of the bottom section 186 can be configured as a second spherical surface 192. In this regard, advantageously, both a first radius R1 of the first spherical surface 190 and also a second radius R2 of the second spherical surface 192 are larger than an axial length L of the swivel support 174.

Advantageously, the two counter plates 182, 184 can be produced from a ceramic. The swivel support 174 can be produced from a plastic. This combination of materials has been shown to be particularly advantageous tribologically and results in a low-wear and low-noise operation. The plastic serves to reduce the noise and also, because of its relatively higher deformability compared with rigid materials, it results in a smaller loading because of an advantageous Hertzian stress of the sphere-plane contact.

FIG. 35 and FIG. 36 therefore show a swivel support 174 with spherical ends. The swivel support 174 which is shown is produced from plastic, whereas the counter plates 182, 184 are preferably produced with flat ceramic upper and lower counter-surfaces. The swivel support 174 produced from plastic fits into the cylindrical depressions 176, 178 of the support body 138 or main component 104.

The larger the respective sphere diameter 2×R1 or 2×R2 is, the smaller is the load or pressure. A further advantage of the swivel support 174 over a ball with the same radius as the ends of the swivel support 174 is the significantly smaller radial extent of the swivel support 174. This saves space and produces a compact configuration for the laboratory instrument 100.

As can be seen in FIG. 31 and FIG. 32, four swivel supports 174 with spherical ends are preferably used for the axial mounting of the main component 104 with respect to the support body 138. However, a different number of swivel supports 174 is also possible, for example three or at least five. The swivel supports 174 sit in the depressions 176, 178 and are therefore guided laterally. The counter plates 180, 182 produced from ceramic and the swivel supports 174 produced from plastic advantageously work together to reduce noise during the mixing operation of the laboratory instrument 100.

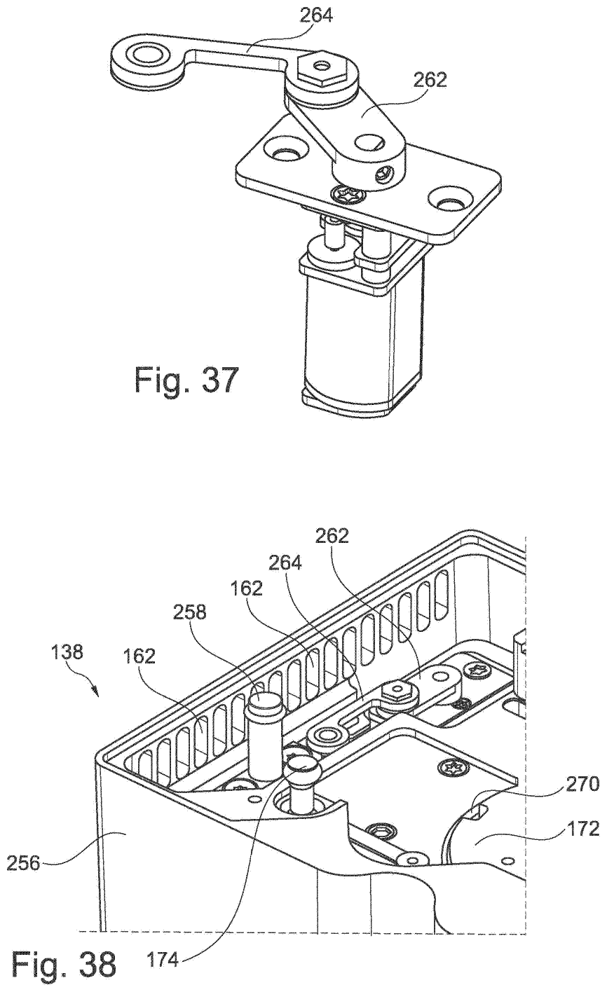

FIG. 37 shows an actuator 262 of a laboratory instrument 100 in accordance with an exemplary embodiment of the invention in an uninstalled state. The functionality of the actuator 262 was described above with reference to FIG. 31 and FIG. 32.

FIG. 38 shows an interior of a support body 138 of a laboratory instrument 100 in accordance with an exemplary embodiment of the invention. The actuator 262 is shown in FIG. 38 in its locked position. The actuator 262 serves to actuate the slide 258.

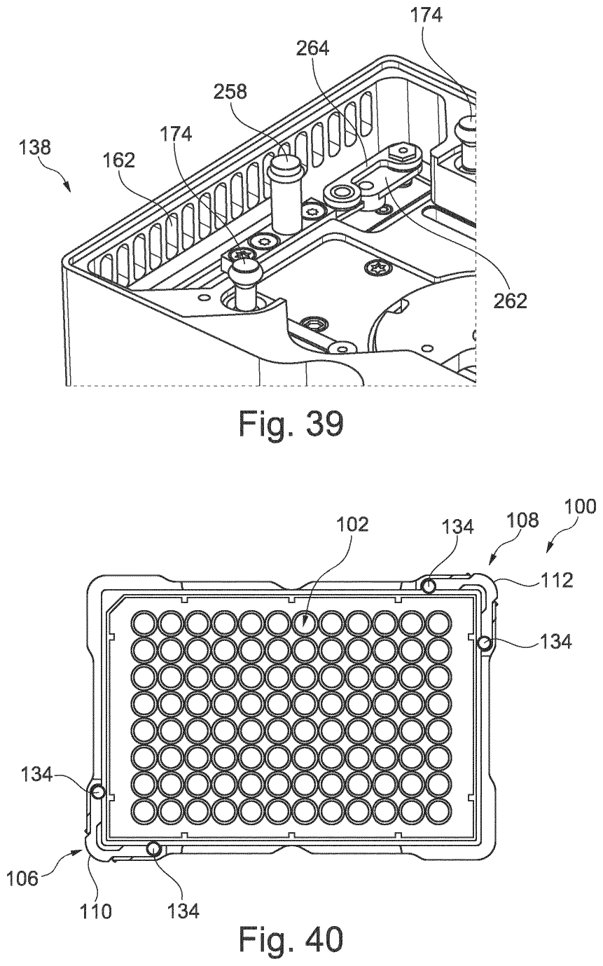

FIG. 39 shows another view of the assembly in accordance with FIG. 38. The actuator 262 is shown in FIG. 39 in its unlocked position. In this position, the object carrier 102, for example a sample carrier plate, can be freely removed from the laboratory instrument 100. The actuator 262 which is shown serves to actuate the slide 258 which therefore is located in a different position as shown in FIG. 39 to that shown in FIG. 38. The slide 258 acts as a coupling element and in operation presses against an opening lever or slide 260 of the main component 104, moves the slide 260 linearly and therefore actuates the force-transmitting mechanism 130 which is configured, for example, as a synchronous mechanism (see FIG. 13). As an alternative to the exemplary embodiment of FIG. 38 and FIG. 39, for example, a rotary or purely linear actuator 262 can also be used. In accordance with FIG. 38 and FIG. 39, the slide 258 acts as linearly movably mounted slides.

FIG. 40 shows a top view of a laboratory instrument 100 in accordance with an exemplary embodiment of the invention with an object carrier 102 mounted on it which is engaged by positioning pins 134 of the laboratory instrument 100. In the view shown, the object carrier 102, which is a sample carrier plate here, is locked and shown from above.

The actuator 262 opens and the pre-tensioning element 198 configured as a spring or springs closes the mechanism.

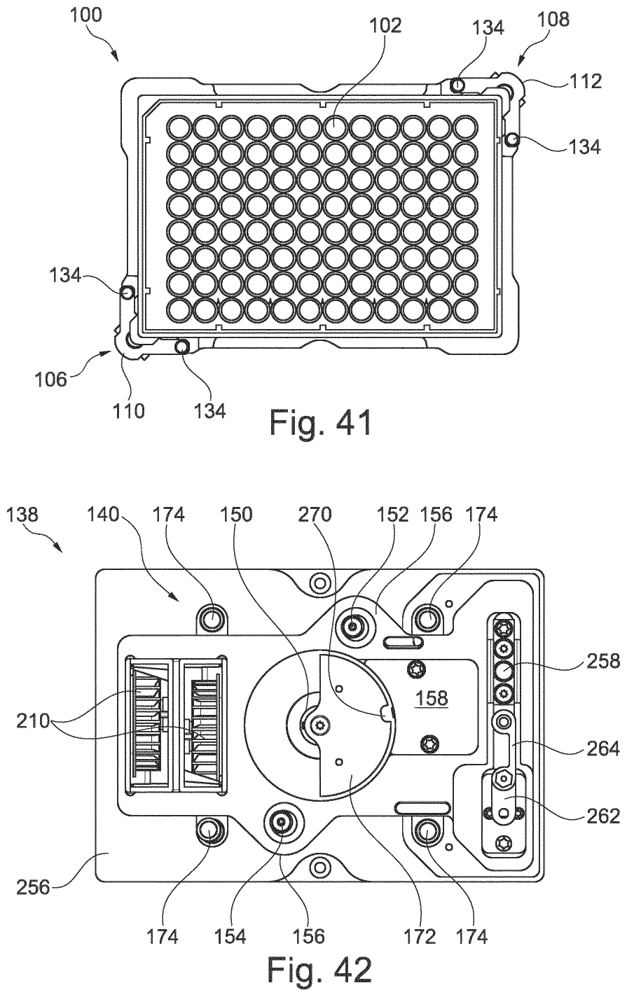

FIG. 41 shows the assembly in accordance with FIG. 40, wherein the object carrier 102 is now released from the positioning pins 134. The view of FIG. 41 shows the object carrier formed as a sample carrier plate in an unlocked state from above.

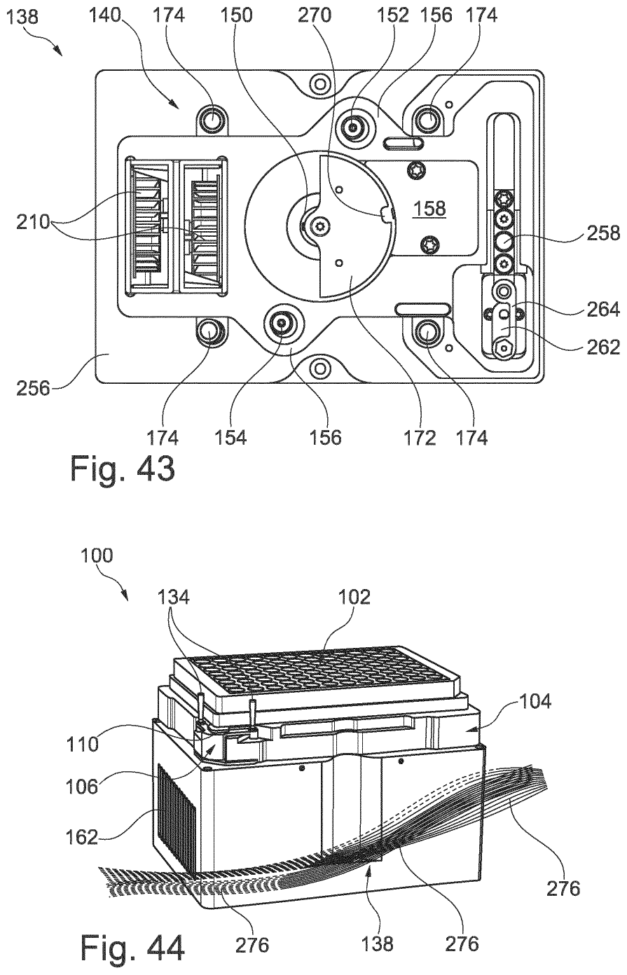

FIG. 42 shows a top view of a support body 138 of a laboratory instrument 100 in accordance with an exemplary embodiment of the invention in an actuator position with a locked object carrier 102. FIG. 43 shows the assembly in accordance with FIG. 42 in an actuator position with an unlocked object carrier 102.

FIG. 44 shows a three-dimensional view of a laboratory instrument 100 in accordance with an exemplary embodiment of the invention, wherein a cooling flow of air 276 is shown. Ambient air can, for example, be sucked in through the cooling fan 210 and can flow through cooling openings 162 in a side wall of the support body 138 into the interior of the laboratory instrument 100. Inside the laboratory instrument 100, the air flow 276 picks up heat, for example on the underside of a cooling body 164, and then flows in a heated state through another cooling opening 162 which is disposed further up into an opposite side wall of the laboratory instrument 100 out of the laboratory instrument 100. FIG. 44 visualizes the flow of air between the inlet and outlet.

FIG. 45 shows a cross-sectional view, more precisely a longitudinal section, of a laboratory instrument 100 in accordance with an exemplary embodiment of the invention. The airflow 276 inside the laboratory instrument 100 is clearly shown in FIG. 45. This flow of air acts to cool the main component 104, which can also act as a cooling body, or it can include a cooling body 164 (in particular with cooling fins).

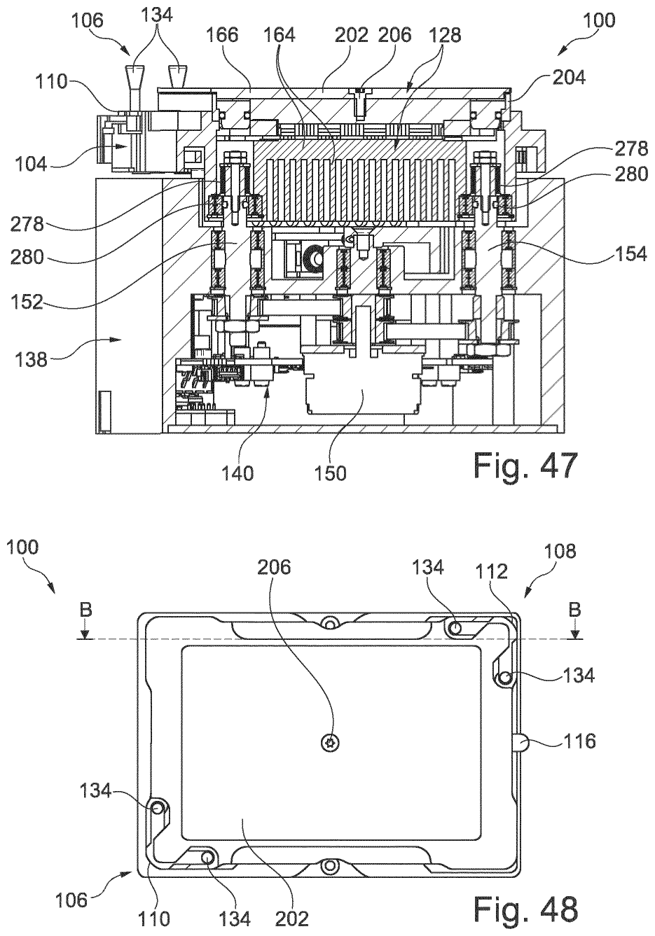

FIG. 46 shows a top view of a laboratory instrument 100 in accordance with an exemplary embodiment of the invention and shows a section line A-A. FIG. 47 shows a cross-sectional view of the laboratory instrument 100 in accordance with FIG. 46 along the section line A-A and therefore along the two eccentric shafts or eccentrics 152, 154. Because they are positioned in the edge region, a central space is advantageously left free for a cooling body 164. Alternatively, the free central region 126/158 can be used as an optical channel to an object carrier 102 fixed on the main component 104 (in particular to a sample carrier plate present on the object mounting device or the shaker tray). This can, for example, be used for optical sensor systems or for optical stimulation of medium in the object carrier 102.

In particular, FIG. 47 shows zigzag springs 278 on the eccentrics 152, 154 in order to produce a force on the axial bearing by means of the swivel supports 174. Clearly, this can prevent lifting of the univalent bearing.

Furthermore, a compensating element 280, for example an O-ring or round ring or a different device, can be attached to a respective eccentric 152, 154 to compensate for misalignments. This is advantageous in order to ensure that despite misalignments of the eccentrics 152, 154, the axial mounting of the main component 104 always rests on the swivel supports 174. Although the swivel supports 174 described in FIG. 35 and FIG. 36 are particularly advantageous, these can also be replaced by balls.

Preferably, the shaft diameter can be smaller than the ball bearing diameter, particularly preferably significantly smaller. This guarantees a solely linear contact between the O-ring and the inner ring of the bearing. This therefore ensures that only a linear contact exists between the compensating element 280, for example configured as an O-ring, and an inner ring of the bearing.

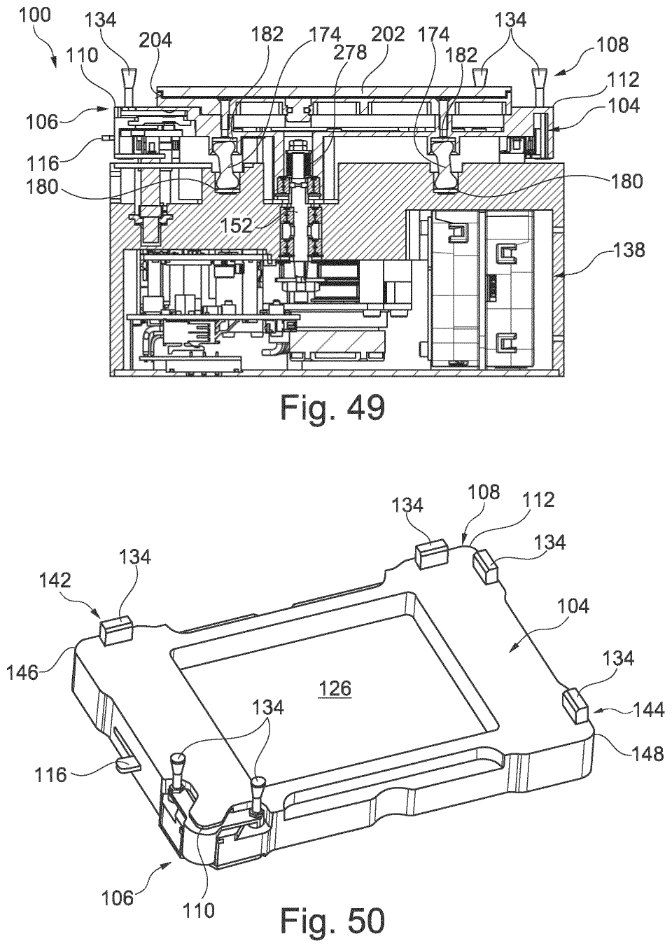

FIG. 48 shows a top view of a laboratory instrument 100 in accordance with an exemplary embodiment of the invention and shows a section line B-B. FIG. 49 shows a cross-sectional view of the laboratory instrument 100 in accordance with FIG. 48 along the section line B-B in order to show the swivel support mounting.

The upper side and underside of each of the swivel supports 174 which are shown and which are produced from plastic are spherical in shape. Ideally, the radius R1 or R2 is selected so as to be as large as possible. Because of the deformation of the plastic and a sufficiently large radius R1 or R2, the Hertzian stress between the plane and sphere and therefore the load can be kept low. This increases the service life of the swivel supports 174 and the counter plates 180, 182, which are preferably produced from ceramic. The movement of the swivel supports 174 on the counter plates 180, 182 advantageously occurs by rolling friction. A surface of the counter plates 180, 182 which is as hard as possible has been shown to be advantageous.

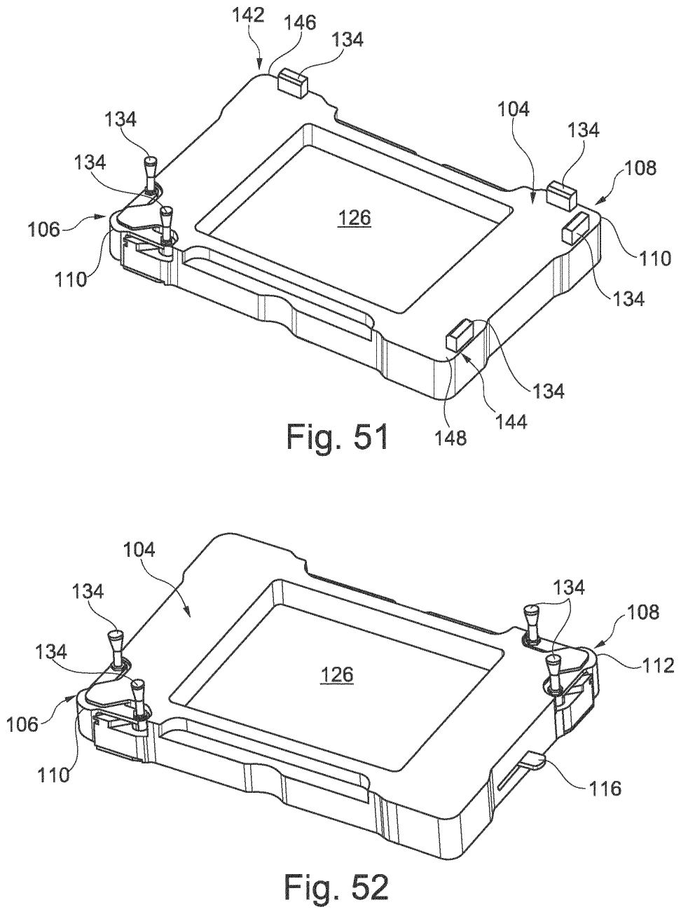

FIG. 50 shows a three-dimensional view of a main component 104 of a laboratory instrument 100 in accordance with an exemplary embodiment of the invention. FIG. 51 shows another three-dimensional view of the main component 104 in accordance with FIG. 50. The main component 104 which is shown is equipped with a movable positioning fixture 106 and additional stationary positioning fixtures 108, 142, 144. The stationary positioning fixtures 108, 142, 144 are formed in the exemplary embodiment shown by solid anchoring pieces or solid anchoring bars.

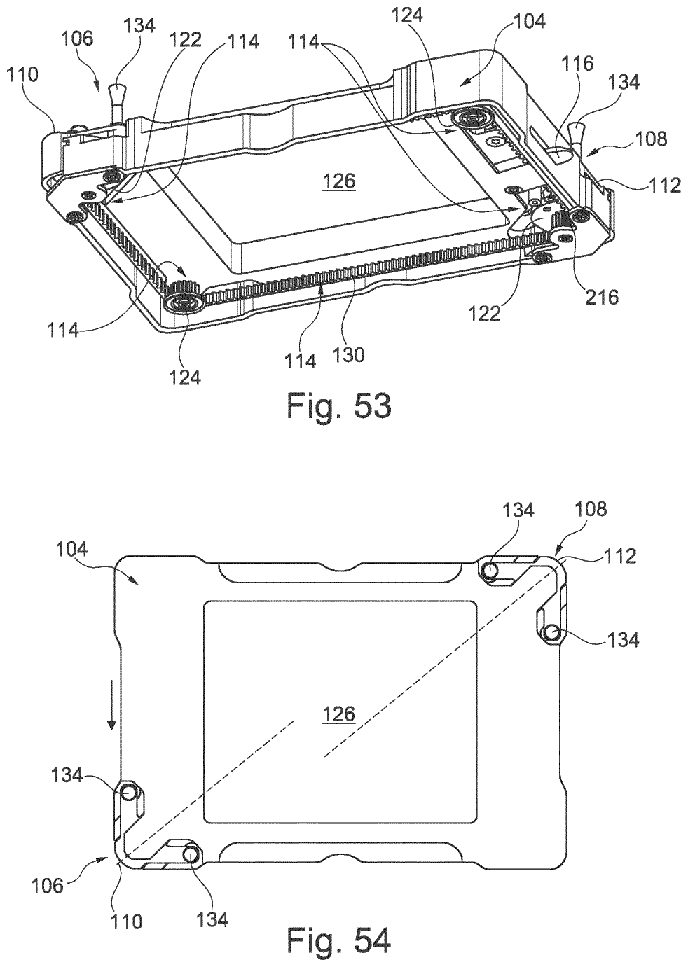

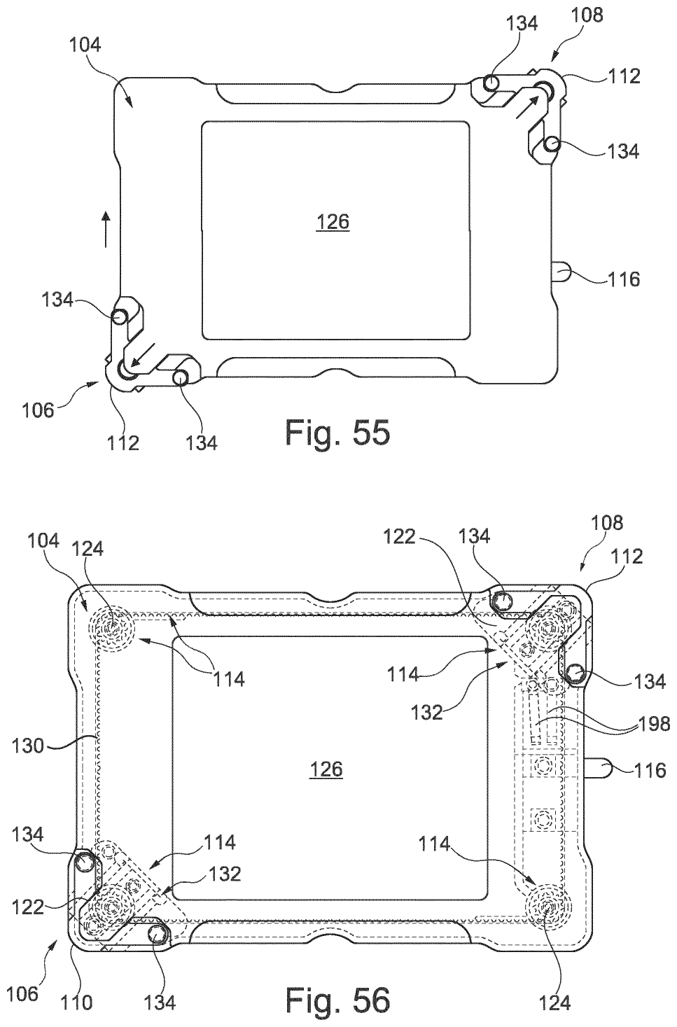

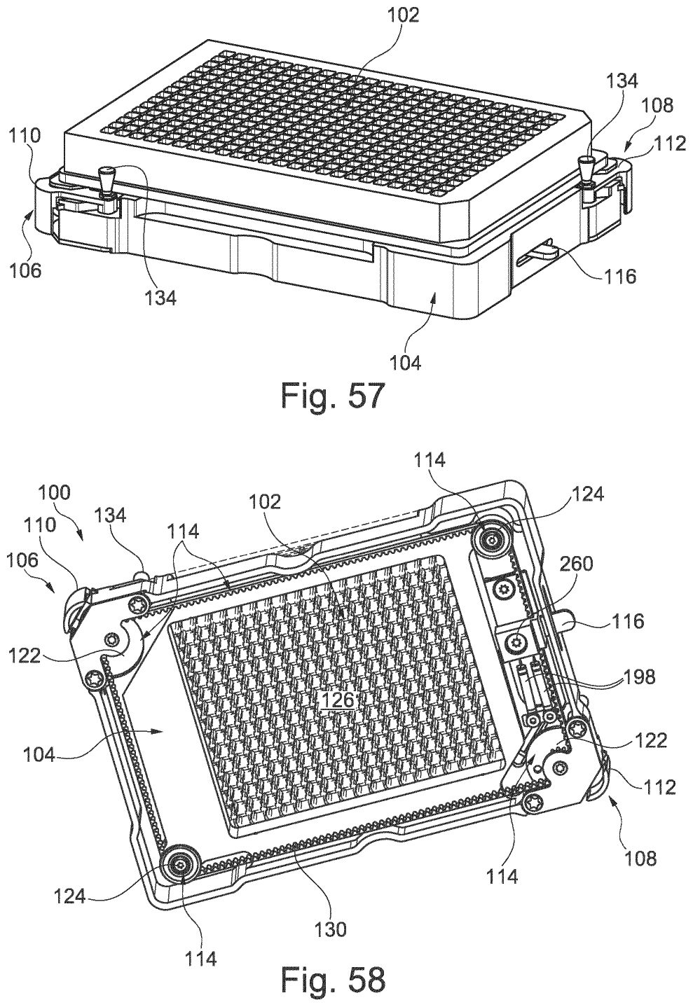

FIG. 52 shows a three-dimensional view of a main component 104 of a laboratory instrument 100 with two movable positioning fixtures 106, 108 in opposite corners 110, 112 of the main component 104 in accordance with another exemplary embodiment of the invention, from above. FIG. 53 shows a bottom view of the main component 104 in accordance with FIG. 52. FIG. 54 shows a top view of the main component 104 in accordance with FIG. 52 with positioning fixtures 134 for the movable positioning fixtures 106, 108 in a locked state. FIG. 55 shows a top view of the main component 104 in accordance with FIG. 52 with the positioning pins 134 in an unlocked state. FIG. 56 shows a show-through view of the main component 104 in accordance with FIG. 52, depicting invisible lines. FIG. 57 shows a three-dimensional view of the main component 104 of the laboratory instrument 100 in accordance with FIG. 52 in a locked state of an object carrier 102. The object carrier 102 here is configured as a sample carrier plate (for example as a microtiter plate with 384 wells), which is fixed to the main component 104 as an object mounting device in the operational state shown. FIG. 58 shows a bottom view of the main component 104 of the laboratory instrument 100 in accordance with FIG. 57 with an inserted sample carrier plate, from below.

The linearly displaceably mounted positioning fixtures 106, 108 shown in FIG. 52 have tapered positioning pins 134 in the upper region (which can alternatively also have other shapes). In operation, the positioning pins 134 move away from the object carrier 102 (for unlocking) or towards them (for locking). The positioning pins 134, which are tapered at least in sections, can be mounted on the main component 104 in an exchangeable manner, for example by being screwed onto a respective positioning fixture 106, 108.

FIG. 52 shows an actuating device 116 as a lever for manual actuation of the positioning fixtures 106, 108. A manual operation of this type can be advantageous, for example for emergency unlocking or for rapid loading/unloading of the laboratory instrument 100 by laboratory personnel.

The free central region 126 of the main component 104 provides accessibility to the object carrier 102 which is configured here as a sample carrier plate. This free accessibility from below is achieved by positioning or attaching all of the components of the main component 104 in the edge region. This provides, for example, for space-saving integration of a temperature control device. Even an optical measurement can be carried out on the medium in the object carrier 102 from below through the main component 104 because of the free central region 126 of the main component 104.

FIG. 58 shows, in the two corners of the main component 104 in which the movable positioning fixtures 106, 108 are disposed, a respective rotatably mounted coupling element in the form of a guide disk 122 for guiding (more precisely linear movement) of the positioning fixtures 106, 108. The respective guide disk 122 (which also can be described as a cam disk) contains the track-shaped groove as a guide recess 118, into which a guide body 120 (for example a pin) of the linearly movable positioning fixtures 106, 108 protrudes. The guide body 120 therefore engages in the guide recess 118 of the guide disk 122 (in particular into a track-shaped groove of a cam disk) and thus ensures—initiated by the rotation—a linear displacement of the movable positioning fixtures 106, 108. The guide disk 122 does not necessarily have to be a cylindrical disk but can be a disk body which contains a track-shaped groove, and can also be different geometrically.

Furthermore, FIG. 58 shows two rotatably mounted guide pulleys 124 for a toothed belt or synchronous belt of a force-transmitting mechanism 130 of the fixing mechanism 114. This synchronous belt or toothed belt brings about a synchronous movement of all of the positioning fixtures 106, 108.

The actuating device 116 in accordance with FIG. 58 furthermore has a linearly mounted slide 260 for manual or automatic actuation of the fixing mechanism 114. As an example, a pin-shaped slide 258 of the support body 138 as shown in FIG. 31 can engage in a complementarily shaped depression of the slide 260 and displace it. When no force (manual or caused by an actuator 262, see FIG. 31) acts on this slide 260, the slide 260 is moved backwards into its initial position by a pre-tensioning element 198 which can be formed as a mechanical spring (or another pre-tensioning element, for example a magnet). The slide 260 is securely connected to the synchronous belt or toothed belt of the force-transmitting mechanism 130 which produces a synchronous rotational movement of the guide disks 122, whereupon in turn, the positioning fixtures 106, 108 are displaced linearly.

The exemplary embodiments of the actuating device 116 described above are based on a linear displacement of an actuating device. It should, however, be emphasized that the actuating device 116 in accordance with other exemplary embodiments of the invention could also be actuated by turning, pivoting or rotation in order in this manner to act on the synchronous belt drive or another force-transmitting mechanism 130.

The pre-tensioning element 198 configured as a tension spring can be configured to move the linearly mounted slide 260 back into its rest position and therefore to move the positioning fixtures 106, 108 in the direction of the object carrier 102 (i.e. into a locking position). This fixing mechanism 114 therefore closes automatically if no actuating force is acting.

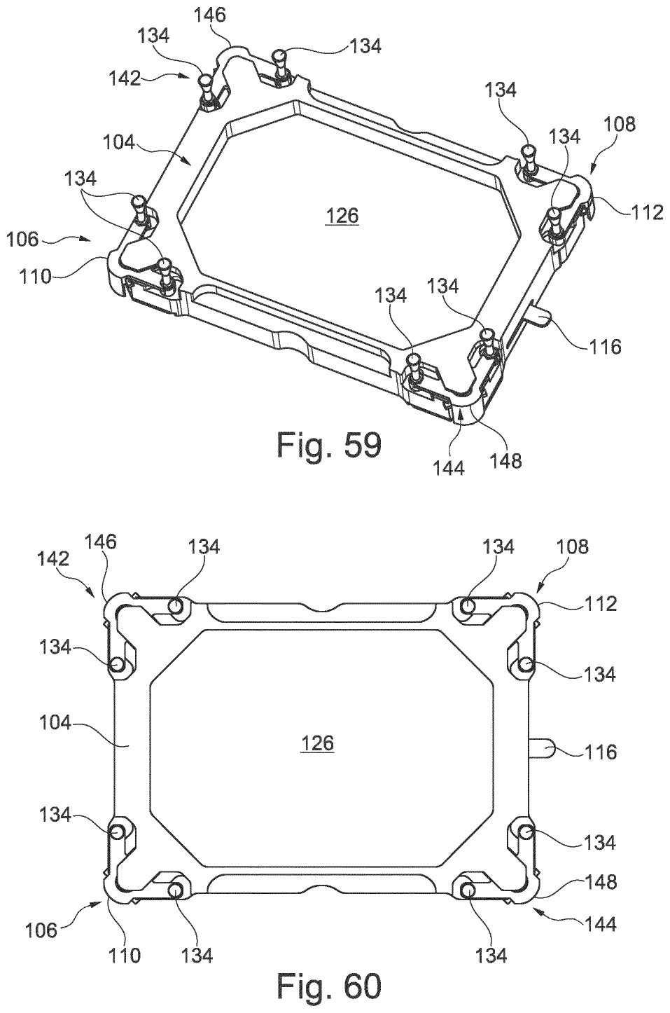

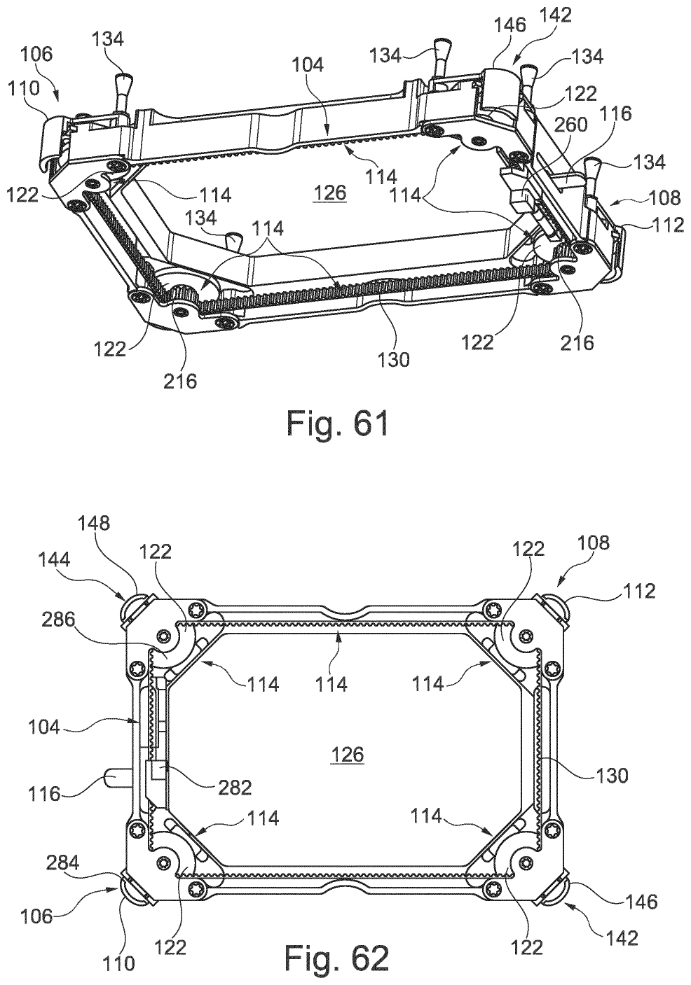

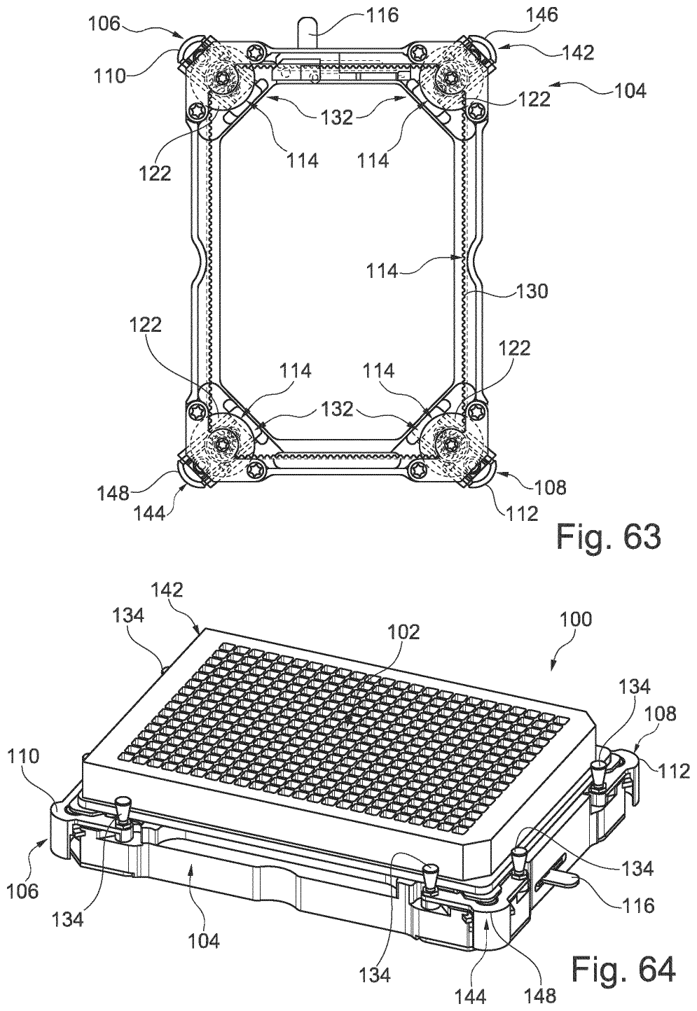

FIG. 59 shows a three-dimensional view of a main component 104 of a laboratory instrument 100 in accordance with an exemplary embodiment of the invention with positioning pins 134 in all four corners. Thus, FIG. 59 shows the main component 104 with four movable positioning fixtures 106, 108, 142, 144 at all four corners 110, 112, 146, 148 of the main component 104 from above. FIG. 60 shows a top view of the main component 104 in accordance with FIG. 59. FIG. 61 shows a three-dimensional view of an underside of the main component 104 in accordance with FIG. 59. FIG. 62 shows a view of an underside of the main component 104 in accordance with FIG. 59. FIG. 63 shows a bottom view of the main component 104 in accordance with FIG. 59, showing invisible lines. FIG. 64 shows a three-dimensional view of a main component 104 of a laboratory instrument 100 with an object carrier 102 in accordance with FIG. 59 to FIG. 63 mounted thereon.

Clearly, in accordance with FIG. 59 to FIG. 64, a guide disk 122 with guide recess 118 is disposed in each corner 110, 112, 146, 148 of the main component 104, wherein a respective guide body 120 of a respective movable positioning fixture 106, 108, 142, 144 engages in the associated guide recess 118. All four guide disks 120 are mechanically coupled to the actuating device 116 via a common toothed belt as the force-transmitting mechanism 130.

In each exemplary embodiment described here with at least one movable positioning fixture, sensor-based monitoring of the movement of a positioning fixture can be employed. The monitoring of movement and position of the movable positioning fixtures 106, 108, 142, 144 and therefore of the operational state of the locking of unlocking can be accomplished in accordance with FIG. 59 to FIG. 64 by one or more sensors (for example a Hall effect sensor cooperating with a magnet, a light guide, etc.). The sensor-based monitoring of the movement of a positioning fixture is advantageous for the operational safety of the liquid handling system or of a mixing device. The sensor-based monitoring can, for example, be in respect of the linear position of the movable positioning fixtures 106, 108, 142, 144, the position of a respective rotatably mounted guide disk 122 (or of another coupling element) or the linear position of the slide 260 of the actuating device 116.

Reference numeral 282 in FIG. 62 indicates a first possible sensor position (for example for linear monitoring of an actuating lever of the actuating device 116). Reference numeral 284 indicates a further possible sensor position (for example for linear monitoring of the associated movable positioning fixture 106). Reference numeral 286 indicates a third possible sensor position (for example for monitoring the rotation of the guide disk 122 or of another coupling element or of a guide pulley 124).

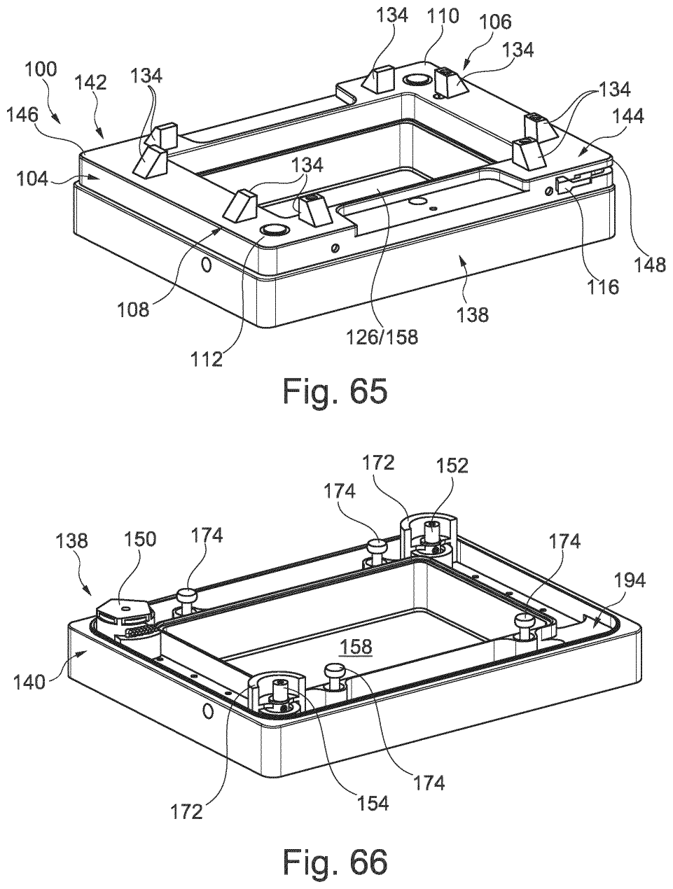

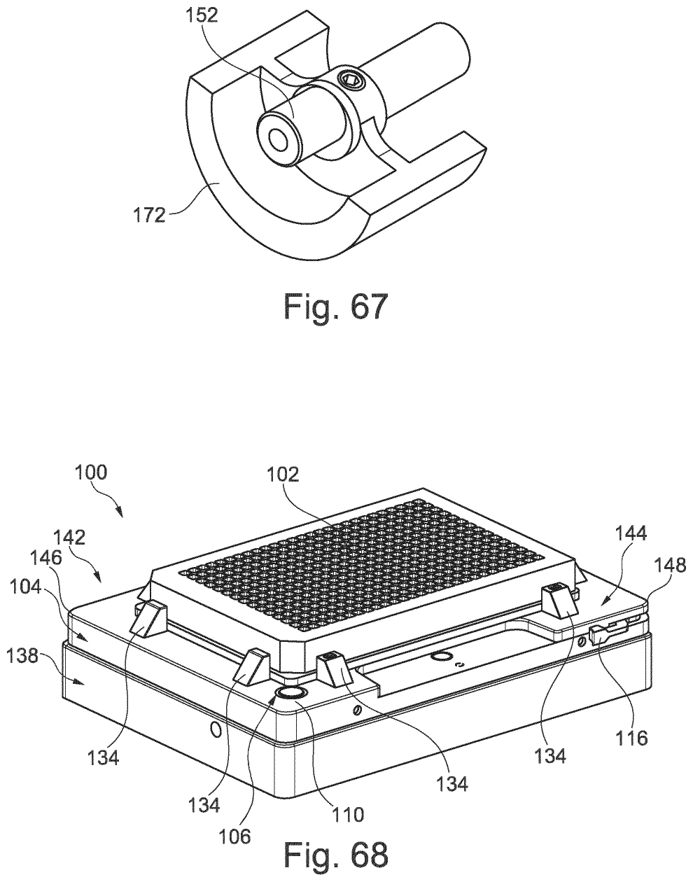

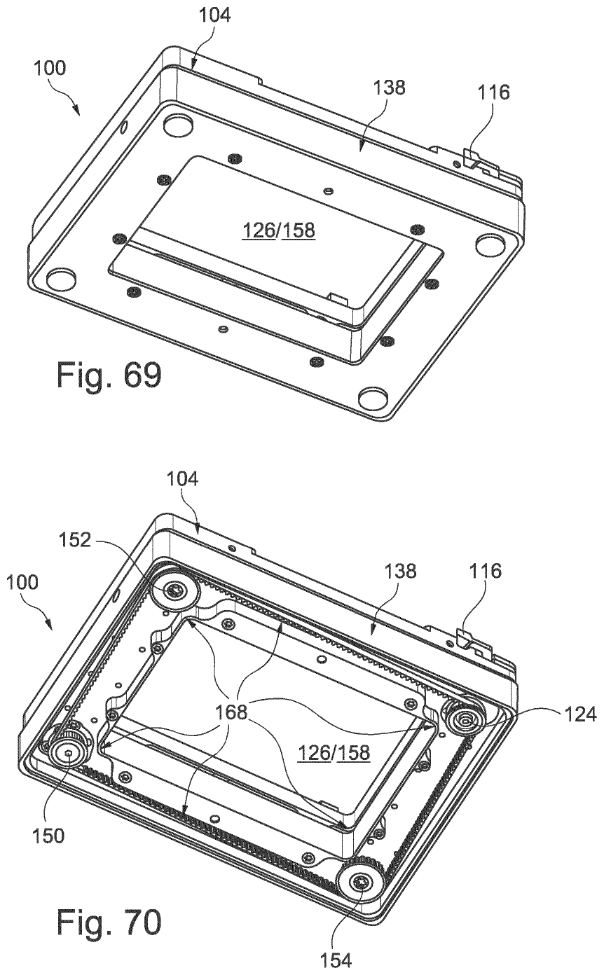

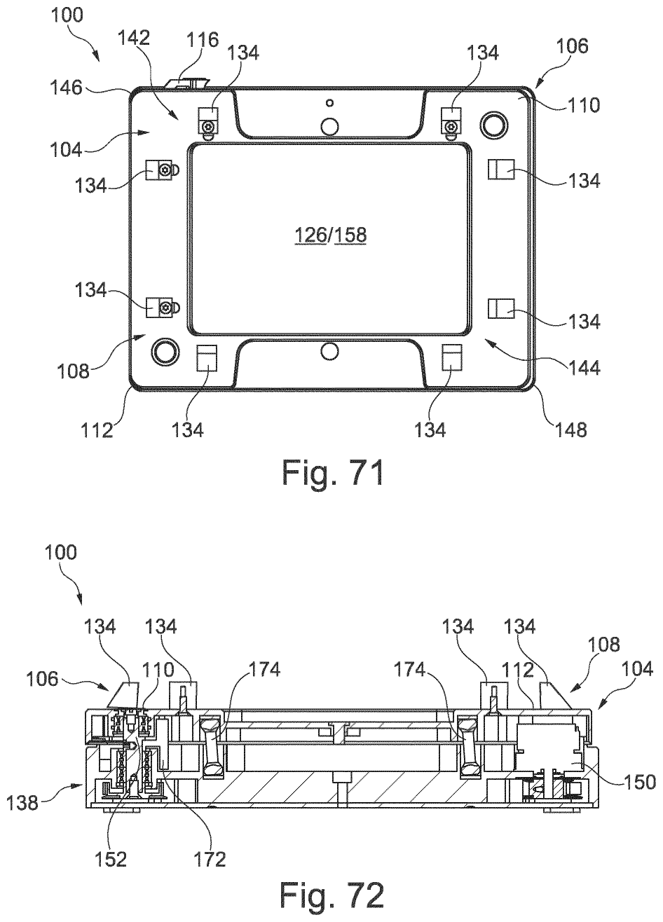

FIG. 65 shows a three-dimensional view of a laboratory instrument 100 in accordance with another exemplary embodiment of the invention from above, wherein the laboratory instrument 100 contains a mixing device. FIG. 66 shows a three-dimensional view of a support body 138 of the laboratory instrument 100 in accordance with FIG. 65 from above. FIG. 67 shows an eccentric 152 with counterbalancing mass 172 of a mixing drive mechanism 140 of the support body in accordance with FIG. 66. FIG. 68 shows the laboratory instrument 100 in accordance with FIG. 65 with an object carrier 102 mounted thereon, which is configured here as a microtiter plate. FIG. 69 shows an underside of the laboratory instrument 100 in accordance with FIG. 65. FIG. 70 shows an underside of the laboratory instrument 100 in accordance with FIG. 65 without the bottom cover, i.e. from below without a cover. FIG. 71 shows a top view of the laboratory instrument 100 in accordance with FIG. 65. FIG. 72 shows a cross-sectional view of the laboratory instrument 100 in accordance with FIG. 65, more precisely a section which makes it possible to see a mixing drive mechanism 140 with eccentrics 152, 154 and counterbalancing masses 172, as well as swivel supports 174.

As can be seen in FIG. 70, the support body 138 has an annular closed force-transmitting mechanism 168 which is configured as a peripheral closed toothed belt. This acts to transmit the driving force from the drive device 150 to the first eccentric 152 in a first corner and to the second eccentric 154 in a second corner which is opposite to the first corner. The drive device 150 is disposed in a third corner. A guide pulley 124 is disposed in a fourth corner.

As can be seen to best effect in FIG. 66 and FIG. 67, a first counterbalancing mass 172 is attached to the first eccentric 152 so as to be rotatable therewith. Furthermore, a second counterbalancing mass 172 is attached to the second eccentric 154 so as to be rotatable therewith.

The exemplary embodiment in accordance with FIG. 65 to FIG. 72 shows a laboratory instrument 100 with an annular main component 104 with a rectangular outer contour and an annular support body 138 also with a rectangular outer contour. A through hole of the annular main component 104 forms a free central region 126 of the main component 104. Correspondingly, a through hole of the annular support body 138 forms a free central region 158 of the support body 138. In the assembled state of the annular main component 104 and the annular support body 138, the free central regions 126, 158 are aligned or flush, so that the laboratory instrument 100 formed from the main component 104 and the support body 138 also has a central through hole which is formed by the central regions 126, 158.

The laboratory instrument 100 obtained thereby has a mixing device and moreover can be used for any applications which require accessibility to the object carrier 102 (in particular a sample carrier plate or plate with laboratory vessels) from below or requires a completely free optical path. As an example, this laboratory instrument 100 can be used in cell culture in a nutrient with simultaneous online measurement of the optical density (OD) in order to monitor cell growth. To ensure good cell growth, as large an exchange surface between gas and liquid as possible is required. This can be produced by means of an orbital mixing motion.

Because the space in the center of the laboratory instrument 100 is completely free (see the free central regions 126, 158), many other applications can be carried out with the laboratory instrument 100 which require accessibility to the sample vessels from below (such as temperature control, selection, magnetic separation and other application).

In the magnetic separation process, for example, successive washing and separation steps can be carried out without the need to move the object carrier 102 (for example a sample carrier plate) to another position. This can be achieved by positioning electromagnets or movable permanent magnets under the object carrier 102 configured as a sample carrier plate.

As an example, sample carrier plates can be alternately placed on a mixing device and/or temperature control device and then placed by means of a gripper on a magnetic separation device with permanent magnets. Next, in order to carry out the washing steps, transport back to the mixing device can be carried out. The movement of the sample carrier plates to a magnetic separation position and then onto a mixing device (for example to carry out washing steps) can be dispensed with by using a combined laboratory instrument. A movement of this type can, however, be carried out when a combined laboratory instrument of this type is not available and individual positions are used.

The provision of a laboratory instrument 100 in accordance with an exemplary embodiment of the invention in the form of a combination of an orbital shaker with electrically switchable magnets or linear/rotatably movable permanent magnets in the direction of the sample carrier plate saves space, time and unnecessary movements in fully automatic liquid handling systems.

Returning to FIG. 65 to FIG. 72, the support body 138 forms a stationary framework. The main component 104, on the other hand, forms a shaker tray for receiving an object carrier 102 which in particular is configured as a sample carrier plate or as laboratory vessels. Because of the opening in the laboratory instrument 100 through the central regions 126, 158, the vessels of the sample carrier plate are advantageously fully accessible from below. This means that a temperature control device, an optical measuring device and/or another interactive device 128, for example, could be placed in the central regions 126, 158.

In the exemplary embodiment in accordance with FIG. 65 to FIG. 72, the actuating device 116 has an actuating lever for unlocking or locking the object carrier 102. In the exemplary embodiment described, the actuation is carried out by rotation, but can also be carried out a different way (for example by means of a longitudinal displacement).

Furthermore, the exemplary embodiment in accordance with FIG. 65 to FIG. 72 includes movable positioning fixtures 106, 108, 142, 144, but alternatively or in addition can also be combined with fixed positioning fixtures. As an example, fixed anchoring bars could be provided, but also all of the positioning fixtures 106, 108, 142, 144 could be movable.

As shown in FIG. 72, swivel supports 174 with top and bottom spherical ends (univalent bearing) can be mounted on a flat running surface in the exemplary embodiment in accordance with FIG. 65 to FIG. 72. Preferably, here again, at least three swivel supports 174 are provided; four are shown in the exemplary embodiment.

Two eccentrics 152, 154 or eccentric shafts can be provided for deflecting the main component 104 with respect to the stationary support body 138. The counterbalancing masses 172 act to compensate for the imbalance caused by the moving masses and are attached directly to the eccentrics 152 or 154 in the exemplary embodiment in accordance with FIG. 65 to FIG. 72.

The synchronous belt drive or toothed belt 168 shown in FIG. 70 for mechanically coupling the eccentrics 152, 154 to the drive device 150 and the tensioning pulley or guide pulley 124 can also be configured in a different manner (for example in accordance with FIG. 34). The synchronous belt or toothed belt 168 acts to move the eccentrics 152, 154 synchronously.

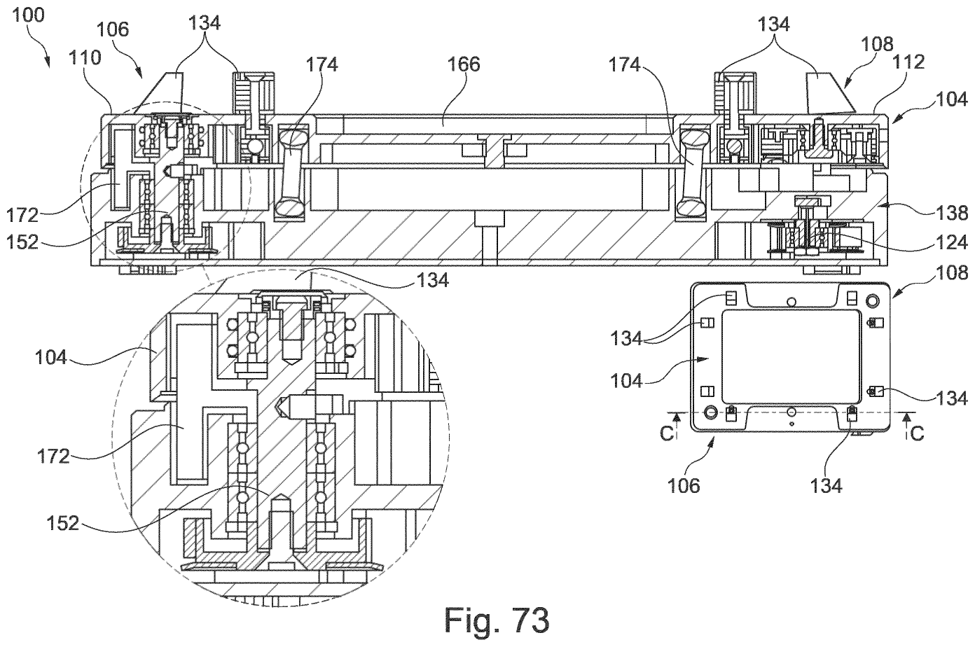

FIG. 73 shows different views of components of the laboratory instrument 100 in accordance with FIG. 65, which includes a mixing device with an orbitally moved counterbalancing mass 172. FIG. 73 shows a sectional view along a sectional line C-C as well as a detail of this sectional view.

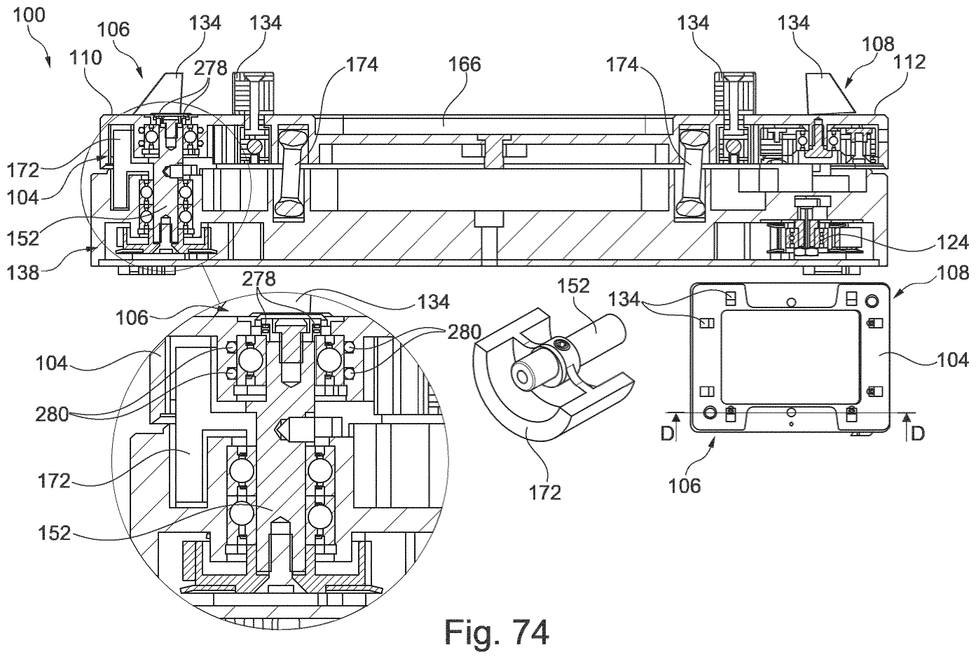

FIG. 74 shows different views of components of the laboratory instrument 100 in accordance with FIG. 65. FIG. 74 shows a sectional view along a sectional line D-D, a detail of this sectional view and a three-dimensional view of the first eccentric 152 with counterbalancing mass 172. FIG. 74 shows a sectional view through the mixing device and shows a portion of the mixing drive mechanism 140. In particular, FIG. 74 shows a first eccentric shaft or the first eccentric 122 with the counterbalancing mass 172 rigidly attached thereto. Furthermore, FIG. 74 shows two of the swivel supports 174 of the swivel support mount which accomplishes axial mounting of the shaker tray or main component 104 with respect to the support body 138 which is configured as a stationary framework. Furthermore, a zigzag spring 278 is attached to the first eccentric 152, which acts to produce a contact pressure or normal force on the univalent axial bearing. Although it cannot be seen in FIG. 74, a zigzag spring 278 of this type is also attached to the second eccentric 154. As an alternative to the zigzag springs 278, repelling or attracting permanent magnets can be used as the means for producing a contact pressure.

Compensating elements 280 are configured as O-rings in the exemplary embodiment shown, which act for angular compensation. This is present on the outer ring of the bearing in FIG. 74. In another embodiment, positioning on the eccentric shaft or the inner ring of the bearing can be obtained. Clearly, the compensating elements 280 ensure that in the event of angular errors of the eccentrics 152, 154 or of the bearing, the axial bearing of the main component 104 is nevertheless on all (preferably four) swivel supports 174. The diameter of the shaft or of the bearing seat is preferably smaller or larger than the inner or outer ring bearing, so that the transmission occurs only through the O-ring (or another compensating element 280).

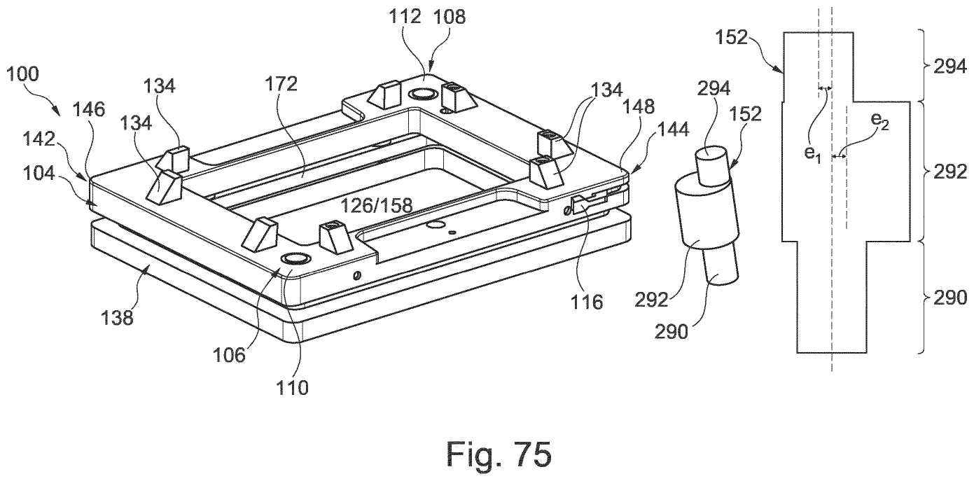

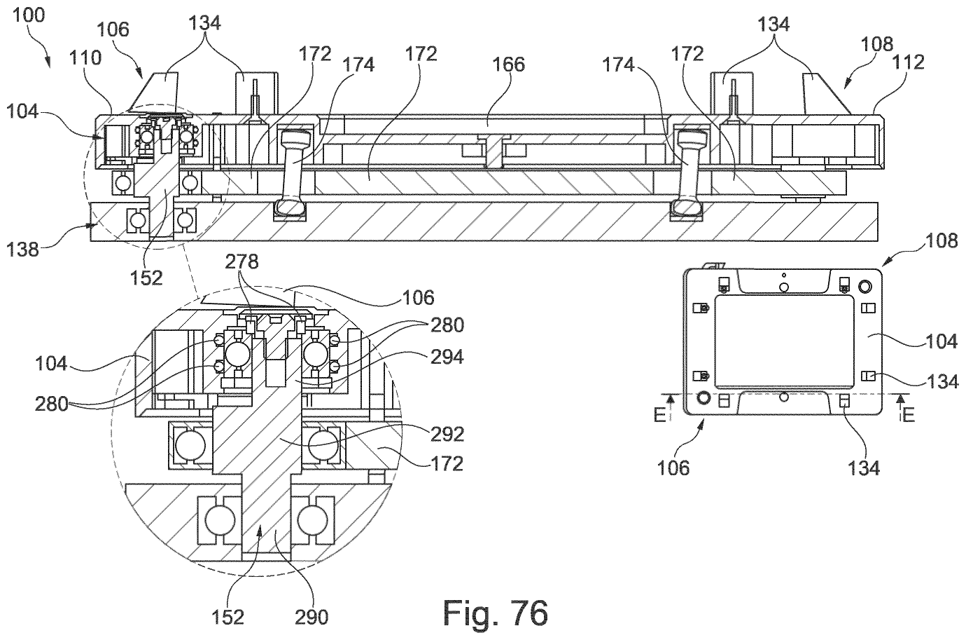

FIG. 75 shows a three-dimensional view of a laboratory instrument 100 in accordance with another exemplary embodiment of the invention with a frame-shaped counterbalancing mass 172, wherein furthermore, two representations of a first eccentric 152 can be seen.

The two representations (namely a three-dimensional view and a cross sectional view) show the first eccentric 152 as a double eccentric. This double eccentric is formed by a first shaft section 290, a second shaft section 292 and a third shaft section 294, wherein the second shaft section 292 is disposed between the first shaft section 290 and the third shaft section 294 in the axial direction. The second shaft section 292 has a larger diameter than the first shaft section 290 and the third shaft section 294. Each of the shaft sections 290, 292 and 294 is configured as a circular cylinder. A central axis of the third shaft section 294 is offset by a value el from a central axis of the first shaft section 290. A central axis of the second shaft section 292 is offset by a distance e2 with respect to the central axis of the first shaft section 290. The first shaft section 290 is mounted in the support body 138, i.e. in the stationary framework. The second shaft section 292 (with eccentricity e2) functions to deflect the counterbalancing mass 172. The third shaft section 294 (with eccentricity el) deflects the main component 104.

Although it is not shown in FIG. 75, the second eccentric 154 can be configured in exactly the same manner as the first eccentric 152.

The double eccentric shown is in particular suitable for use with an orbitally moved frame-shaped counterbalancing mass 172. An advantage of a frame-shaped counterbalancing mass 172 for carrying out an orbital motion over rotary counterbalancing masses 172, as previously shown, consists in the fact that the counterbalancing mass 172 can be housed peripherally in the edge region, wherein compared with rotary masses, this allows for an overall smaller build space for the laboratory instrument 100. Furthermore, the larger mass which is possibly makes it possible to compensate for even larger moved masses. The frame-shaped counterbalancing mass 172 is preferably produced from a high-density material and moves orbitally like the main component 104, but in the opposite direction to the framework mount (i.e. the mounting position of the support body 138). Clearly, the frame-shaped counterbalancing mass 172 of FIG. 75 is provided so that it does not rotate but is moved eccentrically counter to the main component 104 (i.e. the shaker tray) and the load (in particular with the object carrier 102). In a configuration of this type, it is highly advantageous to use a double eccentric as the first eccentric 152 and as the second eccentric 154. The eccentrics 152, 154 configured as a double eccentric act to deflect the main component 104 and produce a counteracting deflection of the (in particular frame-shaped) counterbalancing mass 172. The eccentric 152 (or 154) in accordance with FIG. 75 is a double eccentric with a cross section or shaft section which is rotatably mounted in the stationary support body 138 and two counteracting eccentric cross sections or shaft sections (one to deflect the main component 104 and the other to deflect the counterbalancing mass 172). In this manner, a frame-shaped counterbalancing mass 172 can be attached to the first eccentric 152 (advantageously configured as a double eccentric) and/or to a second eccentric 154 (advantageously configured as a double eccentric) and disposed between the support body 138 and the main component 104 in order to execute a movement which counteracts the movement of the main component 104 during mixing.

FIG. 76 shows different views of components of the laboratory instrument 100 in accordance with FIG. 75. More precisely, FIG. 76 shows a sectional view along a sectional line E-E as well as a detail of this sectional view.

In particular, FIG. 76 again shows the frame-shaped counterbalancing mass 172, which can also be termed a shaker frame. In accordance with the exemplary embodiment shown, the counterbalancing mass 172 is configured as a frame-shaped orbitally counteracting moved component in order to compensate for the imbalance.

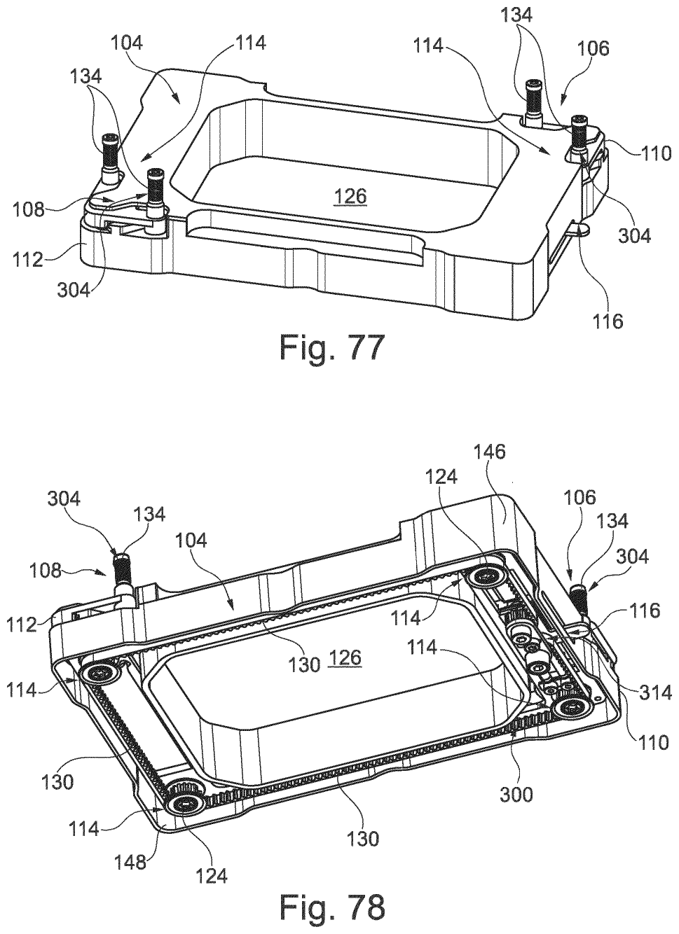

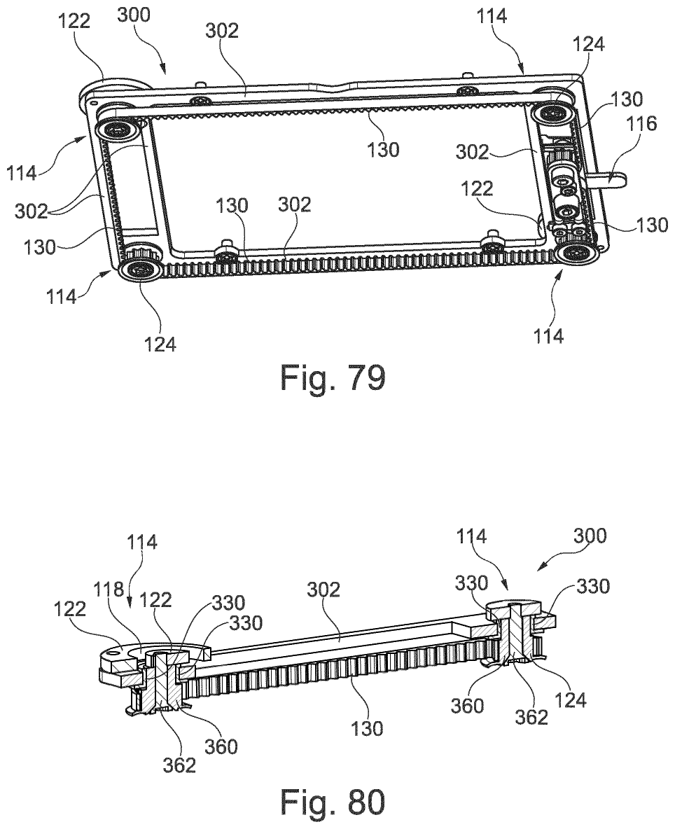

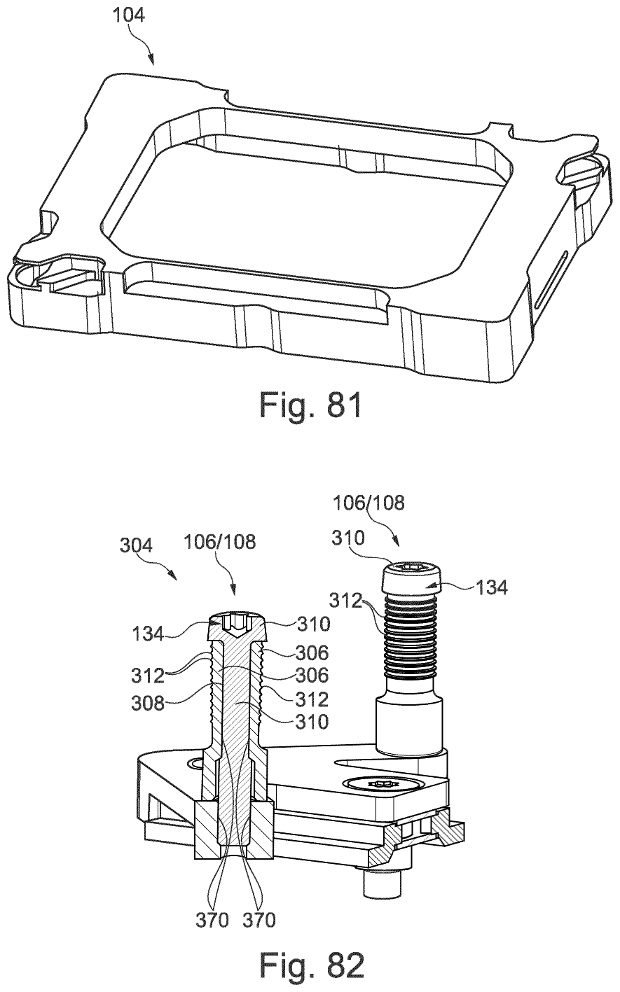

FIG. 77 shows a three-dimensional top view of a main component 104 with positioning fixtures 106, 108 and fixing mechanism 114 of a laboratory instrument 100 in accordance with another exemplary embodiment of the invention. FIG. 78 shows a three-dimensional bottom view of the main component 104 with positioning fixtures 106, 108 and fixing mechanism 114 in accordance with FIG. 77. FIG. 79 shows a three-dimensional bottom view of a functional assembly 300 of the laboratory instrument 100 in accordance with FIG. 77 and FIG. 78. FIG. 80 shows a cross-sectional view of the functional assembly 300 in accordance with FIG. 79. FIG. 81 shows a three-dimensional view of a one-piece main component 104 of the laboratory instrument 100 in accordance with FIG. 77 to FIG. 80.

FIG. 77 to FIG. 81 show a laboratory instrument 100 configured as an object mounting device with a locking device in the form of the fixing mechanism 114 which can be automated and which has two movable positioning fixtures 106, 108. The exemplary embodiment shown in FIG. 77 to FIG. 81 is characterized by particularly low complexity, a particularly small number of components and by particularly simple installation of the assemblies shown and of the laboratory instrument 100 which is to be produced. In particular, but not exclusively, a laboratory instrument 100 in accordance with FIG. 77 to FIG. 81 can be used for temperature control, mixing and/or manipulation of biological samples in an automated laboratory system.

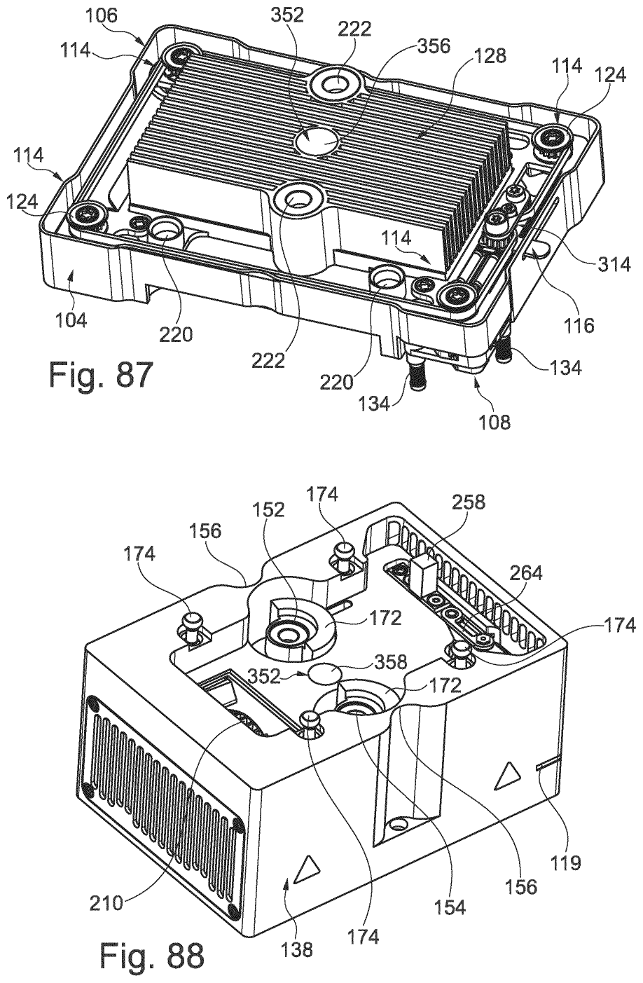

A tensioning device 314 is shown in FIG. 79 (but also in FIG. 87) which is configured for tolerance-compensating tensioning of the annular closed force-transmitting mechanism 130. The force-transmitting mechanism 130 of FIG. 78 is a toothed belt which can be locally tensed or deflected by means of the tensioning device 314 in the region of the actuating device 116 in order to compensate for tolerances between the dimensions of the toothed belt and the dimensions and positions of the components of the actuating device 116 and the fixing mechanism 114. This has the advantage that no particularly strict requirements have to be placed on said components and the operational accuracy of the laboratory instrument 100 is not compromised. Larger tolerances can even be compensated for in a simple manner by means of the tensioning device 314.

FIG. 79 shows the functional assembly 300 with a plate carrier 302 which is configured as a structured sheet on which components of the actuating device 116 and of the fixing mechanism 114 have already been mounted. More precisely, FIG. 79 shows a pre-assembled unit in the form of the functional assembly 300 without the main component 104 and without positioning assemblies 304 (see FIG. 82). The configuration described results in particularly simple preparation and pre-assembly. The vertically compact and efficiently pre-assembled functional assembly 300 results in a small build height and a simple way of manufacturing the laboratory instrument 100. In addition, as described in FIG. 81, the main component 104 is made in one piece from one material and is configured to receive the pre-assembled functional assembly 300 as well as positioning assemblies 304 which form the first positioning fixture 106 or the second positioning fixture 108 and, for example, can be configured as shown in FIG. 82. The configuration shown in FIG. 78 can be obtained by installing said assemblies.

FIG. 80 shows a section through the mounting for a guide disk 122 (or cam disk) and a guide pulley 124 (wherein, when four positioning fixtures are provided, instead of the guide pulley 124, a respective further cam disk or guide disk 122 can be installed). It can be seen in FIG. 80 that in order to mount all of the guide disks 122 and guide pulleys 124 of the toothed belt drive for rotation, slide mounts 330 can be used. This provides for simple and cost-effective fabrication as well as robust operation. As an alternative to the slide mounts 330, however, other types of bearings can be used, for example ball bearings. The plate carrier 302 here is configured as a base panel. Reference numeral 360 shows a toothed belt pulley with a continuation of the shaft. Furthermore, a fastening element 362 is provided, for example in the form of a screw. FIG. 80 therefore shows that the guide structure configured as a guide disk 122 can be pivotably mounted on the main component 104. As can also be seen in FIG. 80, the guide structure configured as a guide disk 122 is disposed in a different corner of the main component 104, as a guide pulley 124 mounted by means of a further slide mount 330. The use of a respective slide mount 130 constitutes a mechanically simple configuration which results in a compact and readily manufacturable laboratory instrument 100. Advantageously, for the pivotal mounting of all of the guide disks 122 (in particular cam disks) and guide pulleys 124 of the toothed belt mechanism, slide mounts 330 are used, as can be seen in FIG. 80.

The laboratory instrument 100 is constructed from the main component 104 shown in FIG. 81 as a base part, the positioning assembles 304 shown in FIG. 82 (also termed the positioning slide assembly) and the functional assembly 300 pre-assembled on a panel-like base part in accordance with FIG. 79. The main component 104 in accordance with FIG. 81 is configured for the attachment of two positioning fixtures 106, 108. The functional assembly 300 receives all of the components of the fixing mechanism 114 and the actuating device 116. The positioning slide or positioning assemblies 304 in accordance with FIG. 82 can be mounted by way of final installation. The functional assembly 300 in accordance with FIG. 79 can be completely pre-assembled and installed. This significantly facilitates the manufacturing outlay.

For final assembly, the pre-assembled positioning assemblies 304 (or positioning slides) in accordance with FIG. 82 are placed into the guides of the main component 104 (or base part) in accordance with FIG. 81 and then the functional assembly 300 in accordance with FIG. 79 is screwed into the main component 104.

FIG. 82 shows a cross-sectional view of a positioning assembly 304 with positioning fixtures 106, 108 of a laboratory instrument 100 in accordance with an exemplary embodiment of the invention.

In particular, FIG. 82 shows that the first positioning fixture 106 and the second positioning fixture 108 can include a respective positioning sleeve 306 with a through hole 308. A fastening element 310, which can, for example, be configured as a screw, can be inserted to fasten the positioning sleeve 306 in the through hole 308. The fastening element 310 can include an external thread which can be screwed together with an optional internal thread 370 of the positioning sleeve 306.

FIG. 82 also shows that the first positioning fixture 106 and the second positioning fixture 108 can include a respective external profiling, which in the exemplary embodiment shown is an external thread on an outside of the positioning sleeve 306. Clearly, the profiling acts for engagement of the object carrier 102 during operation of the laboratory instrument 100. As an example, the external thread can penetrate a little further into plastic material of an object carrier 102 which can, for example, be configured as a microtitre plate and therefore securely hold the object carrier 102 between the positioning fixtures 106, 108. In particular, this means that unwanted vertical lifting of the object carrier 102 during operation can be avoided.

Thus, FIG. 82 shows that the positioning sleeves 306 of the positioning pins 134 can be equipped with an external thread or another profiling 312. These positioning sleeves 306 can be connected to the fastening element 310 which in the exemplary embodiment shown is configured as a screw with the slide, which permits easy exchange when adjustments have to be made. The profiling 312 shown here as an external thread can be formed as a cylindrical thread or as a tapered thread when the positioning sleeve 306 is tapered. Because of the resulting roughness, a reliable frictional connection can be formed in this manner with the object carriers 102 (in particular laboratory vessels such as microtiter plates, for example), which usually consist of plastic. In this manner, good and secure retention can, for example but not exclusively, be obtained when using the laboratory instrument 100 as a mixing device.

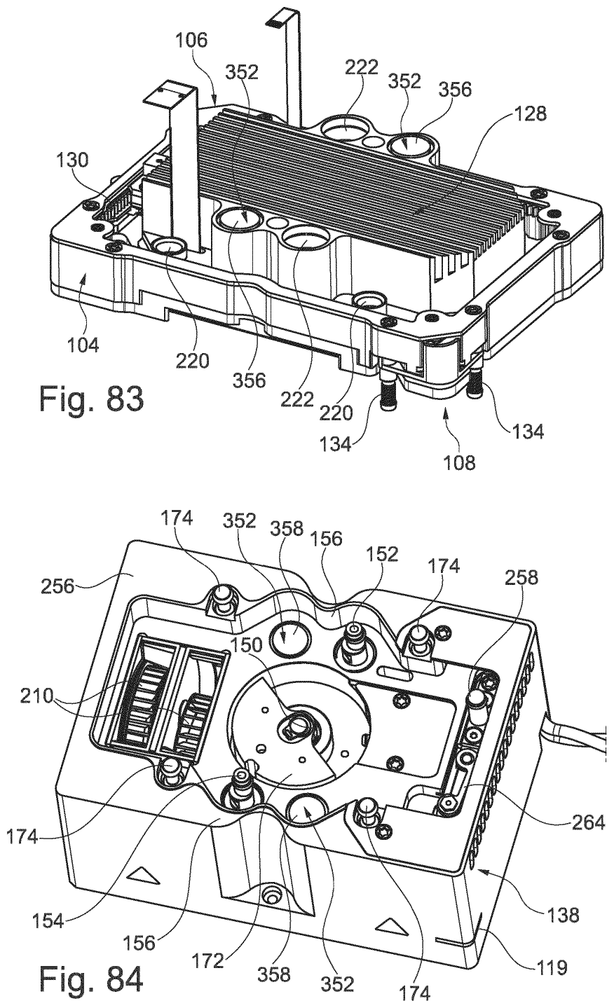

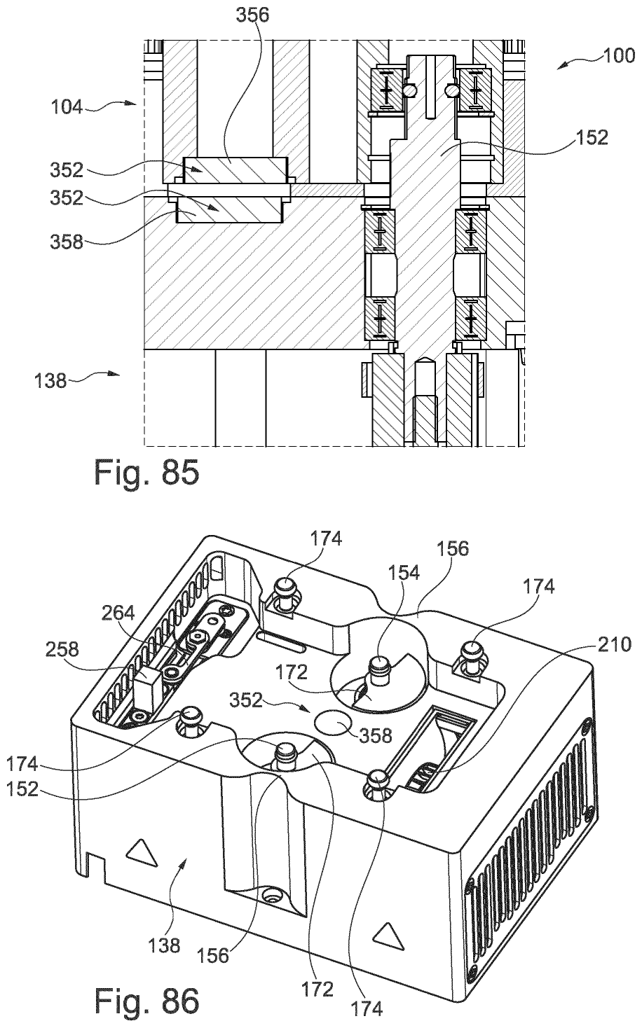

FIG. 83 shows a three-dimensional bottom view of a main component 104 with positioning fixtures 106, 108 and fixing mechanism 114 as well as an interactive device 128 configured as a cooling body of a laboratory instrument 100. Advantageously, said laboratory instrument 100 is equipped with a part of a normal force-producing device 352 which will be described in more detail below. FIG. 84 shows a three-dimensional top view of a support body 138 of the laboratory instrument 100 with another part of the normal force-producing device 352 for cooperation with the main component 104 in accordance with FIG. 83. FIG. 85 shows a cross-sectional view of a laboratory instrument 100 with a normal force-producing device 352 in accordance with an exemplary embodiment of the invention and shows a coupling region between the main component 104 in accordance with FIG. 83 and the support body 138 in accordance with FIG. 84. The laboratory instrument 100 in accordance with FIG. 83 to FIG. 85 can, for example, be configured as a mixing device for objects such as sample holders, for example.

As already discussed, the laboratory instrument 100 in accordance with FIGS. 83 to 85 includes the normal force-producing device 352 for the production of a normal force to impede lifting of the movable main component 104 from the support body 138 or, more precisely, from the swivel supports 174 between the support body 138 and the main component 104. Clearly, the normal force-producing device 352 produces an attractive vertical force between the support body 138 and the main component 104. In accordance with FIG. 83 and FIG. 84, the normal force-producing device 352 has two normal force-producing magnets 356 on the main component 104 as well as two cooperating normal force-producing magnets 358 on the support body 138. The normal force-producing magnets 356, 358 in accordance with FIG. 83 to FIG. 85 are mutually attractive. Closely positioned attractive normal force-producing magnets 356, 358 have the advantage of having at most a minor effect on the electronics of the laboratory instrument 100. By means of the configuration of the normal force-producing device 352 and the mixing drive mechanism 140 in accordance with FIG. 83 to FIG. 85, the production of the normal force by means of the normal force-producing device 352 is functionally decoupled from a horizontal force produced by means of the mixing drive mechanism 140.

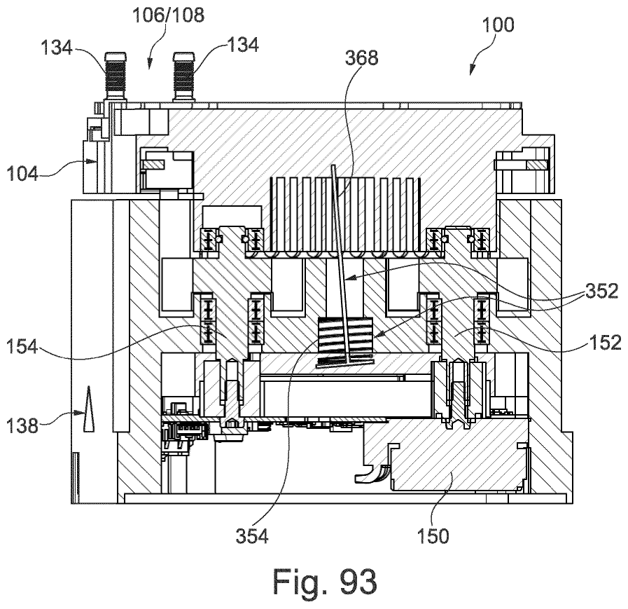

Expressed more precisely, the normal force produced by means of the normal force-producing device 352 is transferred to the swivel supports 174. A normal force-producing device 352 of this type can, for example, be implemented using magnets (such as in FIG. 83 to FIG. 85) and/or with spring elements (see FIG. 93). The normal force-producing magnets 356, 358 can be attached directly to the support body 138 (also termed the framework) or to the main component 104 (also termed the shaker tray). This has the advantage that the normal force which is produced does not axially load the ball bearings 222 of the eccentrics 152, 154 any more than is necessary. The normal force produced by means of the normal force-producing device 352 is advantageous in order to ensure that as it moves, the main component 104 always rests on bearing elements (swivel supports 174 in the exemplary embodiment shown).

A transmission of axial forces directly via rotary bearings (in particular bearing inner ring—rolling body—bearing outer ring) would not be ideal in the case of high loads or tipping moments and the use of deep groove ball bearings (high radial forces, low axial forces) would not be ideal and would necessitate selecting geometrically larger bearings which would have to be accommodated.

In contrast, as can be seen in the exemplary embodiment in accordance with FIG. 83 to FIG. 85, the production of the normal force directly between the components involved without the involvement of a rotary bearing is ideal. This is made possible in accordance with FIG. 83 to FIG. 85 in that in the support body 138 and in the main component 104, normal force-producing magnets 356, 358 configured as permanent magnets are used and these can be coupled together attractively (or repulsively, see FIG. 92).

FIG. 83 shows the main component 104, which is configured as a shaker tray. from below. Two normal force-producing magnets 356 which are configured as permanent magnets can be seen, which can be glued into the tray close to the bearing (alternatively or in addition at other positions, however) and, together with a respective further attractive normal force-producing magnet 358 in the support body 138 configured as a framework, provide a normal force in the direction of the framework (and therefore on to the swivel supports 174).

Advantageously, this therefore produces the normal force or axial force directly between the components (i.e. support body 138 and main component 104) via the normal force-producing magnets 356, 358 (attractive or repulsive).

FIG. 84 shows the support body 138 configured as a framework, from above. Here, two normal force-producing magnets 358 configured as permanent magnets can be seen, which provide a normal force in the direction of the main component 104 which is configured as a shaker tray.

Advantageously with the configuration in accordance with FIG. 83 and FIG. 84, the normal force is therefore not directed via the respective eccentric shaft. The bearings (in particular the ball bearings 222) of the eccentrics 152, 154 are therefore at most only slightly axially loaded, which results in high reliability and long service life.

FIG. 85 shows a section through an eccentric shaft for the example of an attractive permanent magnet pair in accordance with FIG. 83 and FIG. 84. Other geometries are possible. Advantageous geometries are those in which the axial force is not transmitted via the shaft, but directly from the shaker tray to the framework.

The exemplary embodiments in accordance with FIG. 86 to FIG. 90 described below show the laboratory instrument 100 as a mixing device with two eccentrics 152, 154 with eccentric shafts, of which one is driven directly from a drive device 150 which is configured as a motor and only a single toothed belt drive is required for the indirect drive of the other eccentric shaft.

FIG. 86 shows a three-dimensional view of a support body 138 of a laboratory instrument 100 with a normal force-producing device 352 in accordance with an exemplary embodiment of the invention. FIG. 87 shows a three-dimensional bottom view of a main component 104 with positioning fixtures 106, 108 and fixing mechanism 114 as well as a cooling body of a laboratory instrument 100 with a normal force-producing device 352 for cooperation with the support body 138 in accordance with FIG. 86.

Thus, FIG. 86 shows an alternative embodiment of a framework or support body 138 with two eccentrics 152, 154 in a view from above. In this exemplary embodiment, a normal force can be produced via a single attractive permanent magnet as the normal force-producing magnet 358. In a corresponding manner, FIG. 87 shows an alternative embodiment of a shaker tray or main component 104 in a view from below, in which the normal force can be produced via a single attractive permanent magnet as the normal force-producing magnet 356. In accordance with FIG. 86 and FIG. 87, then, the support body 138 has only a single normal force-producing magnet 358 and the main component 104 has only a single normal force-producing magnet 356. Alternatively, another central magnetic or spring arrangement can be employed in which the axial force is not directed via the eccentric shafts and bearings, but acts directly between the main component 104 and the support body 138. As an example, a spring or another force producing element can also be centrally disposed, which could contribute to the production of a force between the main component 104 and the support body 138.

In accordance with FIG. 86, counterbalancing masses 172 are attached directly to the respective eccentrics 152, 154. In this manner, advantageously, imbalances during operation of the eccentrics 152, 154 can be compensated for directly at the location where they are generated. This reduces the forces acting on various components of the laboratory instrument 100, and therefore reduces wear and results in an increased service life.

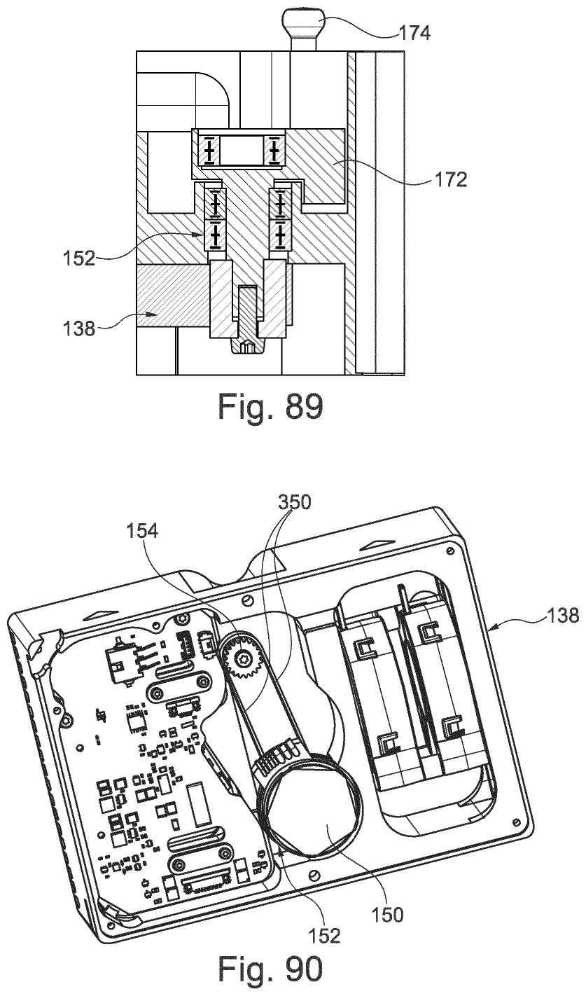

FIG. 88 shows a three-dimensional view of a support body 138 of a laboratory instrument 100 with a part of a normal force-producing device 352 in accordance with another exemplary embodiment of the invention. FIG. 89 shows a cross-sectional view of a laboratory instrument 100 with a normal force-producing device 352 in accordance with an exemplary embodiment of the invention, in which the support body 138 in accordance with FIG. 88 can be employed.

FIG. 88 shows an alternative embodiment of a support body 138 configured as a framework with two counterbalancing masses 172 directly on the respective eccentric 152, 154, from above. A normal force here can, for example, also be produced via an attractive permanent magnet or by means of another central magnet or spring arrangement, in which the axial force is not directed via the eccentric shafts and bearings, but is produced directly between the framework and shaker tray components. A spring or another element which can produce a force between the components can also be disposed centrally.

FIG. 89 shows a section through a counterbalancing mass 172 with an eccentrically mounted bearing. In this exemplary embodiment, only two solid pins are located in the inner ring of the main component 104, whereupon it is deflected.

The exemplary embodiment which has been described has advantages: it means that an adaptation of the eccentricity or the amplitude of the laboratory instrument 100 is possible simply by changing the counterbalancing mass 172. In a standard configuration (separate counterbalancing mass 72 and shaft of the respective eccentrics 152, 154), both components (eccentric shaft amplitude/eccentricity and counterbalancing mass imbalance property) can be adjusted. Changes to the mixing amplitude can be made when mixing by means of a circular orbital motion.

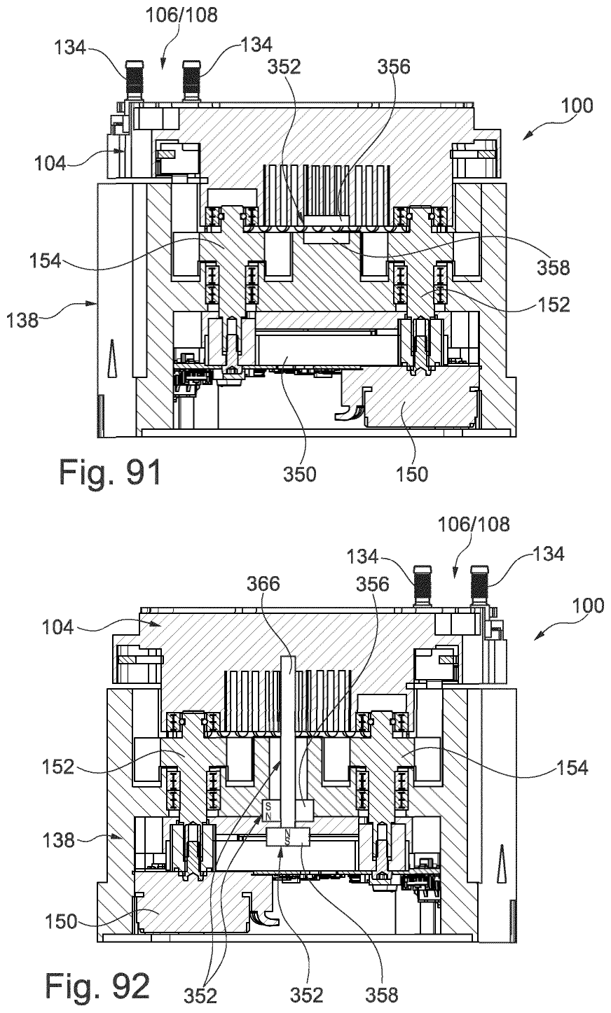

FIG. 90 shows a three-dimensional view of a support body 138 of a laboratory instrument 100 in accordance with an exemplary embodiment of the invention. FIG. 91 shows a cross-sectional view of the laboratory instrument 100 in accordance with FIG. 90.

In accordance with FIG. 90 and FIG. 91, the first eccentric 152 is mounted directly on the drive device 150. In contrast, the second eccentric 154 is force-coupled to the first eccentric 152 and the drive device 150 by means of a force-transmitting belt 350. In this manner, components for coupling the first eccentric 152 to the drive device 150 can be dispensed with, whereupon the associated laboratory instrument 100 can become compact and simple in construction. Thus, in accordance with FIG. 90 and FIG. 91, one of the two eccentric shafts can be driven directly by the motor. Just one force-transmitting belt 350 (for example configured as a toothed belt) is sufficient and the construction has a particularly small number of components and bearings.

Because all of the imbalances which arise in the exemplary embodiment in accordance with FIG. 90 and FIG. 91 are compensated for directly at one bearing point, particularly good reliability and service life is obtained.

It should be noted in the sectional view of FIG. 91 that the laboratory instrument 100 manages with a single centrally disposed pair of permanent magnets as the normal force-producing device 352. Expressed more precisely, in accordance with FIG. 90 and FIG. 91, the main component 104 has only one normal force-producing magnet 356 and the support body 138 has only one normal force-producing magnet 358.

FIG. 92 shows a cross-sectional view of a laboratory instrument 100 with a normal force-producing device 352 in accordance with another exemplary embodiment of the invention.

In accordance with FIG. 92, the normal force-producing device 352 includes a rigid element 366 which is rigidly connected to a first normal force-producing magnet 358 and passes through a second normal force-producing magnet 356, for example a bolt. The rigid element 366 is attached to the main component 104, whereas the second normal force-producing magnet 356 is attached to the support body 138. If the main component 104 plus the rigid element 366 attached thereto moves away from the support body 138, the first normal force-producing magnet 358 is entrained with it and therefore moves in the direction of the second normal force-producing magnet 356 which is attached in a stationary manner to the support body 138. If the normal force-producing magnets 356, 358 repel, the described mechanism produces a repulsive magnetic force which pulls the main component 104 back to the support body 138.

In the exemplary embodiment in accordance with FIG. 92, the two normal force-producing magnets 356, 358 are therefore mutually repulsive. This is illustrated by the letter “S” for south pole or “N” for north pole. FIG. 92 shows a section through the laboratory instrument 100 which includes the normal force-producing device 352 described for the production of the normal force by repulsive permanent magnets as the normal force-producing magnets 356, 358. The rigid element 366 (for example a bolt) on the main component 104 configured as a shaker tray protrudes through a second normal force-producing magnet 356, configured here as a disk magnet or ring magnet, through the support body 138 configured as a framework. Furthermore, a further (in particular configured as a permanent magnet) normal force-producing magnet, namely the first normal force-producing magnet 358, is fastened to the end of the rigid element 366. A disk magnet is advantageous in order to facilitate the eccentric movement between the framework and shaker tray. In particular, the first normal force-producing magnet 358 can be connected to the rigid element 366 in one piece. The second normal force-producing magnet 356 can be securely anchored in the support body 138. Because the second normal force-producing magnet 356 cannot move and the first normal force-producing magnet 358 experiences a repulsive downwards force, the main component 104 is pulled towards the support body 138.

FIG. 93 shows a cross-sectional view of a laboratory instrument 100 with a normal force-producing device 352 in accordance with another exemplary embodiment of the invention.

In accordance with FIG. 93, the normal force-producing device 352 includes a normal force-producing spring 354 which couples the main component 104 with the support body 138. Furthermore, in accordance with FIG. 93, the normal force-producing device 352 includes a pliable element 368 which is operatively connected to the normal force-producing spring 354, wherein the pliable element 368 is attached to the main component 104 and the normal force-producing spring 354 is attached to the support body 138. The pliable element 368 can be rigid in the tensile direction, but flexible transverse to the tensile direction. The pliable element 368 attached to the main component 104 (for example a cord or wire) can follow mixing motions in a horizontal plane because of its flexibility. The pre-tensioned normal force-producing spring 354 attached to the support body 138 can impede lifting of the main component 104 from the support body 138 and can pull the main component 104 back down by means of the pliable element 368.

Again, FIG. 93 shows a section through the laboratory instrument 100, in which the normal force is produced by a pre-tensioned spring element in the form of the normal force-producing spring 354 and a pliable element 368 (for example a cord, a wire, etc.). The pliable element 368 acts to compensate for the amplitude and/or the eccentricity between the support body 138 and main component 104. Clearly, the normal force-producing spring 354 pulls the pliable element 368 downwards, whereupon the main component 104 is pulled towards the support body 138. The configuration with a normal force-producing spring 354 produces a fluid-tight embodiment of main component 104 or support body 138, which can be advantageous if, for example, condensation is formed when the laboratory instrument 100 is used for cooling applications, so it cannot then penetrate into the interior. The fluid-tight configuration clearly means that apertures in the top of the main component 104 for pre-tensioning the spring are not pertinent.

In accordance with FIG. 93, one or more spring elements can be used to produce a normal force directly between the support body 138 (also termed the framework) and main component 104 (also termed the shaker tray), without loading the rotary bearings of the eccentrics 152, 154. This reduces the mechanical loading and therefore the wear on the eccentrics 152, 154, and therefore increases the service life. As an alternative to the construction in accordance with FIG. 93, it is also possible, for example, to insert a tension spring between the main component 104 and support body 138.

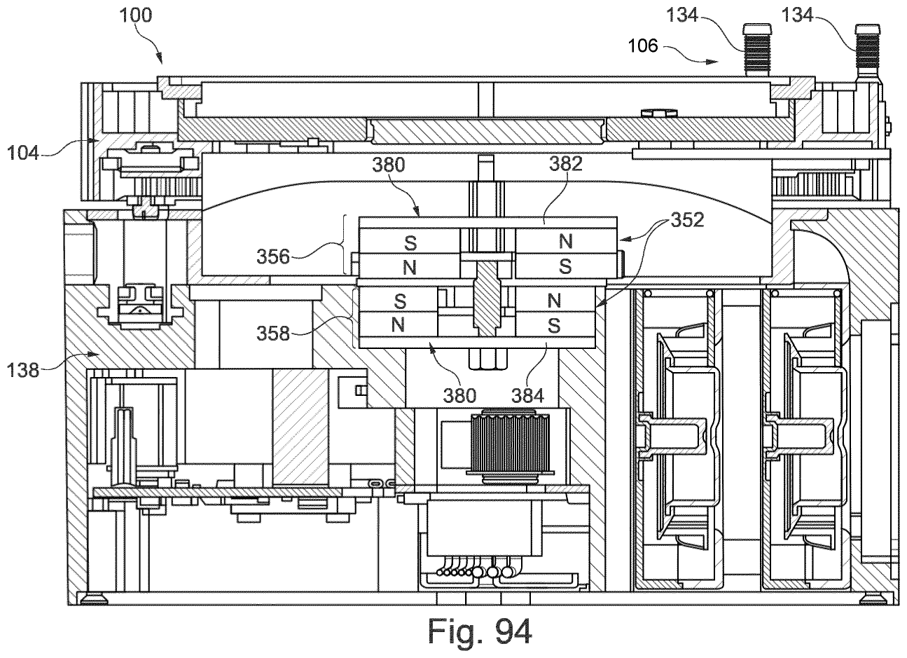

FIG. 94 shows a cross-sectional view of a laboratory instrument 100 with a normal force-producing device 352 and a magnetic field shielding device 380 in accordance with another exemplary embodiment of the invention.

In accordance with FIG. 94, the normal force-producing device 352 includes a magnetic field shielding device 380 which is formed by two mutually opposite ferromagnetic keepers. The magnetic field shielding device 380 acts to shield a magnetic field produced by the normal force-producing magnets 356, 358. Expressed more precisely, in accordance with FIG. 94, the normal force-producing magnets 356 of the main component 104 and the normal force-producing magnets 358 of the support body 138 are configured so as to be mutually attractive in pairs. The main component 104 includes two mutually anti-parallel normal force-producing magnets 358. Correspondingly, the support body 138 includes two mutually anti-parallel normal force-producing magnets 356. Each of the normal force-producing magnets 358 is disposed opposite to a respective normal force-producing magnet 356, so that an attractive magnet force is generated between the respective pair of normal force-producing magnets 358, 356. On a side of the normal force-producing magnet 356 facing away from the normal force-producing magnet 358 is a first ferromagnetic keeper 382 of the magnetic field shielding device 380. Correspondingly, a second ferromagnetic keeper 384 of the magnetic field shielding device 380 is disposed on the side of the normal force-producing magnet 358 facing away from the normal force-producing magnet 356.

Thus, in the exemplary embodiment in accordance with FIG. 94, the normal force-producing magnets 356, 358 are formed as attractive permanent magnets, which are provided with circuit-closing plates in the form of the keepers 382, 384. In the laboratory instrument 100 in accordance with FIG. 94, therefore, the attractive permanent magnets are additionally coupled by means of ferromagnetic circuit-closing plates. In the sectional view in accordance with FIG. 94, a laboratory instrument 100 which is configured as a mixing device is shown in which four permanent magnets (two above in the movable main component 104, two below in the stationary framework or in the support body 138) so as to attract and are coupled together on the rear by circuit-closing plates. By using said circuit-closing plates, at least part (in particular most or all) of the magnetic energy is concentrated onto the attractive surfaces and the spatial effect of the magnetic field is restricted. In this manner, an unwanted magnetization of the environment or influences on the electronic components located in the laboratory instrument 100 are prevented. Clearly, by means of the keepers 382, 384, the magnet field lines are concentrated or focused onto the region of the magnetic field shielding device 380.

In addition, the following aspects of the invention are disclosed:

Aspect 1. Laboratory instrument (100) for mixing a medium in an object carrier (102), wherein the laboratory instrument (100) includes: a support body (138); a main component (104) for receiving the object carrier (102) which is disposed on the support body (138) and is movable with respect to the support body (138) for mixing; and a mixing drive mechanism (140) disposed on the support body (138), with a drive device (150), a first eccentric (152) and a second eccentric (154) which can be driven by means of the drive device (150) and which are configured in order to transmit a driving force produced by the drive device (150) to the main component (104) in order to mix the medium in the object carrier (102); wherein the first eccentric (152) and the second eccentric (154) are disposed on a peripheral edge (156) of the support body (138) and outside a central region (158) of the support body (138).

Aspect 2. Laboratory instrument (100) according to aspect 1, wherein a cavity is formed in the central region (158), wherein in particular, the support body (138) is configured to allow a cooling fluid to flow through the cavity from outside the laboratory instrument (100).

Aspect 3. Laboratory instrument (100) according to aspect 2, wherein the support body (138) includes at least one cooling opening (162) on mutually opposite sides, through which the cooling fluid flows from outside the laboratory instrument (100) through the cavity and out of the laboratory instrument (100) again.

Aspect 4. Laboratory instrument (100) according to one of aspects 1 to 3, wherein a cavity is formed in the central region (158) in which at least a portion of a cooling body (164) attached to an underside of the main component (104) is received.

Aspect 5. Laboratory instrument (100) according to one of aspects 1 to 4, including a thermal coupling plate (166) on the main component (104), the upper side thereof forming at least a portion of a loading surface for the object carrier (102).

Aspect 6. Laboratory instrument (100) according to aspect 4 and 5, wherein the underside of the thermal coupling plate (166) is coupled to the cooling body (164).

Aspect 7. Laboratory instrument (100) according to one of aspects 1 to 6, including at least one of the following features: including an annular closed first force-transmitting mechanism (168), in particular a first toothed belt, for transmitting the driving force from the drive device (150) to the first eccentric (152) and/or including an annular closed second force-transmitting mechanism (170), in particular a second toothed belt, for transmitting the driving force from the drive device (150) to the second eccentric (154); including an annular closed force-transmitting mechanism (168), in particular a toothed belt, for transmitting the driving force from the drive device (150) to the first eccentric (152) and to the second eccentric (154).

Aspect 8. Laboratory instrument (100) according to one of aspects 1 to 7, including at least one counterbalancing mass (172) to at least partially compensate for an imbalance produced by the first eccentric (152), the second eccentric (154) and the main component (104).

Aspect 9. Laboratory instrument (100) according to aspect 8, including at least one of the following features: wherein the at least one counterbalancing mass (172) is asymmetrically attached to the drive device (150); wherein a first counterbalancing mass (172) is attached to the first eccentric (152) and a second counterbalancing mass (172) is attached to the second eccentric (154).

Aspect 10. Laboratory instrument (100) according to aspect 8, wherein a counterbalancing mass (172), which in particular is in the shape of a frame, is attached to at least one of the first eccentric (152), in particular configured as a double eccentric, and the second eccentric (154), in particular configured as a double eccentric, and is disposed between the support body (138) and the main component (104) and is configured to carry out a movement upon mixing which is counter to that of the main component (104).

Aspect 11. Laboratory instrument (100) according to one of aspects 1 to 10, including at least one swivel support (174), in particular a plurality of swivel supports (174), which is or are movably mounted between the support body (138) and the main component (104).

Aspect 12. Laboratory instrument (100) according to aspect 11, wherein the bottom of the at least one swivel support (174) is mounted in at least one first depression (176) in the support body (138) and the top is mounted in at least one second depression (178) in the main component (104).

Aspect 13. Laboratory instrument (100) according to aspect 11 or 12, wherein at least one first counter plate (180) is or are disposed on the support body (138) in physical contact with a bottom surface of the at least one swivel support (174) and/or at least one second counter plate (182) is or are disposed on the main component (104) in physical contact with a top surface of the at least one swivel support (174).

Aspect 14. Laboratory instrument (100) according to aspect 13, wherein the at least one first counter plate (180) and/or the at least one second counter plate (182) includes or consists of a ceramic.

Aspect 15. Laboratory instrument (100) according to aspect 13 or 14, wherein the at least one swivel support (174) on the one hand and the at least one first counter plate (180) and/or the at least one second counter plate (182) on the other hand are configured for rolling friction interaction, and in particular for sliding friction-free interaction.

Aspect 16. Laboratory instrument (100) according to one of aspects 11 to 15, wherein the at least one swivel support (174) includes a laterally broadened top section (184) and a laterally broadened bottom section (186) as well as a pin section (188) disposed between the top section (184) and the bottom section (186).

Aspect 17. Laboratory instrument (100) according to aspect 16, wherein an outer surface of the top section (184) includes a first spherical surface (190) and/or an outer surface of the bottom section (186) includes a second spherical surface (192).

Aspect 18. Laboratory instrument (100) according to aspect 17, wherein a first radius (R1) of the first spherical surface (190) and/or a second radius (R2) of the second spherical surface (192) is or are larger than an axial length (L) of the at least one swivel support (174).

Aspect 19. Laboratory instrument (100) according to one of aspects 11 to 18, wherein the at least one swivel support (174) includes or consists of a plastic.

Aspect 20. Laboratory instrument (100) according to one of aspects 11 to 19, including at least three swivel supports (174), in particular four swivel supports (174), which are mounted in pairs on mutually opposite sides of the support body (138) and of the main component (104).

Aspect 21. Laboratory instrument (100) according to one of aspects 1 to 20, wherein the first eccentric (152) and the second eccentric (154) are disposed on mutually opposite side edges of the support body (138), and in particular laterally offset with respect to each other.

Aspect 22. Laboratory instrument (100) according to aspect 21, wherein the drive device (150) is disposed between the first eccentric (152) and the second eccentric (154).

Aspect 23. Laboratory instrument (100) according to one of aspects 1 to 20, wherein the first eccentric (152) is disposed in a first corner of the support body (138) and the second eccentric (154) is disposed in a second corner of the support body (138).

Aspect 24. Laboratory instrument (100) according to aspect 23, wherein the drive device (150) is disposed in a third corner of the support body (138), in particular in a third corner between the first corner and the second corner.

Aspect 25. Laboratory instrument (100) according to aspect 24, including a guide pulley (194), which is disposed in a fourth corner of the support body (138).

Aspect 26. Laboratory instrument (100) according to one of aspects 1 to 25, including: a movable first positioning fixture (106) for attachment to a first edge region of the object carrier (102); a second positioning fixture (108) for attachment to a second edge region of the object carrier (102); a fixing mechanism (114) for fixing the object carrier (102) to the main component (104) between the first positioning fixture (106) and the second positioning fixture (108) by moving at least the first positioning fixture (106).

Aspect 27. Laboratory instrument (100) according to aspect 26, wherein the fixing mechanism (114) is disposed along at least a portion of a periphery of the main component (104), leaving free a central region (126) of the main component (104) which is surrounded by the periphery.

Aspect 28. Laboratory instrument (100) according to aspect 26 or 27, wherein the fixing mechanism (114) is disposed along an underside of the main component (104) facing away from the object carrier (102).

Aspect 29. Laboratory instrument (100) according to one of aspects 26 to 28, wherein the fixing mechanism (114) runs along the entire periphery of the main component (104).

Aspect 30. Laboratory instrument (100) according to one of aspects 26 to 29, wherein the mixing drive mechanism (140) and the fixing mechanism (114) are decoupled from one another, in particular the mixing drive mechanism (140) is formed exclusively in the support body (138) and the fixing mechanism (114) is formed exclusively in the main component (104).

Aspect 31. Laboratory instrument (100) according to one of aspects 26 to 30, including an actuating device (116) for actuating the fixing mechanism (114) in order for transposing at least the first positioning fixture (106) between an operational state which fixes the object carrier (102) and an operational state which releases the object carrier (102).

Aspect 32. Laboratory instrument (100) according to aspect 31, including an actuator (262) attached to the support body (138) for the electromechanical control of the actuating device (116) disposed on the main component (104) in order to actuate the fixing mechanism (114).

Aspect 33. Laboratory instrument (100) according to one of aspects 1 to 32, including at least one interactive device (128) which is at least partially disposed in the free central region (158) of the support body (138) and/or is operationally configured through the free central region (158) of the support body (138) on the object carrier (102).

Aspect 34. Laboratory instrument (100) according to aspect 33, wherein the interactive device (128) is selected from a group which consists of a temperature control device for controlling the temperature of a medium in the object carrier (102), an optical apparatus for optical interaction with a medium in the object carrier, and a magnetic mechanism for magnetic interaction with a medium in the object carrier (102).

Aspect 35. Laboratory instrument (100) according to one of aspects 1 to 34, wherein the mixing drive mechanism (140) is configured to produce an orbital mixing motion.

Aspect 36. Laboratory instrument (100) according to one of aspects 1 to 35, wherein the drive device (150) is coupled to the first eccentric (152) and to the second eccentric (154) for synchronously moving the first eccentric (152) and the second eccentric (154).

Aspect 37. Laboratory instrument (100) according to one of aspects 1 to 36, including the object carrier (102), in particular a sample carrier plate, more particularly a microtiter plate, received on the main component (104).

Aspect 38. Laboratory instrument (100) according to one of aspects 1 to 37, including a thermally conductive temperature control adapter (202) which can be attached to the main component (104), in particular by screwing, which can be thermally coupled to the main component (104) for thermally conductive coupling of the object carrier (102) and/or vessels containing a medium.

Aspect 39. Laboratory instrument (100) according to aspect 38, wherein the temperature control adapter (202) is selected from a group which consists of a flat plate for receiving the object carrier (102), and a framework with receiving openings (208) for receiving vessels containing a medium.

Aspect 40. Laboratory instrument (100) according to one of aspects 1 to 39, wherein the main component (104) is an annular body with a central through hole and/or the support body (138) is an annular body with a central through hole.

Aspect 41. Laboratory instrument (100) according to one of aspects 1 to 40, wherein the support body (138) includes a connecting plate (230) on the bottom with an electrical connector (232), which is configured for cordless electrical connection to a base plate (242) in order to receive the connecting plate (230).

Aspect 42. Method for mixing a medium in an object carrier (102), wherein the method includes: receiving the object carrier (102) on a main component (104) which is disposed on a support body (138) and can be moved with respect to the support body (138) for the purposes of mixing; disposing a mixing drive mechanism (140), which includes a drive device (150), a first eccentric (152) and a second eccentric (154), on the support body (138); disposing the first eccentric (152) and the second eccentric (154) on a peripheral edge (156) of the support body (138) and outside a central region (158) of the support body (138); and driving the first eccentric (152) and the second eccentric (154) by means of the drive device (150) in order to transmit a driving force produced by the drive device (150) to the main component (104) in order to mix the medium in the object carrier (102).

In addition, it should be noted that “including” does not exclude any other elements or steps and “a” or “an” does not exclude a plurality. It should also be noted that features or steps which have been described with reference to one of the above exemplary embodiments can also be used in combination with other features or steps of other exemplary embodiments which have been described above. Reference numerals in the claims should not be considered to be limiting.

In accordance with an exemplary embodiment of the invention, a laboratory instrument is provided which, by means of (exactly or at least) two rotationally driven eccentrics which protrude vertically over a support body, can set a main component located on the eccentrics in a cyclic and preferably planar rotational movement and in this manner can efficiently mix medium in an object carrier on the main component. Advantageously, the two eccentrics are attached to the edge, preferably at mutually opposite edges of the support body, so that a cavity with a large volume remains between them; this provides a great deal of design freedom as regards filling it with an interactive device for the provision of a function at the object carrier and the medium contained therein. The cavity can also remain at least partially free, however, and be used for the purposes of cooling, for example.

Additional exemplary embodiments of the laboratory instrument and of the method will now be described below.

In accordance with an exemplary embodiment, a cavity can be formed in the central region. Advantageously, at least a portion of an interactive device can be disposed in this cavity. As an alternative or in addition, the cavity can be used in a different manner, for example as a flow volume for cooling fluid. Preferably, the support body can be configured to guide or pass a cooling fluid (i.e. a cooling gas and/or a cooling liquid) from outside the laboratory instrument through the cavity. Advantageously, cooling fluid, in particular ambient air, can be passed through a definable cavity above the support body and below the main component as well as laterally between the eccentrics in order, for example, to effectively cool a cooling body which is in thermal contact with medium of the object carrier attached to the underside of the main component. The cooling fluid flow can be conveyed through the cavity by means of at least one cooling fan which can be mounted in the support body. As an example, a cooling fan of this type can take in ambient air and transport it to the cavity. This means that a high cooling efficiency can be obtained.

In accordance with an exemplary embodiment, the support body can have at least one cooling opening on respective mutually opposite sides thereof through which the cooling fluid flows from outside the laboratory instrument through the cavity and back out of the laboratory instrument. A cooling path defined by the airflow can be precisely defined in this manner, since an inlet for cooling air or an outlet for heated air is formed on two mutually opposite side faces of the support body, preferably at different heights. In this manner, a draught of ambient air through the (preferably lower-lying and/or larger) inlet, through the cavity to the (preferably higher-lying or smaller) outlet can be precisely defined. This draught of air can be reinforced by at least one ventilator or cooling fan which can be disposed in the region of the inlet or outlet in the support body. In this manner, advantageously, effective cooling of the object carrier and of the medium found therein can be achieved. Advantageously, the vertically offset positioning of inlet and outlet are configured in a manner such that the tendency of gradually heated air to flow upwards is exploited. The cooling efficiency can be further reinforced in this manner.

In accordance with an exemplary embodiment, a cavity can be formed in the central region, in which a cooling body on the underside of the main component is entirely or partially received. A cooling body of this type which is at least partially accommodated in the cavity can, for example, have a massive thermally conducting plate which is mounted on an underside of the main component and therefore, for example, can be thermally coupled to a thermal coupling plate of the main component so that the object carrier can be placed on it. A plurality of cooling fins can extend downwards from the massive thermally conductive plate in order to increase the surface area and therefore improve heat exchange, between which through channels are provided for the flow of cooling fluid. The through channels can extend along at least a sub-section between the air inlet and the air outlet.

In accordance with an exemplary embodiment, the laboratory instrument can comprise a thermal coupling plate at the main component, the upper side of which forms at least a portion of a loading surface of the object carrier. A thermal coupling plate of this type can have a particularly high thermal conductivity (in particular at least 50 W/mK) in order to obtain a strong thermal coupling between the object carrier and main component. In particular, the thermal coupling plate can be a metal plate, for example an aluminum plate.

For the purposes of a further improved thermal coupling of medium in the object carrier with a temperature control device in the laboratory instrument (in particular in the main component), it is also possible to attach a temperature control adapter, for example metallic, to the thermal coupling plate, for example by screwing it on (see FIG. 3, for example). A temperature control adapter of this type can, for example, contain a plurality of receptacles into which an object carrier (such as a microtiter plate with appropriately profiled bottom) or in fact individual sample vessels can be positively engaged.

In accordance with an exemplary embodiment, the underside of the thermal coupling plate can be thermally coupled to the cooling body. As an example, the whole surface of the thermal coupling plate can lie on the cooling body or can be separated from the cooling body only by a further thermally conductive intermediate body. In this manner, a highly thermally conductive pathway can be formed between the object carrier and cooling body, wherein a cooling flow of air can be passed across an underside of the cooling body.

In accordance with an exemplary embodiment, the laboratory instrument (and in particular the support body) can comprise an annular closed first force-transmitting mechanism (in particular a first toothed belt) for transmitting the driving force from the drive device to the first eccentric and/or an annular closed second force-transmitting mechanism (in particular a second toothed belt) for transmitting the driving force from the drive device to the second eccentric. An exemplary embodiment with a first force-transmitting mechanism and second force-transmitting mechanism in the form of two toothed belts is shown in FIG. 33 and FIG. 34. In an exemplary embodiment of this type, for example, a first peripheral closed toothed belt or synchronous belt can engage with a toothed wheel of the drive device and with a toothed wheel of the first eccentric, whereas a second peripheral closed toothed belt or synchronous belt can be engaged with the toothed wheel of the drive device and another toothed wheel of the second eccentric. Advantageously in this case, the two peripheral closed toothed belts can be countersunk into the support body in order to leave an appropriately large cavity between the eccentrics.

In accordance with another exemplary embodiment, the laboratory instrument can comprise a single annular closed force-transmitting mechanism, in particular a toothed belt or synchronous belt, for transmitting the driving force from the drive device to the first eccentric and to the second eccentric. Another exemplary embodiment of this type with only a single force-transmitting mechanism in the form of a peripheral closed toothed belt is illustrated in FIG. 70. In an exemplary embodiment of this type, the peripheral closed toothed belt can engage with a toothed wheel of the drive device, with a further toothed wheel of the first eccentric, with an additional toothed wheel of the second eccentric and optionally with another toothed wheel of a guide pulley. The toothed belts can run along an outer periphery of the support body, preferably on its underside. In accordance with a preferred exemplary embodiment of this type, a particularly large central region can be kept free from the eccentrics and even from the entire mixing drive mechanism and run along an entire outer periphery of the support body. In an embodiment of this type, a particularly large amount of space is left for employing an interactive device, extending the functionality of the laboratory instrument. It can even be advantageously possible to equip the support body with a central through hole and in this manner to make a support body received on the main component fully accessible from an underside of the laboratory instrument.

In accordance with an exemplary embodiment, the laboratory instrument can comprise at least one counterbalancing mass to at least partially compensate for an imbalance produced by the first eccentric and the second eccentric as well as the main component (and an optional object carrier plus medium attached thereto) during operation (in particular during orbital operation). A counterbalancing mass of this type can reduce or completely or partially compensate for the imbalance which in particular is caused by the eccentrics and the main component on the associated eccentric shafts, as well as on a shaft of the drive device which is operationally coupled to the eccentrics. Advantageously, forces on the bearings are reduced thereby and wear on the components of the laboratory instrument can be reduced, whereupon the service life of the laboratory instrument can be increased.

In accordance with an exemplary embodiment, the at least one counterbalancing mass can be securely asymmetrically attached to the drive device and can rotate with its shaft (see FIG. 31, for example). As an example, then, a single counterbalancing mass can partially surround the periphery of the drive device in order to at least partially compensate for the mechanical loads generated by the eccentrics.

In accordance with another exemplary embodiment, a first counterbalancing mass can be securely attached to the first eccentric and a second counterbalancing mass can be securely attached to the second eccentric (see FIG. 66, for example). In accordance with an embodiment of this type, a respective counterbalancing mass which rotates with the associated eccentric can be provided per eccentric, accurately compensating for the unbalanced forces of an associated eccentric.

In accordance with a further exemplary embodiment, an in particular frame-shaped counterbalancing mass can be attached to at least one of the first eccentric (in particular configured as a double eccentric) and the second eccentric (in particular configured as a double eccentric). A frame-shaped counterbalancing mass of this type can, for example, be disposed between the support body and the main component. A frame-shaped counterbalancing mass can be configured to execute a counterbalancing movement upon mixing (see FIG. 75 and FIG. 76). An advantage of a frame-shaped counterbalancing mass, for example for executing an orbital motion, is that a particularly small build space is sufficient to accommodate it. Furthermore, counterbalancing even larger moved masses is possible. The frame-shaped counterbalancing mass can move orbitally like the main component, but eccentrically in opposition thereto. As an example, a frame-shaped closed counterbalancing mass can be implemented which can be configured to absorb or counterbalance the bearing loads which are generated by the eccentrics in particular.

In accordance with an exemplary embodiment. the laboratory instrument can comprise at least one swivel support, in particular a plurality of swivel supports, which are movably mounted between the support body and the main component. The term “swivel support” should in particular be understood to mean a rigid elongated component, preferably with upper and lower curved contact surfaces which, in operation, executes a spatially limited staggering movement, in particular a combination of rotation and tilting. The swivel supports mount or guide the main component on the support body in a plane which is defined by the swivel supports. Expressed another way, between the support body and the main component, in order to transmit a mixing motion, preferably a (more preferably planar) orbital motion, not only force-coupling or torque-coupling occurs by means of the two eccentrics, but also, the swivel supports can function as bearings and guides for the main component and the support body in a plane.

In particular when using a plurality (preferably at least three, in particular four) of swivel supports, mounting of the main component, which functions as a shaker tray with respect to the stationary support body of the laboratory instrument can advantageously permit a mixing motion in only one plane (in particular a horizontal plane).

In accordance with an exemplary embodiment, the at least one swivel support can be mounted with the bottom in at least one first depression in the support body and with the top in at least one second depression in the main component. In this manner, the mounting provided by the swivel supports can be carried out in a particularly accurate manner.

In accordance with an exemplary embodiment, at least one first counter plate can be disposed on the support body in physical contact with a bottom surface of the at least one swivel support and/or at least one second counter plate can be disposed on the main component in physical contact with a top surface of the at least one swivel support. The swivel support on the one hand and preferably two counter plates as power interfaces for the support body and the main component can transfer force between the main component and support body in the vertical direction, whereas in a horizontal plane, the swivel support carries out the function of bearing and guiding. In accordance with one embodiment, the respective counter plate can be a separate body which is attached to the main component or to the support body. In accordance with another embodiment, the respective counter plate can form an integral part of a housing of the main component or of the support body.

In accordance with an exemplary embodiment, the at least one first counter plate and/or the at least one second counter plate can comprise or consist of a ceramic. As an alternative or preferably in addition, the at least one swivel support can comprise or consist of plastic. In particular, the pairing of ceramic and plastic materials constitutes a particularly advantageous tribological system formed by the counter plate and swivel support and provides a low-friction, low-wear and low-noise coupling between the support body and main component.

In accordance with an exemplary embodiment, the at least one swivel support on the one hand and the at least one first counter plate and/or the at least one second counter plate on the other hand can be configured to produce a (at least substantially) rolling friction and in particular (at least substantially) sliding friction-free interaction. This can be accomplished by matching the geometry of the swivel supports and counter plates as well as the mutually vertically opposite depressions in the main component and support body for receiving the counter plates. A guided movement of the main component accomplished by rolling friction and preferably without sliding friction with respect to the support body with the swivel supports disposed therebetween and driven by means of the eccentrics ensures a particularly low-loss and energy-saving mixing operation in an extremely guided manner.

In accordance with an exemplary embodiment, the at least one swivel support can include a laterally broadened top section and a laterally broadened bottom section as well as a pin section disposed between the top section and the bottom section. Clearly, during operation, the bottom section rolls on the support body and the top section rolls on the main component. A configuration of this type is substantially more space-saving than using balls instead of swivel supports.

In accordance with an exemplary embodiment, an outer surface of the top section can comprise a first spherical surface and/or an outer surface of the bottom section can comprise a second spherical surface. The configuration of the contact surfaces of the top section and bottom section as spherical surfaces advantageously favors force coupling between the main component and the support body which is dominated by rolling friction and is depleted in sliding friction.

In accordance with an exemplary embodiment, a first radius of the first spherical surface and/or a second radius of the second spherical surface can be larger than an axial length of the at least one swivel support. Clearly, the radii of the two mutually opposite spherical surfaces should be selected to be very large, preferably larger than an axial extent of the entire swivel support. This favors a low-friction and simultaneously precisely guided force coupling between the main component and the support body.

In accordance with an exemplary embodiment, the laboratory instrument can include four swivel supports which are mounted in pairs on mutually opposite sides of the support body and of the main component. As an example, the first eccentric can be disposed along a first elongated edge of the laboratory instrument between two swivel supports. In a corresponding manner, the second eccentric can be disposed along a second elongated edge of the laboratory instrument opposite the first elongated edge between two other swivel supports. All four swivel supports can be identical in configuration. A configuration of this type has been shown to be particularly advantageous in forming a low-friction and precisely guided mixing motion.

In accordance with an exemplary embodiment, the first eccentric and the second eccentric can be disposed on mutually opposite side edges of the support body, and in particular offset laterally with respect to each other. In particular, the two eccentrics can be disposed on mutually opposite long side edges of a substantially rectangular support body. One of the two eccentrics can be disposed closer to one of the two short side edges of the support body than the other of the two eccentrics. A configuration of this type results in a particularly stable arrangement of the main component on the support body.

In accordance with an exemplary embodiment, the drive device can be disposed between the first eccentric and the second eccentric. In particular, the drive device in one exemplary embodiment can be disposed approximately in the middle of a connecting line between the two eccentrics and in fact preferably vertically sunk into a housing of the support body, leaving a cavity free between the two eccentrics (see FIG. 31, for example). An arrangement of this type saves space and results in short drive paths, so that the drive for the eccentric can be obtained in a secure and low-loss manner. In an exemplary embodiment of this type, force coupling between a drive device and the two eccentrics can be achieved by short peripheral closed toothed belts or other force-transmitting mechanisms.

In accordance with another exemplary embodiment, the first eccentric can be disposed in a first corner and the second eccentric can be disposed in a second corner, in particular in two mutually opposite corners, of the support body (see FIG. 70, for example). Then, the drive device can be disposed in a third corner of the support body, in particular in a third corner between the first corner with the first eccentric and the second corner with the second eccentric. In accordance with a configuration of this type, the coupling between the drive device and the eccentrics by means of a force-transmitting mechanism (such as a toothed belt, for example) can be produced, which, by deflection at the toothed wheels or the like, forms a substantially L-shaped force transmission path between the drive device and the two eccentrics. In this regard, the drive device is at the corner of the L, whereas the two eccentrics are disposed at the ends of the L. In a configuration of this type, the drive for the eccentrics for the generation of a mixing motion of the main component can be accommodated along a periphery of the support body, whereupon a central region of the support body can be left free, for example in order to attach an interactive device. Said toothed wheels can, for example, be provided at the drive device and at each of the two eccentrics in order to drive a completely peripheral toothed belt by means of the drive device and to transmit its driving force onto the two eccentrics.

In accordance with an exemplary embodiment, the laboratory instrument can include a guide pulley which is disposed in a fourth corner of the support body. In this regard, an annular closed and rectangular toothed belt can be provided which can run around the entire periphery of the support body and therefore leave a larger inner area or central region of the support body free inside the peripheral toothed belt. Even the guide pulley which is rotatably mounted on the support body can comprise a toothed wheel which engages with the peripheral toothed belt in order to deflect it.

In accordance with an exemplary embodiment, the laboratory instrument can comprise a movable first positioning fixture for application to a first edge region of the object carrier, a second positioning fixture for application to a second edge region of the object carrier, and a fixing mechanism for fixing the object carrier to the main component between the first positioning fixture and the second positioning fixture by moving the at least one positioning fixture. In the context of the present application, the term “positioning fixture” should in particular be understood to mean a body, component or mechanism which is configured to be abutted onto or applied to an edge region of an object carrier in order in this manner to exert a fixing and/or positioning influence thereon. In particular, a positioning fixture can exert an at least temporary fastening force on an object carrier. In the context of the present application, the term “edge region of an object carrier” should be understood to mean a position on or near a peripheral boundary of an object carrier. In particular, an edge of an object carrier can be defined by a side wall of the object carrier. In the context of the present application, the term “fixing mechanism” should in particular be understood to mean an arrangement of cooperating elements or components which together exert a fixing force on an object carrier which fixes the object carrier in a pre-specified position.

In accordance with an exemplary embodiment, the fixing mechanism can be disposed along at least a portion of a periphery of the main component, leaving a central region of the main component which is surrounded by the periphery free. In accordance with this embodiment, the fixing mechanism for fixing the object carrier to the laboratory instrument by actuating an actuating device can be disposed so as to extend partially or completely around a central region of a main component of the laboratory instrument. Expressed another way, the fixing mechanism can be guided along an edge of the main component and can also be guided around an outer edge of the object carrier. Since the fixing mechanism for fixing the object carrier does not have any components which extend into an inner region of the main component (over which inner region the object carrier can be positioned), the central region below the object carrier remains free for receiving an interactive device for functional cooperation with the object carrier. This means that the fixing mechanism does not suffer from any restrictions as regards a direct functional interaction between the laboratory instrument and the object carrier on it. Advantageously, with an annular peripheral fixing mechanism of this type, a low-force actuation of it by means of an actuating device and a robust self-locking effect against unwanted release of the object carrier from the laboratory instrument can be obtained even when significant operational forces (for example an orbital force for mixing a medium in the object carrier) act on the object carrier during the operation of the laboratory instrument.

In accordance with an exemplary embodiment, the fixing mechanism can be disposed along an underside of the main component which faces away from the object carrier. Particularly preferably, the fixing mechanism on the underside of the main component extends around the entire peripheral edge in a closed loop. In a configuration of this type, not only does the entire upper side of the main component remain free for receiving an object carrier of the same size, but also, a large central region on the underside of the main component can be used in part or in its entirety for accommodating an interactive device and/or in part or in its entirety for the passage of a cooling gas.

In accordance with an exemplary embodiment, the fixing mechanism can run along the entire periphery of the main component. In particular, a force transmission path of the fixing mechanism can be formed in an annular closed manner along an entire outer periphery of the main component. A transmission of force of this type can be obtained, for example, by means of a toothed belt which extends along the entire perimeter of all the side edges of the main component and at each of the corners of the main component, the direction of the force is changed by means of a respective component of the fixing mechanism (in particular by means of one or more guide disks and/or one or more deflecting elements). In the context of this application, when a “guide disk” is discussed, this can indicate here a round guide disk or a guide disk with a different shape. In general, instead of guide disks, guide structures of any other type can be used.

In accordance with an exemplary embodiment, the laboratory instrument can comprise an actuating device for actuating the fixing mechanism in order for transposing at least the first positioning fixture between an operational state which fixes the object carrier and an operational state which releases the object carrier. In the context of the present application, the term “actuating device” should in particular be understood to mean a mechanical arrangement which enables a user, actuator and/or robotic handler to apply an actuating force to the laboratory instrument in order to set a defined operational mode. In particular, at least a portion of the actuating device can be attached to an exterior of the laboratory instrument in order to enable a user and/or robotic handler in particular to gain access to the actuating device. As an alternative or in addition, it is also possible to bring at least a portion of the actuating device into an interior of the laboratory instrument in order to enable access in particular for an actuator which is also attached inside the laboratory instrument. Actuating the actuating device can, for example, be carried out by means of a longitudinal force on a longitudinally displaceable element and/or by means of a turning force on a pivotable lever or the like.

In accordance with an exemplary embodiment, the mixing drive mechanism and the fixing mechanism can be decoupled from each other. Advantageously, the mixing drive mechanism can be configured exclusively in the support body and the fixing mechanism can be configured exclusively in the main component. In this manner, the mixing drive mechanism and the fixing mechanism can be kept functionally and spatially separate from each other. Expressed another way, the fixing mechanism can be activated to release the object carrier or deactivated to fix the object carrier by actuating the actuating device without this having any effect on the mixing drive mechanism. And vice versa, the mixing drive mechanism can be activated by means of its drive device in order to drive the eccentrics without this having any effect on the fixing mechanism. In other words, the actuating device and the fixing mechanism can be mechanically decoupled from the mixing drive mechanism. This means that unwanted interaction between the fixing function and the mixing function can be avoided and both functions can be used independently of one another.

In accordance with an exemplary embodiment, the laboratory instrument can include an actuator attached to the support body for the electromechanical control of the actuating device disposed on the main component in order to actuate the fixing mechanism. Using this automatic control, the fixing mechanism can be actuated selectively in order to engage or release the object carrier.

In accordance with an exemplary embodiment, the laboratory instrument can comprise at least one interactive device which is completely or partially disposed in the free central region of the support body (and/or completely or partially disposed in a free central region of a main component of the laboratory instrument) and/or is operationally configured through the respective free central region (in particular on an object carrier received therein or on a medium received therein). In the context of the present invention, the term “interactive device” should be understood to mean a device which, in addition to mixing (as well as optionally in addition to fixing an object carrier accomplished by means of a fixing mechanism and fixing an object carrier by means of positioning fixtures and by means of a corresponding optional actuation by means of an actuating device), provides at least one additional function for functionally influencing a medium in the object carrier. In an interactive device of this type, this can, for example, be a device which sets or affects at least one operating parameter (for example temperature) of the medium in the object carrier, which sensorially characterizes the medium in the object carrier (for example using optical sensor systems) and/or which deliberately manipulates the medium in the object carrier (for example stimulates it by means of electromagnetic radiation or by means of magnetic forces).

In accordance with an exemplary embodiment, the interactive device can be selected from a group which consists of a temperature control device for controlling the temperature of a medium in the object carrier, an optical apparatus for optical interaction with a medium in the object carrier, and a magnetic mechanism for magnetic interaction with a medium in the object carrier. As an example, by means of a temperature control device of the main component below a mounted object carrier, a temperature of a medium (for example a liquid sample) in the object carrier or in individual compartments of the object carrier can be adjusted. This can comprise heating the medium to a temperature above an ambient temperature and/or cooling the medium to a temperature below an ambient temperature. As an example, heating or cooling can be carried out by means of a heating wire (for heating) or by means of a Peltier element (for selective heating or cooling). Since a central region of the main component is free of fixing mechanism, this can be used to accommodate a temperature control device or at least a portion thereof. However, it is also possible to accommodate an optically active device in the central region of the main component in order to interact optically with the medium in the mounted object carrier. As an example, an optically active device of this type can include an electromagnetic source of radiation, which irradiates the medium in the object carrier with electromagnetic radiation (in particular visible light, ultraviolet light, infrared light, X rays, etc.). Irradiation of the medium in the object carrier with electromagnetic radiation of this type can, for example, be carried out in order to stimulate the medium, to initiate chemical reactions in the medium and/or to heat the medium. It is also possible for an optically active device of this type to include an electromagnetic radiation detector which detects electromagnetic radiation propagated by the medium in the object carrier. A magnetic mechanism disposed below the object carrier in the free central region of the support body and/or main component for the production of a magnetic effect on the medium in the object carrier can, for example, magnetically separate, stimulate or otherwise influence the medium.

In accordance with an exemplary embodiment, the mixing drive mechanism can be configured to produce an orbital mixing motion. The term “orbital motion” as used here should be understood to mean the movement of the object carrier and of the medium contained therein about centers which are formed by two eccentric shafts. Expressed another way, a plate of the main component which receives the object carrier can be driven by two eccentrics (i.e. two shafts configured as eccentrics) which in turn are driven synchronously by an electric motor or another drive device. A resulting orbital motion can cause particularly effective mixing of medium (in particular of a liquid, a solid and/or a gas) in a receptacle of the object carrier. Preferably, the orbital motion of the main component occurs in a horizontal plane.

In accordance with an exemplary embodiment, the drive device can be coupled to the first eccentric and to the second eccentric for synchronously moving the first eccentric and the second eccentric. Thus, the two eccentrics can be driven by a common drive device in a manner such that their eccentric turning motions are matched temporally, and in particular turn in-phase. In this manner, the two eccentrics can cooperate in order to produce a defined mixing motion in order to mix the medium in the object carrier. When the shaker tray is mounted on swivel supports with spherical end surfaces, when there is just one central eccentric drive, the risk of accidental distortion during execution of the mixing motion can arise. This is safely avoided by using two synchronously moved eccentrics which are disposed at the edges. Thus, in particular when used with the aforementioned swivel supports, eccentrics which are disposed on an edge of the support body are highly advantageous.

In accordance with an exemplary embodiment, the laboratory instrument can include the object carrier received on the main component, in particular a sample carrier plate. In particular, the object carrier can be a sample carrier plate which preferably includes a plurality (in particular at least 10, more particularly at least 100) of sample receptacles or sample wells which are disposed in a matrix, for example. More particularly, a sample carrier plate of this type can be a microtiter plate. Advantageously, the structures of an object carrier receiving surface on an upper side of the main component and an underside of the object carrier can be matched.

In accordance with an exemplary embodiment, a removably mounted and thermally conductive temperature control adapter (in particular with a thermal conductivity of at least 50 W/mK, for example consisting of a metal such as aluminum) can be disposed on the main component in order to control the temperature of the object carrier or of vessels (see FIG. 2, FIG. 3 and FIG. 9, for example). This allows for flexible installation of the temperature control adapter when specific temperature control of the object carrier or individual sample vessels is desired.

In particular, the temperature control adapter can include receiving openings for receiving and interlocking the object carrier or the vessels (see FIG. 3, for example). This provides the opportunity for specifically and easily and also flexibly controlling the temperature of object carriers or vessels in a highly thermally conductive manner and in a manner which is intuitive for the user.

In accordance with an exemplary embodiment, the temperature control adapter can be selected from a group which consists of a flat plate for receiving a flat bottom of an object carrier (see FIG. 2) and a frame with receiving openings for receiving an object carrier with a profiled bottom or vessels containing a medium (see FIG. 3 and FIG. 9). With a temperature control adapter configured as a flat plate, the laboratory instrument can be adapted for an object carrier with a flat bottom, for example and particularly good thermal coupling of an object carrier of this type with the main component can be ensured. Alternatively, the temperature control adapter can be configured as a metal frame which has a plurality of receiving openings into which an object carrier or sample vessels or the like which are profiled on the bottom can be placed and can be thermally coupled with the main component. As an example, a temperature control adapter of this type can include a matrix-like arrangement of receiving openings formed by cells and gaps.

In accordance with an exemplary embodiment, the support body on which the main component can be movably mounted can be an annular body with a central through hole (which can correspond to the free central region of the support body). As an alternative or in addition, the main component can be an annular body with a central through hole (which can correspond to the free central region of the main component). An example of an appropriate exemplary embodiment can be seen in FIG. 65 to FIG. 72. In a configuration of this type, a respective central region can be left free, forming a central through hole in the main component and forming a central through hole in the support body. A configuration in which both the main component and also the support body is respectively annular in shape, so that when mounted on each other, the main component and support body together have a common through hole which is formed by their free central regions, is particularly advantageous. Advantageously, in a laboratory instrument of this type in which an object carrier is mounted on the main component, a medium received therein is accessible from an underside of the laboratory instrument through the through holes of the support body and main component in order to enable an interactive device (for example a temperature control device or an optical sensor device) to interact with the medium.

In accordance with an exemplary embodiment, a bottom connecting plate of the support body can be provided with an electrical connector for cordless electrical connection to a base module (for example a base plate) in order to mount the support body (see FIG. 17 to FIG. 21). This enables rapid mounting or exchange of a laboratory instrument with the formation of an electrical connection (for example in order to supply electrical energy and/or for communication purposes) simply by plugging the support body into a base plate with an appropriate mating connector.

In accordance with an exemplary embodiment, the first eccentric can be mounted on the drive device and the second eccentric can be force-coupled to the drive device by means of a force-transmitting belt. Clearly, the first eccentric can be mounted directly, and in particular without a force-transmitting belt, on the drive device (for example an electric motor) in order to follow a driving movement of the drive device. This saves on components and therefore results in a compact laboratory instrument. The second eccentric can be force-coupled to the drive device by means of a force-transmitting belt (for example a toothed belt) in order to transmit drive energy from the drive device to the second eccentric by means of the force-transmitting belt. The configuration described also ensures that the movement of the two eccentrics is synchronized.

In accordance with an exemplary embodiment, the laboratory instrument can include a normal force-producing device in order to produce a normal force to impede lifting of the movable main component from the support body and/or from at least one swivel support between the support body and the main component. When the laboratory instrument is operating, the moved main component should be reliably prevented from coming away from the stationary support body in the vertical direction. The vertical direction can also be designated the normal direction, because it is orientated perpendicular to or normal to a horizontal plane in which, during operation of the laboratory instrument, the movement of the main component occurs relative to the support body. Advantageously, a normal force-producing device can produce a normal force which holds the main component on the support body during operation. This improves the operational safety of the laboratory instrument.

In accordance with an exemplary embodiment, the normal force-producing device and the mixing drive mechanism can be configured to decouple the normal force produced by means of the normal force-producing device on the one hand from a horizontal force produced by means of the mixing drive mechanism on the other hand. In accordance with a preferred embodiment of this type, the normal force is produced by the normal force-producing device and the horizontal force for moving the main component relative to the support body is produced by the mixing drive mechanism, or more accurately from its driven eccentrics. This force decoupling in particular ensures that the bearings on the eccentrics are only loaded radially and have to accommodate almost no axial forces. This protects the bearings of the eccentrics from wear and increases their service lives. More accurately, in operation, the normal force-producing device prevents the main component (which can be configured as a shaker tray in one exemplary embodiment) from lifting from the swivel supports between the support body and main component. This means that the bearings of the eccentrics are protected from excessive mechanical loads. Since radial forces (produced by the eccentrics) are separated from the normal force, which is generated by the normal force-producing device, bearings (in particular ball bearings) of the eccentric are essentially only loaded radially. In contrast, axial forces in the normal direction can be taken up by the swivel supports, which can be loaded axially.

In accordance with an exemplary embodiment, the normal force-producing device can include at least one normal force-producing spring (for example a helical spring or a plate spring) which couples the main component to the support body. The use of a mechanical spring for coupling in order to impede separation of the main component and support body has the advantage that no magnetic fields are produced thereby which could compromise the electronics or magnetic applications (for example magnetic separation) of the laboratory instrument under adverse circumstances.

In accordance with an exemplary embodiment, the normal force-producing device can include a pliable element which is operatively connected to the at least one normal force-producing spring, wherein one of the at least one normal force-producing spring and the pliable element is attached to the main component and the other of the at least one normal force-producing spring and the pliable element is attached to the support body. The term “pliable” in this context can in particular be understood to mean that the element is rigid in the tensile direction but is flexible transversely to the tensile direction. An example in this regard is a tensile filament (for example a steel cord) which can in fact be curved or angled but cannot or can only with difficulty be extended or have its length changed in the longitudinal direction or in the tensile direction by the action of force. Clearly, the pliable element (for example a cord or wire) which is advantageously attached to the main component can follow mixing motions in a horizontal plane. The normal force-producing spring which is preferably attached to the support body can be pre-tensioned and if the main component is briefly lifted from the support body, it can pull the main component down by means of the pliable element.

As an alternative, the normal force-producing spring can be configured as a tension spring between the main component and support body. A pliable element can then be unnecessary.

In accordance with an exemplary embodiment, the normal force-producing device can include at least two normal force-producing magnets coupling the main component to the support body. As an example, at least one first normal force-producing magnet can be provided on the main component and at least one second normal force-producing magnet can be provided on the support body, wherein the first and second normal force-producing magnets can attract each other. The use of magnets on the main component and support body which operate without contacting constitutes a particularly simple and low-wear embodiment of the normal force-producing device.

In accordance with an exemplary embodiment, the at least two normal force-producing magnets can be configured so as to attract each other or repel each other. As an example, mutually attracting magnets can be disposed in mutually facing coupling regions of the support body and main component. Said magnets can be kept at a distance from each other which is as small as possible, but preferably non-zero. In another embodiment, the normal force-producing magnets in the support body and main component can be mutually repulsive, wherein an appropriate mechanism is provided such that the repulsive force between the normal force-producing magnets holds the main component on the support body.

In accordance with an exemplary embodiment, the normal force-producing device can include a rigid element which is rigidly connected to a first of the normal force-producing magnets and by a rigid element which passes through a second of the normal force-producing magnets, wherein the rigid element is attached to the main component and the second normal force-producing magnet is attached to the support body. If the main component plus the rigid element attached thereto tends to lift from the support body, the first normal force-producing magnet is entrained with it and therefore moves in the direction of the second normal force-producing magnet which is attached to the support body in a stationary manner. If the normal force-producing magnets repel, then said tendency leads to a repulsive magnetic force which pulls the main component back to the support body.

In accordance with an exemplary embodiment, the normal force-producing device can include a magnetic field shielding device, in particular formed by ferromagnetic keepers which at least partially surround the normal force-producing magnets in order to shield a magnetic field which is produced by the at least two normal force-producing magnets. In this manner, a measure can be taken to shield components of the laboratory instrument, for example electronics or components used in connection with magnetic separation, from the magnetic field produced by the normal force-producing magnets.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A laboratory instrument (100) for mixing a medium in an object carrier (102), wherein the laboratory instrument (100) includes:
a support body (138);
a main component (104) for receiving the object carrier (102) which is disposed on the support body (138) and is movable with respect to the support body (138) for mixing;
a mixing drive mechanism (140) disposed on the support body (138), with a drive device (150), a first eccentric (152) and a second eccentric (154) which can be driven by means of the drive device (150) and which are configured in order to transmit a driving force produced by the drive device (150) to the main component (104) in order to mix the medium in the object carrier (102); and
at least one counterbalancing mass (172) to at least partially compensate for an imbalance produced by the first eccentric (152), the second eccentric (154) and the main component (104);
wherein the first eccentric (152) and the second eccentric (154) are disposed on a peripheral edge (156) of the support body (138) and outside a central region (158) of the support body (138);
wherein the first eccentric (152) and the second eccentric (154) are disposed on mutually opposite side edges of the support body (138) and are laterally offset with respect to each other, or the first eccentric (152) is disposed in a first corner of the support body (138) and the second eccentric (154) is disposed in a second corner of the support body (138); and
wherein the counterbalancing mass (172) is attached to at least one of the first eccentric (152) and the second eccentric (154), and is disposed between the support body (138) and the main component (104) and is configured to carry out a movement upon mixing which is counter to that of the main component (104).

2. The laboratory instrument (100) as claimed in claim 1, wherein a cavity is formed in the central region (158), wherein in particular, the support body (138) is configured to allow a cooling fluid to flow through the cavity from outside the laboratory instrument (100).

3. The laboratory instrument (100) as claimed in claim 2, wherein the support body (138) includes at least one cooling opening (162) on mutually opposite sides, through which the cooling fluid flows from outside the laboratory instrument (100) through the cavity and out of the laboratory instrument (100) again.

4. The laboratory instrument (100) as claimed in claim 1, wherein a cavity is formed in the central region (158) in which at least a portion of a cooling body (164) attached to an underside of the main component (104) is received.

5. The laboratory instrument (100) as claimed in claim 1, including a thermal coupling plate (166) on the main component (104), the upper side thereof forming at least a portion of a loading surface for the object carrier (102).

6. The laboratory instrument (100) as claimed in claim 4, wherein the underside of the thermal coupling plate (166) is coupled to the cooling body (164).

7. The laboratory instrument (100) as claimed in claim 1, including at least one of the following features:
including an annular closed first force-transmitting mechanism (168), in particular a first toothed belt, for transmitting the driving force from the drive device (150) to the first eccentric (152) and/or including an annular closed second force-transmitting mechanism (170), in particular a second toothed belt, for transmitting the driving force from the drive device (150) to the second eccentric (154);
including an annular closed force-transmitting mechanism (168), in particular a toothed belt, for transmitting the driving force from the drive device (150) to the first eccentric (152) and to the second eccentric (154).

8. The laboratory instrument (100) as claimed in claim 1, including at least one of the following features:
the at least one counterbalancing mass (172) is asymmetrically attached to the drive device (150);
wherein a first counterbalancing mass (172) is attached to the first eccentric (152) and a second counterbalancing mass (172) is attached to the second eccentric (154).

9. The laboratory instrument (100) as claimed in one of claim 1, including at least one swivel support (174), in particular a plurality of swivel supports (174), which is or are movably mounted between the support body (138) and the main component (104).

10. The laboratory instrument (100) as claimed in claim 9, wherein the bottom of the at least one swivel support (174) is mounted in at least one first depression (176) in the support body (138) and the top is mounted in at least one second depression (178) in the main component (104).

11. The laboratory instrument (100) as claimed in claim 9, wherein at least one first counterplate (180) is or are disposed on the support body (138) in physical contact with a bottom surface of the at least one swivel support (174) and/or at least one second counterplate (182) is or are disposed on the main component (104) in physical contact with a top surface of the at least one swivel support (174).

12. The laboratory instrument (100) as claimed in claim 11, wherein the at least one first counterplate (180) and/or the at least one second counterplate (182) includes or consists of a ceramic.

13. The laboratory instrument (100) as claimed in claim 12, wherein the at least one swivel support (174) on the one hand and the at least one first counterplate (180) and/or the at least one second counterplate (182) on the other hand are configured for rolling friction interaction, and in particular for sliding friction-free interaction.

14. The laboratory instrument (100) as claimed in claims 9, wherein the at least one swivel support (174) includes a laterally broadened top section (184) and a laterally broadened bottom section (186) as well as a pin section (188) disposed between the top section (184) and the bottom section (186).

15. The laboratory instrument (100) as claimed in claim 14, wherein an outer surface of the top section (184) includes a first spherical surface (190) and/or an outer surface of the bottom section (186) includes a second spherical surface (192).

16. The laboratory instrument (100) as claimed in claim 15, wherein a first radius (R1) of the first spherical surface (190) and/or a second radius (R2) of the second spherical surface (192) is or are larger than an axial length (L) of the at least one swivel support (174).

17. The laboratory instrument (100) as claimed in claim 9, wherein the at least one swivel support (174) includes or consists of a plastic.

18. The laboratory instrument (100) as claimed in claim 9, including at least three swivel supports (174), in particular four swivel supports (174), which are mounted in pairs on mutually opposite sides of the support body (138) and of the main component (104).

19. A method for mixing a medium in an object carrier (102), wherein the method includes:
receiving the object carrier (102) on a main component (104) which is disposed on a support body (138) and can be moved with respect to the support body (138) for the purposes of mixing;
disposing a mixing drive mechanism (140), which includes a drive device (150), a first eccentric (152) and a second eccentric (154), on the support body (138);
disposing the first eccentric (152) and the second eccentric (154) on a peripheral edge (156) of the support body (138) and outside a central region (158) of the support body (138); and
driving the first eccentric (152) and the second eccentric (154) by means of the drive device (150) in order to transmit a driving force produced by the drive device (150) to the main component (104) in order to mix the medium in the object carrier (102);
wherein the first eccentric (152) and the second eccentric (154) are laterally offset with respect to each other on mutually opposite side edges of the support body (138), or the first eccentric (152) is disposed in a first corner of the support body (138) and the second eccentric (154) is disposed in a second corner of the support body (138);
attaching the counterbalancing mass (172) to at least one of the first eccentric (152) and the second eccentric (154); and
disposing the counterbalancing mass (172) between the support body (138) and the main component (104) to carry out a movement upon mixing which is counter to that of the main component (104).
